(19) United States
(12) Patent Application Publication
(10) Pub. No.: US 2025/0341199 A1
(43) Pub. Date: Nov. 6, 2025

(54) DEVICE FOR CONVERTING FLOW ENERGY TRANSPORTED VIA A MEDIUM INTO MECHANICAL AND/OR ELECTRICAL ENERGY

(71) Applicant: VentoStream AG, Liestal (CH)

(72) Inventor: Gebhard Bernsau, Hohentengen (DE)

(73) Assignee: VentoStream AG, Liestal (CH)

(21) Appl. No.: 18/702,971

(22) PCT Filed: Oct. 14, 2022
(86) PCT No.: PCT/EP2022/000091

§ 371 Date: Apr. 19, 2024

(30) Foreign Application Priority Data
Oct. 19, 2021 (DE) 10 2021 005 200.5

(51) Int. Cl. F03D 1/04; F03B 17/06; H02K 7/18

(52) U.S. Cl. CPC F03D 1/04; F03B 17/06; H02K 7/1823

(57) ABSTRACT

The invention relates to a device (1) for converting flow energy transported via a medium into mechanical and/or electrical energy, comprising a housing (112) having a turbine wheel (80) and a device for generating additional negative pressure (50) arranged downstream of same in the flow direction, which has an inner in-flow channel (41) and channels (48), which receive the medium, wherein same is pressed outwards with the rotation of the rotatable parts of the device for generating additional negative pressure (50), wherein the device for generating additional negative pressure (50) has a non-rotatable shaped disc (51c), which has at least one further through-opening (51, 51h, 51i, 51d-51g), which is suitable for either accelerating or braking the rotatable parts of the device for generating additional negative pressure (50).

The present invention relates to a device for converting flow energy transported via a medium into mechanical and/or electrical energy, as claimed in the preamble of patent claim 1.

Disclosed in DE 10 2010 024 621 A1 is an energy converter having a supply duct for a medium, and a turbine wheel disposed downstream of the supply duct, in which a converter wheel is disposed downstream of the turbine wheel in such a manner that the converter wheel set in rotation by the medium is able to be accelerated for rotating the turbine wheel. This energy converter operates efficiently and can convert the energy of fluid flowing in a tubular section into energy by way of a relatively simple and compact construction.

The object of the present invention lies in achieving a device for converting flow energy transported via a medium into rotational mechanical and/or electrical energy, which preserves these properties but is even more efficient and is adaptable to the flow characteristics of the fluid. Furthermore, the intention is to achieve a structural design embodiment which enables the energy converter to be actuated and regulated for optimal utilization of the flow energy from water power and wind power or other flowing media. Furthermore, the production and the use of such an apparatus is to be highly neutral in terms of the climate and sustainable, and have a characteristic that has little visual or other negative impact on the landscape.

Consequently, the intention is to achieve a device which boosts those flow conditions that are prevalent without a device of this type, to the extent that the respective fluid impacts a turbine or a jet engine, a pump, or the like, this already being described in DE 10 2010 024 621 A1, and which moreover further optimizes the utilization of flow energy from water power, wind power or other flowing media for capturing energy, and which moreover most particularly preferably permits the use of the device so as to be able to be monitored and easily regulated at low and at high flow rates, and at highly fluctuating flow rates.

Moreover, the device is to be able to fulfil multifunctional tasks which go beyond converting flow energy transported via a medium into rotational mechanical and/or electrical energy, this including, inter alia, achieving a device of this type which, beyond capturing energy, permits sustainable, environmentally friendly cooling and ventilating of buildings and rooms which is CO2-neutral when in use.

This object is achieved by a device having the features of claim 1, and by a method as claimed in claim 16. The dependent claims contain advantageous design embodiments of the invention. The device enables the conversion of flow energy transported via a medium into mechanical and/or electrical energy. The mechanical energy may be of rotational origin, or originate from a pump.

### Summary of the Fundamental Principles According to DE 10 2010 024 621 A1

Since the present invention is based on patent application DE 10 2010 024 621 A1, the principles on which that application is based are presently to be summarized hereunder, which principles also apply to the present invention. Reference is additionally made to DE 10 2010 024 621 A1.

The device described in the latter comprises, inter alia, a turbine wheel, what is referred to as a converter wheel, which is a device for generating additional negative pressure in comparison to the atmospheric pressure prevalent in the device, and thus for further increasing the pressure difference after the turbine wheel in comparison to the atmospheric pressure, as a result of which the inflow rate of the fluid into the housing surrounding the turbine wheel is increased, at least one generator.

When viewed in the flow direction of the medium, the device for generating additional negative pressure is disposed behind the turbine wheel. Said device for generating additional negative pressure is rotatably disposed and is preferably located in the same axial direction as the turbine wheel.

When the device is set in rotation, either by a drive motor or by a prevailing fluid flow, the rotating speed of the converter wheel according to this prior art can be increased by the drive motor in a differentiated manner. The pressure difference prevailing between the pressure of the medium in the housing surrounding the turbine wheel and the pressure in the region of the turbine wheel is increased as a result. The housing surrounding the turbine wheel can be designed as a supply duct for water, air or other flowing media. This results in a substantially higher flow rate of the medium in the housing, or supply duct, respectively, i.e. in a substantially greater kinetic energy of the medium.

Assuming an identical output of a conventional wind wheel, the diameter of the turbine wheel of the energy converter according to the invention can be comparatively small due to this generic prior art. Furthermore, the efficiency is substantially increased in comparison to the conventional wind wheel because of the large number of blade parts of the turbine wheel in combination with the corresponding number of guide vane parts of the guide vane assembly of what is referred to as a formed component of the turbine wheel. Given the same output of a wind wheel and of the present energy converter, the construction mode of the present energy converter can be relatively small. Moreover, conventional wind wheels have to be switched off at high wind speeds.

This known energy converter is compact, lightweight, able to be produced in a cost-effective manner, easy to transport and assemble, relatively immune to lightning. Said known energy converter can be installed and operated on the ground, on buildings, terraces, etc. Even in this known design embodiment, no damage is to be anticipated in the event of sudden gusts of wind.

A constant generation of current can be achieved by the generator driven by the turbine wheel of the energy converter in that the rotating speed of the converter wheel is regulated in such a way that a constant volumetric flow rate of the medium in the supply duct is adjusted. The medium, which may be air, for example, and thus flows in at a higher inflow rate additionally sets the converter wheel in rotation and by way of an additional gearbox drives an additional generator. A differentiated increase in the rotating speed is delivered to the converter wheel by the drive motor, optionally as a function of the flow rate, so as to vary the inflow rate in such a way that the turbine wheel has an optimal circulating flow. In this way, it is not necessary to vary the angle of attack of the blade parts and of the guide vane parts.

The housing surrounding the turbine wheel, which can be designed as a supply duct, is not limited to a specific spatial/geometrical configuration. Said housing is preferably formed as a tubular section, wherein a formed component that protrudes into the end region of the tubular section is disposed on that side of the tubular section that faces the turbine wheel. The formed component is designed in such a manner that it directs the medium from the longitudinal axis of the tubular section in the direction toward the internal wall of the tubular section. The formed component is designed to be conical and disposed so as to be concentric with the tubular section. The formed component on its external circumference has guide vane parts which run in each case in the direction of the longitudinal axis of the tubular section and on the external circumference of said formed component are uniformly spaced apart from one another. In this way, a flow duct is formed in each case between two adjacent guide vane parts, a corresponding region of the external circumference of the formed component and a corresponding region of the internal wall of the tubular section, said flow duct leading to the blade parts of the turbine wheel.

The blade parts of the turbine wheel are uniformly spaced apart about a circumference of the turbine wheel. Said blade parts run away from the formed component toward the side of the converter wheel, and are inclined in the circumferential direction of the turbine wheel.

The turbine wheel is connected to a turbine shaft which for generating a current is co-rotationally connected to a generator.

The converter wheel in turn is co-rotationally disposed on a rotatable hollow shaft. Said converter wheel has two circular disks which are mutually spaced apart in parallel, and in the intermediate space of which are disposed ducts that run from the center of said converter wheel toward the outside and open toward the outside, the medium being guided toward the outside in said ducts during rotation of the converter wheel. The ducts comprise in each case a first region which, from a centric antechamber assigned to all ducts, runs radially toward the outside, and a second region which is radially outside and angled relative to the first region approximately in the circumferential direction of the converter wheel and opens toward the outside. The ducts are in each case formed by baffles disposed between the circular disks.

Air particularly preferably serves as the medium. In a further preferred design embodiment of the invention, an atomizer unit is disposed in the supply duct, preferably on that side that faces away from the turbine wheel, a liquid or vaporous medium being able to be introduced into the supply duct through said atomizer unit, said medium preferably being water, atomized water droplets, or atomized oil.

An exemplary embodiment of a known energy converter of this type will be schematically illustrated by means of the figures hereunder, said figures largely corresponding to those of the generic patent application.

In the figures

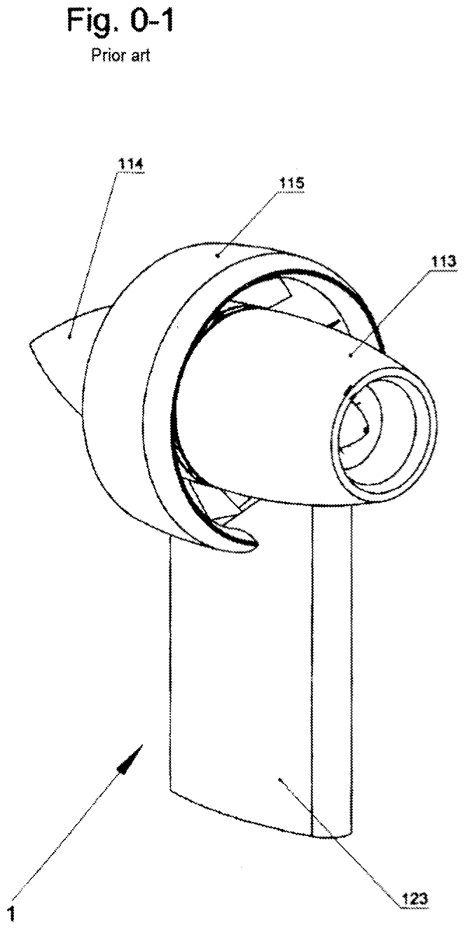

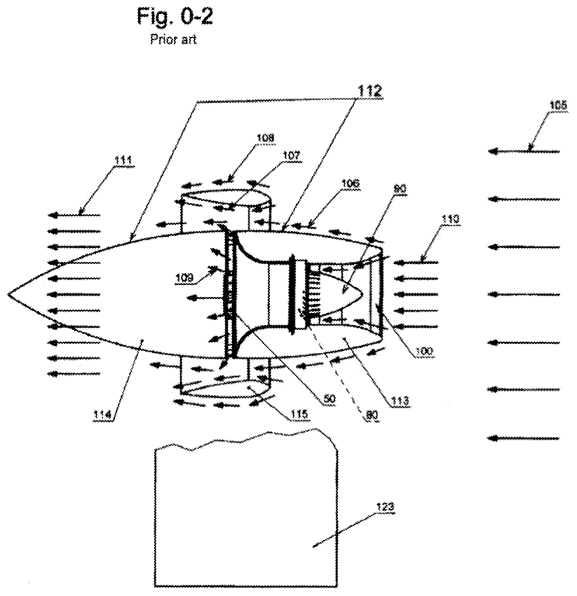

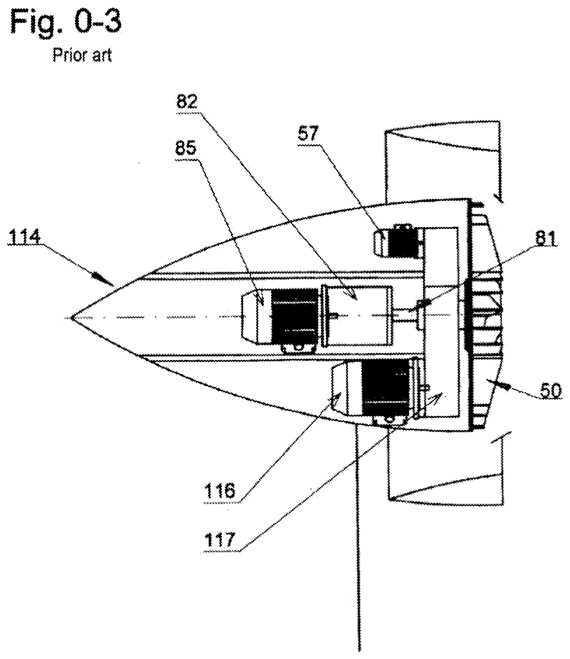

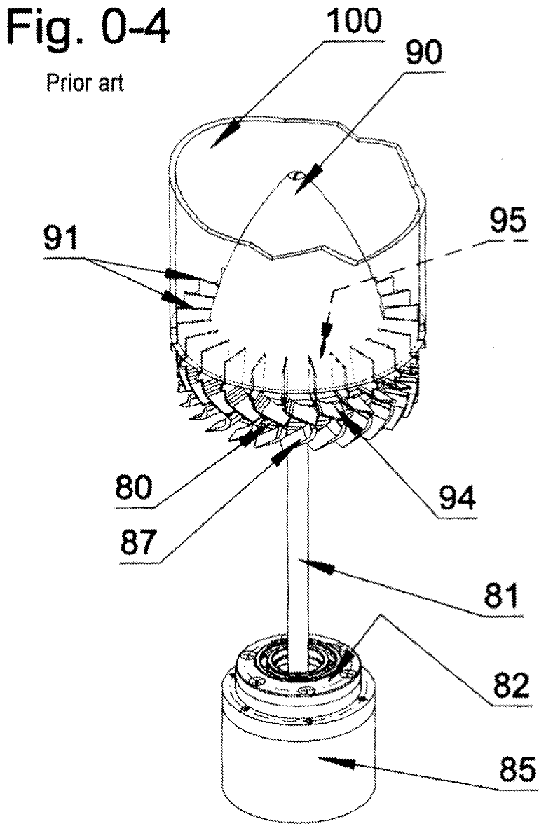

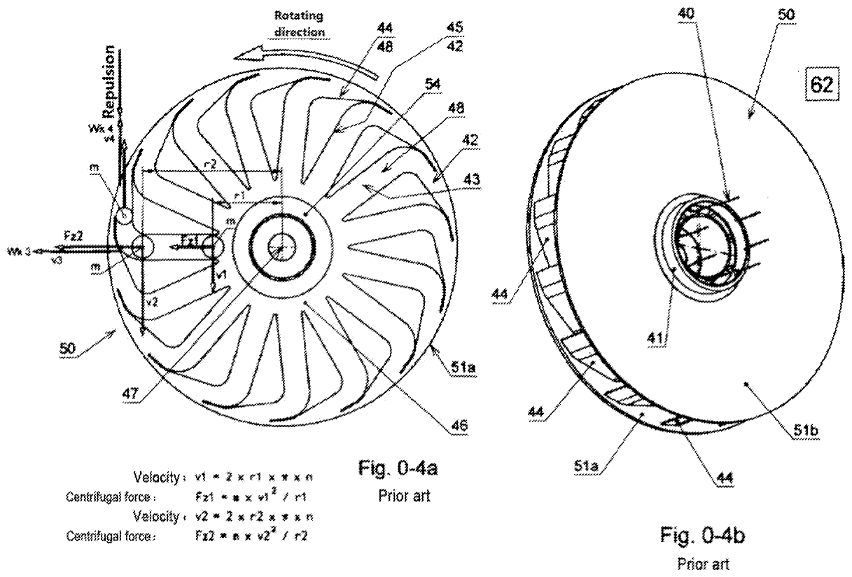

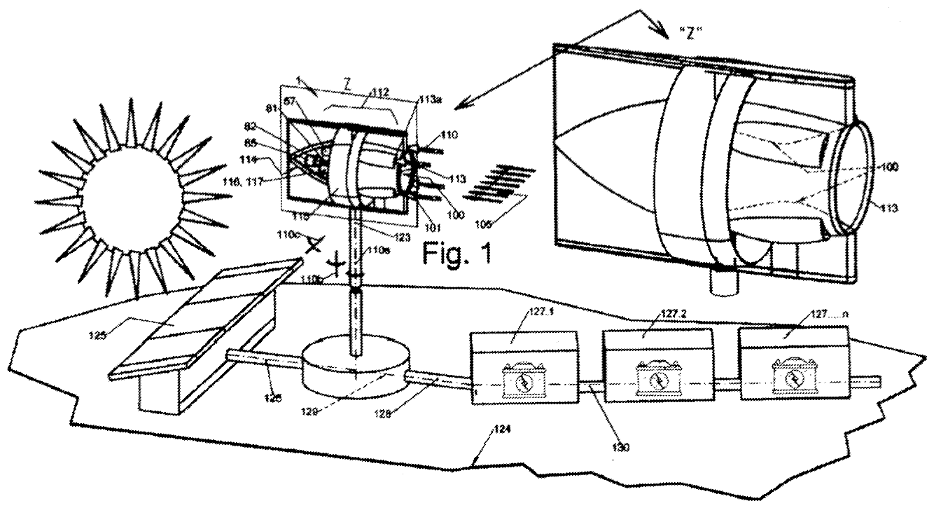

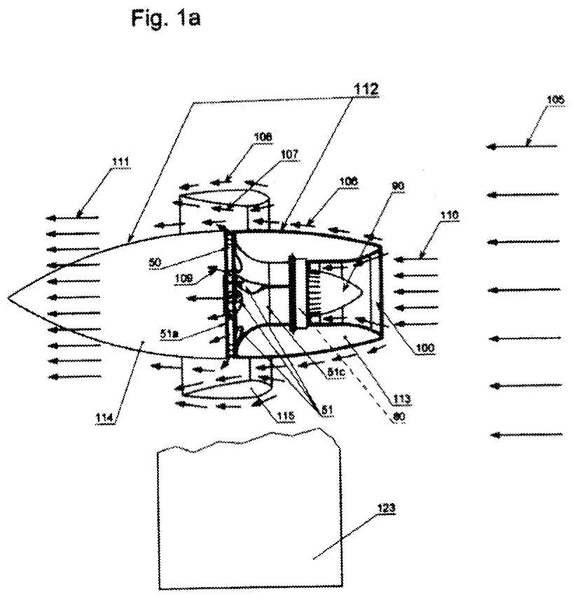

FIG. 0-1 shows an embodiment of the known energy converter in a perspective illustration;

FIG. 0-2 shows a section through the energy converter of FIG. 0-1;

FIG. 0-3 shows an internal view of the profile section 114 as a section through the energy converter of FIG. 0-1;

FIG. 0-4 shows a known design embodiment of the turbine wheel with a connection to the generator; and

FIGS. 0-4a, 0-4b show illustrations for explaining the construction and the function of the known converter wheel.

The embodiment of the energy converter shown in FIG. 0-1 and FIG. 0-2 rests on a mast 123 and includes the overall profile 112 with its parts 113, 114 which are designed as conical or coniform casings, respectively, and receive, inter alia, the functional parts of the so-called converter wheel 50 and of the turbine wheel 80. When viewed in the inflow direction 110 of the respective fluid, the converter wheel 50 is disposed after the turbine wheel 80.

The profile section 114 receives further functional components such as, for example, the generator 85 which by way of a turbine shaft 81 is connected to the turbine wheel 80 disposed in the casing of the profile section 113, FIG. 0-3. The kinetic energy of the turbine wheel 80 is transmitted with great efficiency to the turbine shaft 81 (FIG. 0-3). The high rotating speed of the turbine shaft 81 can be reduced by way of a gearbox 82, whereby the corresponding torque is increased.

The converter wheel 50 and the turbine wheel denoted by the reference sign 80 are rotatably mounted, whereby the turbine wheel 80 is co-rotationally connected to the turbine shaft 81. The generator 85, which generates electrical energy during rotation of the turbine shaft 81, is co-rotationally assembled on the turbine shaft 81 on that side of the turbine shaft 81 that lies opposite the turbine wheel 80.

The profile section 114 furthermore contains the drive motor 57 for the converter wheel 50, and a further generator 116 which is connected thereto by way of a gearbox 117. The rotation of the drive motor 57 is transmitted to the converter wheel 50 by way of arbitrary means known to the person skilled in the art.

The profile section 113 receives a tubular section 100 which serves as a supply duct. The respective fluid can flow into the interior of the supply duct by way of the end-side opening of the supply duct; the inflow direction is denoted by the reference sign 110, FIG. 0-2.

The formed component 90, which has a conically enlarged shape, is located in the end region of the tubular section 100 that faces the device for generating additional negative pressure 50, whereby guide vane parts 91 which are uniformly spaced apart from one another in the circumferential direction are fastened to the end region of the conical formed component 90 that faces the converter wheel 50, said guide vane parts 91 extending from the formed component 90 radially toward the outside up to the internal wall of the tubular section 100, FIGS. 0-2, 0-4. The guide vane parts 91 form a guide vane assembly. The lower regions 94 of the guide vane parts 91 in FIG. 0-4 that face away from the formed component are angled relative to the upper, axially running regions 95 of the guide vane parts 91 in the circumferential direction of the formed component 90. The guide vane parts 91 are curved in such a way according to FIG. 0-4 that they point downward in the rotating direction of the turbine wheel 80.

In the illustration according to FIG. 0-4, the turbine wheel 80 is located below the tubular section 100 and also below the guide vane assembly. In FIG. 0-2, which is rotated by 90° counter to the clockwise direction, the turbine wheel 80 is disposed on the left, after the guide vane parts (without reference sign) when viewed in the inflow direction 110.

The blade parts 87 of the turbine wheel 80 run away from the formed component 90 toward the side of the generator 85 and are inclined in the circumferential direction of the turbine wheel 80 so as to be counter to the regions 94 of the guide vane parts 91.

According to FIG. 0-4, the converter wheel 50 comprises between two circular disks 51a and 51b ducts 48 which are uniformly spaced apart in the circumferential direction and run in each case from the center 47 of the converter wheel 50 radially toward the outside and, shortly before the external diameter of the converter wheel 50, run at an angle counter to the rotating direction of the converter wheel 50. The ducts 52 herein open radially toward the inside into an annular antechamber 46 which is common to said ducts 52 and surrounds the annular hub part 54 of the converter wheel 50. The hub part 54, by way of its region 54a that faces the disk part 51a, runs in an arcuate manner from the longitudinal axis of the converter wheel 50 toward the outside. This ensures a particularly good and turbulence-free flow of the medium out of the antechamber 46 into the ducts 48. Above the arcuately-formed region 54a, the hub part 54 can run with the region 54b thereof concentrically to the longitudinal axis of the converter wheel and towards the ring duct 41 of the disk part 51a, which is spaced apart therefrom.

The individual ducts 48 are in each case formed by baffles 44 and 45 which, proceeding from the annular antechamber 46, run in each case rectilinearly toward the outside in the manner illustrated in FIG. 0-4a and, for forming the ducts 48, are angled in such a way that the region 43 of the duct 48, which runs approximately radially toward the outside, is formed in the rectilinear region between two adjacent baffles 44 and 45, and the region 42, which preferably runs at a right angle in relation to the region 43 running radially toward the outside, is formed between the angled end regions of the baffles 44 and 45.

During rotation of the converter wheel 50 by the drive motor 57 in the rotating direction illustrated in FIG. 0-4a, a medium located in the ducts 48 is imparted a centrifugal force Fz1 by the rotating movement at a rotating speed n. This centrifugal force Fz1 is determined by the circumferential velocity v1 at the radius r1, and by the mass m of the medium.

The centrifugal force Fz1 forces the medium in the ducts 48 toward the outside. The centrifugal force Fz2 kicks in at the radius r2, shortly before the orthogonal curvature of the ducts 48:

The centrifugal force Fz2 accelerates the mass m of the medium to a velocity v3, whereby friction losses are taken into account. A kinetic energy W3, which is to be calculated, for the mass m of the medium occurs at this point, i.e. just before the curvature of the ducts 48.

The medium is deflected counter to the rotating direction by the curvature of the ducts 48, and after the curvature is imparted a velocity v4 which, due to friction losses, is lower than the velocity v3. The kinetic energy W4 to be calculated results therefrom.

The medium exits the converter wheel 50 with a kinetic energy W4. A repulsion with the same energy is created in the process. This energy aids in driving the converter wheel 50.

In the procedure explained, a negative pressure, which has the effect that the atmospheric external pressure 62 causes the medium to be accelerated in front of the converter wheel 50 and to be supplied to the converter wheel 50 through the ring duct (FIG. 0-4b) denoted by the reference sign 41, is created in the antechamber 46. The pressure difference can be increased by increasing the rotating speed of the converter wheel 50 driven by the drive motor 57.

When the converter wheel 50 is set in rotation by the drive motor 57, the medium in the ducts 43 of the converter wheel 50 is forced toward the outside in the manner described in the context of FIG. 0-4a, which is why a negative pressure is created in the region below the turbine wheel 80, the latter being rotatably disposed in the ring duct 41. This has the consequence that the medium flows out of the tubular section 100, through the ducts formed between the guide vane parts 91, in the direction toward the blade parts 87, because of said negative pressure and because of the atmospheric pressure 62 prevalent in the tubular section 100. The turbine wheel 80 is set in rotation in the process, and transmits its rotation to the generator 85 by way of the turbine shaft, said generator 85 generating electric energy corresponding to the rotation.

The volumetric flow 40 is deflected by the formed component 90 in such a way that an optimal pressure is exerted on the blade parts 87 of the turbine wheel 80.

Fastened to the tubular section 100 that opens toward the outside is an overall profile 112 which by way of a profile section 113 surrounds a tubular section 100 referred to as a supply duct. The profile section 113 extends in the direction toward the converter wheel 50. The overall profile 112 furthermore comprises a further profile section 114 which, proceeding from the converter wheel 50, leads to the side that faces away from the profile section 113 and simultaneously serves for covering the generator and the drive space.

The overall profile 112 is disposed coaxially with the longitudinal axis which preferably runs horizontally, or with the center 47. The overall profile 112 is a round formed component which is profiled in such a way that the flow 106 is accelerated on the profile contour, whereby a negative pressure is created on the upper side of the overall profile 112, similar to the airfoil profile of an aircraft.

An outer profile ring 115 which is centrically fastened to the overall profile 112 is imparted a circulating flow 108 on its external side, and a circulating flow 107 on its internal side. The circulating flow 107 boosts the flow 106 and thus increases the velocity of the latter. The circulating flows 106, 107, 108 all lead in the direction of the “outgoing” wind flow 111. The wind direction of the inflowing wind flow is denoted by the reference sign 105.

The flow 106 with the increased velocity entrains the air flowing out of the converter wheel 50, and thus accelerates the outflow 109 on the converter wheel 50. Said outflow 109 in turn causes a negative pressure in the converter wheel 50 and thus a further increase in the pressure difference after the turbine wheel 80. The inflow rate 110 is thereby increased at the tubular section 100.

The outflow 109 at the converter wheel 50 causes a repulsion on the converter wheel 50, as has already been explained above, and sets the converter wheel 50 in rotation. This energy can be supplied to an additional generator 116, for example by way of a gearbox 117, and be converted into electrical energy.

### SUMMARY OF THE PRESENT INVENTION

Proceeding from DE 10 2010 024 621 A1, the present invention refines this technology.

The term “medium” is also used synonymously with the term “fluid”.

In the absence of a general technical term, the description “converter wheel” was chosen in the generic document for the above-mentioned device that generates the negative pressure. Since the term “converter wheel” is typically used in the automotive transmission industry and tends not to be familiar in the present technical field, mention is primarily made of a “device for generating additional negative pressure”, not least for greater clarity. It is established on the one hand in this way that this is a negative pressure which is to be distinguished from the general atmospheric pressure. It is set forth by the adjective “additional” that this is a negative pressure which is a different—and thus additional—negative pressure in comparison to the negative pressure that is created in that the above-mentioned overall profile of the device is a round formed component which is profiled in such a way that the flow is accelerated on the profile contour of the latter, whereby a negative pressure is created on the upper side of the overall profile, similar to the airfoil profile of an aircraft. In this sense, the term “device for generating additional negative pressure” explains the situation wherein this additional negative pressure is caused by this very device in relation to the atmospheric pressure prevalent in the immediate spatial environment of the device, on the one hand, and in relation to the negative pressure created as a result of the above-mentioned profile of the overall profile, on the other hand, as a result of which the inflow rate of the medium into the housing surrounding the turbine wheel is able to be regulated and in particular increased. The choice of this term is also due to the fact that the constructive design embodiment of this component is different from that of the so-called converter wheel according to the generic document, as will yet be explained in more detail hereunder. The “device for generating additional negative pressure” is therefore also not limited to a construction like that of the known converter wheel. In this sense, the term “device for generating additional negative pressure” also includes a construction, which could be designated as analogous to the known construction as a “converter wheel”.

When mention is made hereunder that the device for generating additional negative pressure is “rotatable”, it is to be pointed out already now that the device has rotatable parts which, conjointly with a non-rotating part, constitute the device. The non-rotating part is a formed disk, and the rotatable parts contain a circular disk and ducts which are disposed between the latter and the non-rotating formed disk and are formed by baffles; this will likewise be explained in more detail hereunder.

The device is conceived for converting flow energy transported via a medium into mechanical, preferably rotational mechanical, and/or electrical energy. The medium may be air, gas, liquid, or generally a fluid.

Regulating the mass of the medium flowing into the device is possible under all practical conditions in terms of use and environment, this constituting a central aspect of the present invention.

The geometry of the device, in particular the diameter of the turbine wheel and the diameter of the device for generating additional negative pressure, directly influence the use in the case of intense and weak flows of the medium and can in any case be adapted to all substantially predictable conditions in practical use.

The device can comprise a mast, foot, pedestal, base frame or the like, on or above which is disposed the device which receives the flow from water power, wind power or other flowing media. Other flowing media may include, for example, exhaust air flows from industrial plants, for example biogas plants, composting plants, or exhaust gases.

The device has an overall profile. The overall profile is the outer casing of the device and is referred to as such because said overall profile has favorable characteristics in the context of the flow of the medium due to its design, i.e. its profile. Said overall profile can in turn have at least two mutually adjacent profile sections. These profile sections are part of the outer casing of the overall profile, which can receive in particular the flow-oriented components of the device, in particular of the device for generating additional negative pressure, of the turbine wheel, and of the formed component, and—preferably—the at least one media supply line, or else can include for instance the at least one generator, the at least one drive motor, gearbox, turbine shaft, the supply duct and other parts.

As is yet to be shown, a profile section of the overall profile casing can advantageously have an inner casing which leads to the turbine wheel and contributes toward an effect that boosts the effect of the flow. The inner casing surrounding the turbine wheel can be designed as a supply duct for water, air, or other flowing media. This results in a substantially higher flow rate of the medium in the overall profile, or supply duct, respectively, i.e. in a substantially greater kinetic energy of the medium. The inner casing which surrounds the turbine wheel and can be designed as a supply duct is not limited to any particular spatial/geometric configuration. Said casing is preferably formed as a tubular section, whereby a formed component which protrudes into the end region of the tubular section is disposed on that side of the tubular section that faces the turbine wheel. The formed component is designed in such a manner that it directs the medium from the longitudinal axis of the tubular section in the direction toward the internal wall of the tubular section. The formed component is expediently designed to be conical and disposed concentrically with the tubular section. This tubular section is known from the generic document.

The formed component, which is likewise known per se from the generic prior art, of a preferred embodiment of the device according to the invention on its external circumference has guide vane parts which run in each case in the direction of the longitudinal axis of the tubular section and on the external circumference of said formed component are uniformly spaced apart from one another. In this way, a flow duct which leads to the blade parts of the turbine wheel is formed in each case between two adjacent guide vane parts, a corresponding region of the external circumference of the formed component, and a corresponding region of the internal wall of the tubular section. The blade parts of the turbine wheel are preferably uniformly spaced apart in the shape of an assembly about a circumference of the turbine wheel. Said blade parts run away from the formed component toward the side of the converter wheel, and are inclined in the circumferential direction of the turbine wheel. The number of blade parts can correspond to the number of guide vane parts, or slightly deviate therefrom for the avoidance of noise. The number of blade parts should preferably always be greater by one blade part. This means that the turbine wheel has one more blade part than the guide vane assembly, or the turbine wheel has one fewer blade part than the guide vane assembly (for the purpose of optimal covering and noise minimization).

The device according to the invention can also be operated without the above-described supply duct, so that the respective medium is directed by way of an end-side opening in the profile section designed as an inlet corpus into the interior of the overall profile, i.e. the outer casing, in the direction of the turbine wheel. In this case, the above-mentioned formed component is disposed without the supply duct in the interior of the overall profile. By virtue of the media supply line described further below, the present invention can dispense with such a supply duct. Whether such a supply duct is to be used in conjunction with the at least one media supply line, which will yet be discussed further below, depends on the respective conditions of use of the device. The invention enables the combination of both constructions and renders the invention even more universally applicable. In this way, it can be expedient to use such a combination of a supply duct and the media supply line when adhering to rather small construction modes is not that relevant.

The turbine wheel is preferably connected to a turbine shaft which for generating a current is co-rotationally connected to a generator by way of a gearbox.

Alternatively, generating energy by means of induction can also be considered. Stators provided with solenoids are supplied with a current, as a result of which the latter generates a magnetic field in the windings. The windings in the moving turbine wheel, or the moving part of the device for generating additional negative pressure, generate the current for the magnetic field in the stator, so that the current can be generated in the turbine wheel by the magnetic field in the stator and/or current can be generated by the magnetic field of the latter in the stator of the device for generating additional negative pressure. The capturing of energy depends on the rotation of the turbine wheel and also on the “device for generating additional negative pressure”, and can be increased to the desired extent.

A constant generation of current can be achieved by the generator driven by the turbine wheel of the device according to the invention in that the rotating speed of the rotatable parts of the device for generating additional negative pressure is regulated in such a way that a constant volumetric flow rate of the inflowing medium in the profile section designed as an inlet corpus, or in the supply duct, is adjusted.

Also in the context of the present invention, the device for generating additional negative pressure causes, inter alia, such an additional negative pressure in comparison to the atmospheric pressure prevalent in the device. Said device for generating additional negative pressure thus leads to a further increase in the pressure difference after the turbine wheel in comparison to the atmospheric pressure, as a result of which the inflow rate of the medium into the casing surrounding the turbine wheel is increased.

When viewed in the flow direction of the medium, the device for generating additional negative pressure is disposed behind the turbine wheel. Said device for generating additional negative pressure is rotatably disposed according to the above explanation, and is preferably located in the same axial direction as the turbine wheel. When mention is made that the device for generating additional negative pressure is rotatable, it is to be pointed out yet again, as has already been mentioned above, that the device preferably has rotatable parts which, conjointly with a non-rotating part, constitute the device. The non-rotating part is a shaped disk, and the rotatable parts contain a circular disk and ducts which are disposed between the latter and the non-rotating shaped disk and are formed by baffles; this will also be discussed in more detail hereunder. The device can be fixed to the mast, pedestal, foot, base frame, or preferably in the overall profile, in any suitable non-inventive manner.

For instance in the absence of a fluid flow, for example in the event of a lull, the device for generating additional negative pressure can be set in rotation by a drive motor. Once the device has been set in rotation, either by the drive motor or by a present flow of the medium, the rotating speed of the device for generating additional negative pressure according to one embodiment of the invention can be increased in a differentiated manner by the drive motor. As a result, the pressure difference existing between the pressure of the medium in the casing surrounding the turbine wheel and the pressure in the region of the turbine wheel is increased.

Therefore, the device for generating additional negative pressure and the turbine wheel are able to be decoupled from one another if desired, this applying to all of the described variants and embodiments of the device according to the invention. The device for generating additional negative pressure and the turbine wheel can be operated in a mutually independent manner, either by the flow of the medium acting thereon, or by a respective drive motor, the energy of the latter being obtained for example by way of an apparatus for capturing and transmitting energy, or for example by way of at least one apparatus for storing and supplying electrical energy. A differentiated increase in the rotating speed is optionally delivered to the device for generating additional negative pressure by the drive motor, depending on the flow rate, so as to vary the inflow rate in such a way that the turbine wheel has an optimal flow surrounding or passing through the latter.

In this way, it is not necessary to vary the angle of attack of the blade parts and of the guide vane parts. One preferred embodiment of the device according to the invention is designed in such a way so that said device is able to be designed with or without a guide vane assembly. In a further preferred design embodiment, the guide vane assembly is designed in such a way that the guide vanes thereof are movable and can be switched to “passage”. Furthermore, an embodiment is designed in such a way that the blades of the turbine wheel can be switched to “passage”. This means that the free inflow into the device for generating additional negative pressure (converter wheel) and the generation of energy are handled only by this device for generating additional negative pressure.

The medium, which is, for example, air and flows in at an increased flow rate additionally sets the device for generating additional negative pressure, for example in the design embodiment of a converter wheel, in rotation and drives an additional generator by way of an additional gearbox. The device for generating additional negative pressure in turn is co-rotationally disposed on a hollow shaft which is rotatably disposed on the turbine shaft.

The device for generating additional negative pressure in its interior has ducts which run from the center of said device for generating additional negative pressure toward the outside and open toward the outside, in which ducts the medium is guided toward the outside during a rotation of the device for generating additional negative pressure. The ducts preferably comprise in each case a first region which, from a centric antechamber assigned to all ducts, runs radially toward the outside, and a second region which is radially outside and angled relative to the first region approximately in the circumferential direction of the converter wheel and opens toward the outside. The ducts are in each case expediently formed in a particularly simple manner by baffles disposed in the interior of said ducts of the device for generating additional negative pressure. This is known per se from the generic prior art.

Particular design embodiments of the device according to the invention will be explained in more detail hereunder, which cause advantageous effects in particular when combined with one another.

### Design Embodiment of the Pivotability:

As has already been briefly mentioned, the overall profile of the device according to the invention is designed as an outer casing. This casing comprises the turbine wheel and the device for generating additional negative pressure which is disposed downstream of the turbine wheel in the flow direction of the medium. This casing, on the end side thereof facing the medium flow, has an opening through which the respective medium, for example the wind, can flow into the interior of the overall profile. The profile section that comprises the end-side opening of the overall profile is thus also referred to as inlet corpus for the respective medium. This inlet corpus corresponds to one of the above-mentioned at least two mutually adjacent profile sections of the overall profile. The inlet corpus can receive an inner casing which can be designed as a supply duct, as set forth.

The overall profile including the inlet corpus, in terms of its longitudinal axis is non-rotating, but is fixed to the mast, foot, pedestal, base frame, or the like.

In contrast, in one embodiment, the device according to the invention including the overall profile is designed to be pivotable into or out of the flow direction of the respective medium. The pivoting movement can be carried out by conventional drives, gearboxes, sensors and feedback controllers known to the person skilled in the art, wherein the latter will take into account, inter alia, the typical flow conditions of the respective medium, seasons, size of the device, and specific purpose. The pivoting movement can be carried out on site, remotely, controlled by an app, or automatically or by means of a combination thereof.

The possibility of “turning into the wind” and “turning out of the wind” is known per se. The difference in the pivoting movement according to the invention lies in that the latter is able to regulate the projected inflow area of the medium. The projected inflow area is formed by the end-side opening of the inlet corpus. For instance, the device can be “partially” turned out of the flow of the medium, for example of the wind, this leading to a corresponding reduction of the inflow area; “from the point of view of the medium”, the end-side opening of the inlet corpus is correspondingly reduced according to the extent of the pivoting movement, or enlarged in the opposite case. In this way, the output of the device is simultaneously able to be regulated, because the projected inflow area of the medium is decreased or increased in size. The device can also be completely turned out of the flow of the medium, for example completely turned out of the wind; in this case, the installation is fundamentally stationary. If said device is completely turned into the flow, for example into the wind, the entire energy of the flow of the medium is available in principle.

Pivoting the device from a given angular position to another angular position is important with a view to an optimal utilization of the respectively prevailing flow energy.

Correcting the pivoting angle preferably is performed permanently as a result of the varying flow conditions of the respective medium. An improved utilization of the prevailing flow energy is possible as a result. As opposed to the sluggish conventional wind wheels which receive plates, a rapid response to varying flow conditions is always possible in the case of the present invention by virtue of its somewhat different basic concept, this leading to a significant increase in efficiency in comparison to conventional wind power wheels and the transformation of energy by the latter.

Moreover, pivoting the device to an angular position leads to advantageous smoothing of the flow energy. Smaller energy peaks, for example smaller current peaks, are thus created on the at least one generator, said peaks therefore not having to be “capped” in a manner in which energy is lost, as is the case in conventional wind power wheel installations.

This results in a higher energy yield, for example current yield, derived from the original flow energy, and consequently also in a better efficiency.

Since a plurality of generators are preferably used, individual generators can be switched on or off by pivoting the device, depending on the energy demand, for example the current demand. This means an optimal utilization of the prevailing flow energy.

It is furthermore to be mentioned that the rapid pivoting of the device serves in protecting the device in relation to damage or even destruction of parts of the device.

The device can be pivoted in various ways, whereby a combination of the pivoting movements is also possible. Pivoting of the device can be performed centrically about a vertical axis. Furthermore, pivoting of said device can be performed eccentrically about a vertical axis. Finally, pivoting can be performed about a spatial axis.

The incident flow angle of the medium, or of the fluid, respectively, which is influenced by pivoting the device, and regulating said incident flow angle, directly influence the rotating speed of the device for generating additional negative pressure, thus for example of the converter wheel and of the turbine wheel. The influence on the outer casing of the overall profile leads to a negative pressure at the device for generating additional negative pressure, and thus influences the rotating speed of the device for generating additional negative pressure by virtue of the repulsion behavior explained above. The profile section is designed in such a way that a negative pressure is created by the axial flow in the region of the device for generating additional negative pressure (similar to an airfoil). This negative pressure has the effect that the medium, for example air, located in the device for generating additional negative pressure flows from the center of the device for generating additional negative pressure toward the outside, and flows out through guide vanes of the device for generating additional negative pressure counter to the rotating direction, thus causing a repulsion that sets the device for generating additional negative pressure in rotation, which may also be referred to as principal of linear momentum. If the device for generating additional negative pressure, thus for example the converter wheel, is additionally driven, an output which is largely returned by the repulsion is required; only that output created by friction losses has to be supplied.

This has the consequence that the rotating speed of the device for generating additional negative pressure is increased when the device is pivotable into the flow direction of the respective medium. In this way, the pressure in front of the turbine wheel is simultaneously increased, as a result of which the inflow rate to the turbine is simultaneously increased. This in turn leads to an increase in the turbine output, which consequently increases the output of the at least one generator which is connected to the turbine wheel by way of the turbine shaft.

In contrast, if the device is pivoted out of the flow direction of the respective medium, the rotating speed of the device for generating additional negative pressure is reduced according to the extent of the pivoting movement. In this way, the pressure in front of the turbine wheel is simultaneously reduced, as a result of which the inflow rate to the turbine is simultaneously reduced. This in turn leads to a reduction in the turbine output, which consequently minimizes the output of the at least one generator which is connected to the turbine wheel by way of the turbine shaft.

The pivotability of the device according to the invention into or out of the flow direction of the respective fluid is thus a preferred aspect of the present invention.

### Design Embodiment of the Device for Generating Additional Negative Pressure:

In another variant of the invention, a further increase in the efficiency of the device in comparison to the generic converter wheel according to patent application DE 10 2010 024 621 A1 is already achieved per se by a constructive design embodiment of the device for generating additional negative pressure.

It is particularly advantageous if the described pivotability of the device into or out of the flow direction of the respective medium is combined with this variant described hereunder:

The device for generating additional negative pressure for the purpose of differentiation of the negative pressure which is present anyway by virtue of the outer casing in the device according to the invention, see above, is provided with the adjective “additional” because the device by virtue of the rotation of its rotatable parts generates an independent, consequently additional, negative pressure in comparison to this present negative pressure. “Generating” means in particular “boosting”. “Generating” in this sense also means “influencing”, which may be associated with a controllable reduction of the additional negative pressure, for instance when this device is decelerated in terms of its rotational behavior in the case of an excessive flow of the medium. The present negative pressure in the device can furthermore be additionally boosted when a dedicated drive is used; the negative pressure present in the device can furthermore be independently boosted, without the drive being used, by virtue of the energy stored in the device or in a dedicated storage medium, this being correlated with the so-called gyrating mass of the device. The invention dispenses with any compression of the medium. Likewise, combustion is not required.

Accordingly, the device for generating additional negative pressure, for example the converter wheel, is rotatably disposed in the above-mentioned inlet corpus of the overall profile of the device according to the following explanations. Said device has a non-rotating front formed disk when viewed in the inflow direction of the respective medium. This formed disk preferably runs in an arcuate manner from the longitudinal axis of the device for generating additional negative pressure toward the outside, whereby the arcuate profile particularly preferably increasingly flattens in the outward direction. Instead of such an arcuate profile, the formed component can also assume a corresponding cascading or stepped profile. The device for generating additional negative pressure, i.e. for example the converter wheel, when viewed in the inflow direction of the respective fluid, has a rotatable rear formed disk which is spaced apart from this front formed component.

The ducts and baffles as well as the inner inlet duct are disposed in a manner known per se between this front non-rotating formed disk and the rear rotating circular disk. The blade assembly, the mounting for the turbine wheel and the receptacle bearing for the bearing flange for the device for generating additional negative pressure are also disposed in this region. These constituent parts are described above in the context of FIGS. 0-4a and 0-4b pertaining to patent application DE 10 2010 024 621 A1, reference been made thereto herewith.

However, it is substantial in terms of this variant of the invention that the front formed disk of the device for generating additional negative pressure is non-rotating, and that said device in addition to the inner inlet duct has at least one opening, advantageously a plurality of openings, which permit the respective medium to flow, thus to “pass through”, into the ducts disposed between the non-rotating front formed disk and the rotatable rear circular disk. Because this is an opening which is to be differentiated from the inner inlet duct in terms of function, said opening is referred to as “further passage”.

These further passages can be disposed for instance in the shape of a rim on the external periphery of the non-rotating formed disk, or in a star-shaped manner, like a chandelier, along their arcuate profile, or have a combination thereof or any regular or irregular arrangement. One or a plurality of slot-type or duct-shaped or other elongate passages, or a passage or passages which continues/continue so as to proceed from the inner inlet duct in the direction of the external circumference of the non-rotating formed disk is/are also conceivable.

The at least one further passage, by means of its arrangement or design embodiment in or on the non-rotating formed disk of the device for generating additional negative pressure is suitable for either accelerating or decelerating the rotatable parts of the device for generating additional negative pressure.

During rotation of the rotatable parts of the device for generating additional negative pressure in the rotating direction, initialized by the drive motor or by a present flow, for instance, a medium located in the ducts of this device is imparted a centrifugal force by the rotating movement at a rotating speed “n”; this centrifugal force is determined by the circumferential velocity on the radius and the mass of the fluid. The centrifugal force forces the medium in the ducts toward the outside. The medium is deflected counter to the rotating direction by a curvature of the ducts, and after the curvature is imparted a kinetic energy by means of which said medium exits the device for generating additional negative pressure. A repulsion with the same energy is created in the process. This energy helps to drive the device for generating additional negative pressure. In the procedure explained, an additional negative pressure is created in the device, which by virtue of the lower atmospheric external pressure has the effect that the medium is accelerated in front of the device. Thus in terms of the physical processes, additional reference is made to the explanations pertaining to the generic prior art.

Depending on the speed of the rotating movement of the rotatable parts of the device for generating additional negative pressure, the medium, or fluid, respectively, is supplied through the inner inlet duct, for example a ring duct, and—in terms of the inner inlet duct-through the above-mentioned at least one further passage of the device for generating additional negative pressure at a corresponding flow rate.

During rotation of the rotatable parts of the device for generating additional negative pressure, the medium, or fluid, respectively, flowing into the ducts of the device for generating additional negative pressure is forced toward the outside, which is why a negative pressure is created in the region of the turbine wheel which is rotatably disposed in the inner inlet duct of the device for generating additional negative pressure. This has the consequence that, because of the negative pressure mentioned and because of the atmospheric pressure prevalent in the inlet corpus or in the supply duct, the medium flows out of the inlet corpus of the overall profile, or out of a supply duct disposed in the latter, through the ducts formed between the guide vane parts of the formed component disposed thereon in the direction of the blade parts of the turbine wheel. The turbine wheel is set in rotation in the process, and transmits its rotation to the generator by way of the turbine shaft, said generator generating energy corresponding to the rotation.

The above-mentioned at least one further passage in the non-rotating front formed disk, by way of its design embodiment per se, preferably already contributes toward enabling a further increase in the negative pressure, and thus already an increase in the rotating speed of the rotatable converter wheel, and thus in turn an increase in the flow rate, consequently also in the flow energy, in comparison to a design embodiment in which the non-rotating formed disk of the device for generating additional negative pressure possesses only one inner inlet duct.

The effect of the at least one further passage in the non-rotating front formed disk of the device for generating additional negative pressure herein can also be increased in that said further passage has a design embodiment which deflects the medium in the rotating direction of the device for generating additional negative pressure. Such a design embodiment can be, for instance, a blade part which protrudes into the passage or out of the latter, a corresponding protrusion, a corresponding bead, an additional perforation, an oblique punching of the passage in the material of the formed disk. As a result, the medium impacting the non-rotating formed disk accelerates the rotating speed of the device for generating additional negative pressure in that a partial deflection of the medium into the mention ducts of the device for generating additional negative pressure in the rotating direction of the latter takes place.

The at least one further passage can also be regulated. The type of regulation is possible in various ways. Hydraulic, purely mechanical or electronic measures, or combinations thereof, can be considered. In this way, a regulating flap or a slide assembly or an aperture is possible in the at least one further passage in the non-rotating formed disk of the device for generating additional negative pressure.

If desired, the effect of the at least one further passage in the non-rotating front formed disk of the device for generating additional negative pressure can conversely also be reduced, i.e. decelerated, in that said further passage has a design embodiment which deflects the medium counter to the rotating direction of the device for generating additional negative pressure. Such a design embodiment can be, for instance, a blade part which protrudes into the passage or out of the latter, a corresponding protrusion, a corresponding bead, an additional perforation, an oblique punching of the opening in the material of the formed disk. As a result, the medium impacting the non-rotating formed disk decelerates the rotating speed of the device for generating additional negative pressure in that a partial deflection of the medium into the mentioned ducts of the device for generating additional negative pressure counter to the rotating direction of the latter takes place.

The accelerating inflow of the medium in the rotating direction of the device for generating additional negative pressure, and the decelerating inflow of the medium counter to the rotating direction of the device for generating additional negative pressure, can also be carried out alternatingly. For this purpose, it is expedient to attach at least two further passages in the non-rotating formed disk of the device for generating additional negative pressure, which passages can be spatially offset on the formed disk which runs in an arcuate manner from the longitudinal axis of the device for generating additional negative pressure to the outside, for example. One of these at least two further passages then serves for acceleration, while the other serves for deceleration. It is particularly advantageous for a plurality of further passages to be in each case disposed for acceleration and for deceleration, said further passages being in each case disposed at the same mutual spacing, which leads to an advantageous synchronization of the acceleration or deceleration procedure. It is particularly preferable for these further passages, which are provided for the alternating acceleration or breaking procedure, to be attached in the form of a rim in the non-rotating formed disk of the device for generating additional negative pressure. Two annular passages which have transverse webs are also suitable.

The alternating function of the further passages provided for the acceleration or deceleration procedure in the non-rotating formed disk of the device for generating additional negative pressure can be selected by any suitable mechanical and/or electronic control, for example by a slide assembly which closes or opens the passages, by adjustable slats, regulating flaps, apertures.

Design Embodiment of the Inlet Corpus with Media Supply Line:

In a further embodiment of the invention, which can be combined with one or both proceedings variants of the invention, the device for generating additional negative pressure, by way of its arrangement, interacts with at least one media supply line in the inlet corpus of the device, said media supply line supplying the respective medium to the device for generating additional negative pressure in the rotating direction of the latter and/or counter to the rotating direction of the latter.

The type of supply of the medium into the device for generating additional negative pressure can be based on any construction available to the person skilled in the art. However, it is particularly advantageous for the at least one media supply line to supply the respective medium to the device for generating additional negative pressure in the rotating direction and/or counter to the rotating direction of the device by way of the at least one further passage of the latter in the non-rotating formed disk.

Such a design embodiment can also be combined with the variant of the invention that comprises the above-described pivotability of the device.

The at least one media supply line runs from the end-side opening of the inlet corpus and/or from an outer inflow hood disposed on the inlet corpus in the direction of the non-rotating formed disk of the device for generating additional negative pressure. The inlet corpus preferably contains at least one outer inflow hood by way of which the medium can flow into the at least one media supply line.

If that end of the at least one media supply line that faces away from the end-side opening of the inlet corpus points in the rotating direction of the device for generating additional negative pressure, this is the position of the media supply line that contributes toward accelerating the rotating speed of the device for generating additional negative pressure when the respective medium is supplied through the media supply line to the device for generating additional negative pressure in the rotating direction of the latter.

If that end of the at least one media supply line that faces away from the end-side opening of the inlet corpus points counter to the rotating direction of the device for generating additional negative pressure, this is the position of the media supply line that contributes toward decelerating the rotating speed of the device for generating additional negative pressure when the respective medium is supplied through the media supply line to the device for generating additional negative pressure counter to the rotating direction of the latter.

It is preferable herein that the inlet corpus has in each case at least one media supply line which supplies the respective medium to the device for generating additional negative pressure in the rotating direction of the latter and counter to the rotating direction of the latter in such a way that the rotating speed of the device for generating additional negative pressure can be accelerated or decelerated depending on the situation of the flow conditions of the medium, in that the respective medium is supplied through the media supply line to the device for generating additional negative pressure in or counter to the rotating direction of the latter. This can be performed by means of corresponding regulating. It is particularly preferable for the inlet corpus to have more than two media supply lines, in particular four, or more preferably six, or most preferably eight, media supply lines which point in and counter to the rotating direction of the device for generating additional negative pressure. A number of media supply lines deviating therefrom may also be provided.

Moreover, if a plurality of media supply lines are used for the accelerating rotating speed and/or for the decelerated rotating speed, it is advantageous for said media supply lines to be disposed at an identical mutual spacing, wherein a rim-shaped arrangement is particularly preferable for a uniform rotating speed or for a uniform rotating speed profile of the device for generating additional negative pressure. In particular the last-mentioned design embodiment makes it possible for example to place the media supply lines that are intended to contribute toward an accelerating rotating speed in an outer annular arrangement, while the media supply lines that are intended to contribute toward a decelerating rotating speed are provided in an inner annular arrangement. It goes without saying that the arrangement can also be reversed.

Instead of different annular arrangements of the media supply lines of this type, it can also be considered to dispose the media supply lines for the accelerating rotating speed or for the decelerated rotating speed of the device for generating additional negative pressure alternatingly, for which purpose a single annular arrangement of the media supply line would be sufficient, for example.

If a central supply duct is additionally provided in the inlet corpus corresponding to the generic prior art outlined in the context of above FIG. 0-2 and FIG. 0-4, in the case of a rim-shaped arrangement of a plurality of media supply lines for the accelerating rotating speed or the decelerated rotating speed of the device for generating additional negative pressure, those media supply lines that contribute toward an accelerating rotating speed can be disposed in a rim-shaped manner outside the central supply duct, consequently be disposed in the outer region of the inflow duct, while those media supply lines that contribute toward a decelerated rotating speed run within the central supply duct, consequently are disposed in the inner region of the inflow duct, for example. It goes without saying that a reversed arrangement can also be considered.

The media supply lines per se are advantageously fixed, i.e. the individual media supply line cannot be moved in an accelerating or decelerating inflow direction, respectively. The latter is however possible.

In all preceding arrangements of the media supply lines, the spatial arrangement of the at least one further passage in the non-rotatable formed disk of the device for generating additional negative pressure expediently follows the arrangement of the associated media supply line.

The design embodiment of the media supply line in terms of construction and material can be implemented in an arbitrary manner by the person skilled in the art. Said design embodiment can be dependent on the climatic basic conditions of the respective region in which the device is to be used. Said design embodiment can differ depending on whether air, exhaust gas, water, oil or the like is to be used as the medium. In terms of its geometric design, said design embodiment can have a tubular cross section. This cross-section may have any shape, for example be cylindrical, oval, square, polygonal, etc. The embodiment can be rigid or have rigid structures, but may also be flexible, i.e. have elastic structures, consequently be in the shape of a hose, or else have a combination of these structures.

The functional connection of that end of the at least one media supply line that faces away from the end-side opening of the inlet corpus to the non-rotating formed disk can likewise be performed in various ways. For example, the media supply line can open into the non-rotating formed disk and, conjointly with the latter, form a unit. Another possibility lies in that the media supply line first opens into a ring duct, and then opens into the non-rotating formed disk by way of one or a plurality of elbows. It is also possible to allow the media supply line to end shortly before contacting the non-rotating formed disk. It is preferable to dispose the media supply line that causes the accelerating rotating speed of the rotating parts of the device for generating additional negative pressure in such a way that said media supply line meets that further passage that by way of its design embodiment or arrangement in turn contributes to the accelerating effect of the device for generating additional negative pressure. Conversely, it is preferable to dispose the media supply line that causes the decelerating rotating speed of the rotating parts of the device for generating additional negative pressure in such a way that said media supply line meets that further passage that by way of its design embodiment or arrangement in turn contributes to the decelerating effect of the device for generating additional negative pressure.

In this context, it is furthermore preferable that the at least one media supply line in terms of receiving and transmitting the medium, and the quantity of the latter, is able to be regulated in such a way that the respective flow conditions of the medium prevalent at the site of this device can be taken into account. In this context, it is likewise preferable that the at least one further passage in the non-rotating formed disk of the device for generating additional negative pressure in terms of receiving and transmitting the medium, and the quantity of the latter, is able to be regulated in such a way that the respective flow conditions of the medium prevalent at the site of this device can be taken into account. A combination of regulatory mechanisms at the sites mentioned can also be considered.

The manner of regulating is possible in various ways. Hydraulic, purely mechanical or electronic measures, or a combination thereof, can be considered. In this way, regulating flaps in the media supply line, or a slide assembly, or an aperture in the at least one further passage in the non-rotating formed disk of the device for generating additional negative pressure is possible, for instance. Furthermore, rotary flaps, rotary slides, throttle valves, or the like, can be considered, for example. The variations being considered to this extent tend to be of secondary importance in terms of the present invention. For reasons of simplified visualization, regulating flaps which can be used in the media supply lines are to be mentioned so as to represent all these variations. The respective regulating flap can be disposed at different positions of the media supply line, or even in the non-rotating formed disk.

A substantial aspect consequently lies in that the at least one media supply line has a regulating flap which is designed to regulate the mass of the inflowing medium. This is preferably performed in that all or part of the regulating flaps can be completely or partially opened and completely or partially closed. The selection of the respective regulating flaps, and/or the complete, partial opening and closing of the regulating flaps, can preferably be performed by a PID controller. A proportional integral differential (PID) controller is advantageous because continuous modulated regulating of the regulating flaps increases the efficiency of the device according to the invention. As a result of PID controllers it is possible to continuously calculate the current actuated values of the regulating flaps as a difference between a desired target value and a measured process variable, and to apply a correction which is based on proportional, integral and differential principles. PID controllers are standard controllers often used, and are the industry-standard in many sectors, consequently known in detail to the person skilled in the art, so that they need not be discussed in more detail in the context of the present description. However, it is to be pointed out that the person skilled in the art is not limited to this type of controller and may select any suitable variant of controller, as long as the latter is able to carry out only the above-mentioned opening and closing of the regulating flaps.

As explained, in this design embodiment of the invention it is important in terms of the actuation and the regulating of the device in order to optimally utilize the flow energy from water power and wind power or other flowing media whether the media supply lines in the inflow duct of the inlet corpus are disposed in the rotating direction of the device for generating additional negative pressure, for example of the converter wheel, or counter to the rotating direction of the device for generating additional negative pressure, for example of the converter wheel.

The effects of these arrangements and the inflow of the medium defined thereby in conjunction with the regulating flaps control will be explained hereunder, wherein it applies throughout to the combination of the above-mentioned embodiment, which has at least one media supply line and at least one further passage:
at least one media supply line is provided;
the at least one media supply line is disposed within the inflow duct of the inlet corpus;
said at least one media supply line is disposed in such a manner that it points “in the rotating direction” or “counter to the rotating direction” of the device for generating additional negative pressure, for example of the converter wheel;
“in the rotating direction” is an arrangement in which an acceleration of the rotating speed of the rotatable parts of the device for generating additional negative pressure is made possible as a result of the flow of the medium in the respective media supply line toward the device for generating additional negative pressure;
“counter to the rotating direction” is an arrangement in which deceleration of the rotating speed of the rotatable parts of the device for generating additional negative pressure is made possible as a result of the flow of the medium in the respective media supply line toward the device for generating additional negative pressure;
the at least one media supply line is provided with a regulating flap which can be moved to an open position (“open”) and to a closed position (“closed”) or to an intermediate position thereof;
the rotating speed and/or the torque of the device for generating additional negative pressure are/is influenced as a function of whether the media supply line points “in the rotating direction” or “counter to the rotating direction” of the device for generating additional negative pressure, for example of the converter wheel, and of whether the regulating flap is moved to an open position (“open”) or to a closed position (“closed”) or to an intermediate position thereof; in that either an acceleration or deceleration of the rotating speed of the rotatable parts of said device for generating additional negative pressure takes place;
varying the rotating speed of the device for generating additional negative pressure directly influences the rotating speed and the torque, consequently the output of the turbine wheel;
if two media supply lines are provided, it is advantageous for one of them to point “in the rotating direction” and the other to point “counter to the rotating direction” of the device for generating additional negative pressure;
if more than two media supply lines are provided, the latter can be disposed in any spatial/geometric manner within the inflow duct of the inlet corpus, for example in an X-shaped arrangement, U-shaped arrangement, circular arrangement or in a double-circular arrangement having an inner and outer region; for reasons of a uniform representation, the latter arrangement is to be assumed hereinafter without any limitation thereto being implied.

In the following arrangement, the regulating flaps and media supply lines are disposed in an outer and/or inner region within the inflow duct of the inlet corpus in such a manner that the media supply lines point in the rotating direction of the device for generating additional negative pressure:

“In the rotating direction” is an arrangement in which an acceleration of the rotating speed of the device for generating additional negative pressure is made possible as a result of the flow of the medium in the respective media supply line toward the device for generating additional negative pressure. The rotating speed and the torque of the device for generating additional negative pressure are influenced by the extent of the open position (“open”) and closed position (“closed”) of the regulating flaps, besides the material characteristics of the medium flowing through the media supply lines.

Regulating flaps “open” means greater repulsion on the converter wheel, which in turn means more torque at a higher rotating speed and thus more output; regulating flaps “closed” means less repulsion on the converter wheel, which in turn means less torque at a lower rotating speed and thus less output.

The variation of the rotating speed and/or of the torque of the device for generating additional negative pressure furthermore directly influences the rotating speed and the torque of the turbine wheel. The regulating flaps in the “open” position leads to an increase in the pressure at the turbine wheel, i.e. there is more torque at a higher rotating speed prevalent on the turbine wheel, which is associated with more output; the regulating flaps in the “closed” position causes a reduction in pressure on the turbine wheel, which means less torque at a lower rotating speed and thus less output.

In the following arrangement, the regulating flaps and media supply lines are disposed in an outer and/or inner region within the inflow duct of the inlet corpus in such a manner that the media supply lines point counter to the rotating direction of the device for generating additional negative pressure:

“Counter to the rotating direction” is an arrangement in which deceleration of the rotating speed of the device for generating additional negative pressure is made possible as a result of the flow of the medium in the respective media supply line toward the device for generating additional negative pressure. The rotating speed and the torque of the device for generating additional negative pressure are influenced by the extent of the open position (“open”) and closed position (“closed”) of the regulating flaps, besides the material characteristics of the medium flowing through the media supply lines.

Regulating flaps “open” means that the converter wheel is decelerated, which in turn means less torque at a lower rotating speed and thus less output; regulating flaps “closed” means normal repulsion on the converter wheel, which in turn means normal torque at a corresponding rotating speed and thus normal output.

The variation of the rotating speed and/or of the torque of the device for generating additional negative pressure furthermore directly influences the rotating speed and the torque of the turbine wheel. The regulating flaps in the “closed” position leads to an increase in the pressure at the turbine wheel, i.e. there is more torque at a higher rotating speed prevalent on the turbine wheel, which is associated with more output; the regulating flaps in the “open” position causes a reduction in pressure on the turbine wheel, which means less torque at a lower rotating speed and thus less output.

In the following arrangement, the regulating flaps and media supply lines are disposed in an outer and inner region within the inlet duct of the inlet corpus in a combined manner such that the media supply lines in the inner region (“internal”) point in the rotating direction of the device for generating additional negative pressure, while the media supply lines in the outer region (“external”) point counter to the rotating direction of the device for generating additional negative pressure:

“In the rotating direction” is an arrangement in which an acceleration of the rotating speed of the device for generating additional negative pressure is made possible as a result of the flow of the medium in the respective media supply line toward the device for generating additional negative pressure; “counter to the rotating direction” is an arrangement in which deceleration of the rotating speed of the device for generating additional negative pressure is made possible as a result of the flow of the medium in the respective media supply line toward the device for generating additional negative pressure. The rotating speed and the torque of the device for generating additional negative pressure are influenced by the extent of the open position (“open”) and closed position (“closed”) of the regulating flaps, besides the material characteristics of the medium flowing through the media supply lines.

Regulating flaps “open” in the media supply lines “internal” in the rotating direction means greater repulsion on the converter wheel, which in turn means more torque at a higher rotating speed and thus more output; regulating flaps “closed” in the media supply line “internal” in the rotating direction means less repulsion on the converter wheel, which in turn means less torque at a lower rotating speed and thus less output.

The variation of the rotating speed and/or of the torque of the device for generating additional negative pressure in the media supply lines “internal” in the rotating direction furthermore directly influences the rotating speed and the torque of the turbine wheel. The regulating flaps in the “open” position lead to an increase in the pressure at the turbine wheel, i.e. more torque at a higher rotating speed is prevalent on the turbine wheel, which is associated with more output; the regulating flaps in the “closed” position cause a reduction in pressure on the turbine wheel, which means less torque at a lower rotating speed and thus less output.

Regulating flaps “open” in the media supply lines “external” counter to the rotating direction means that the converter wheel is decelerated, which in turn means less torque at a lower rotating speed and thus less output; regulating flaps “closed” in the media supply lines “external” counter to the rotating direction means normal repulsion on the converter wheel, which in turn means normal torque at corresponding rotating speed and thus normal output.

The variation of the rotating speed and/or of the torque of the device for generating additional negative pressure in the media supply lines “external” counter to the rotating direction furthermore directly influences the rotating speed and the torque of the turbine wheel. The regulating flaps in the “closed” position leads to an increase in the pressure at the turbine wheel, i.e. more torque at a higher rotating speed is prevalent on the turbine wheel, which is associated with more output; the regulating flaps in the “open” position causes a reduction in pressure on the turbine wheel, which means less torque at a lower rotating speed and thus less output.

It goes without saying that the above-mentioned combination can also be disposed inversely in such a manner that the media supply lines “internal” point counter to the rotating direction of the device for generating additional negative pressure, while the media supply lines “external” point in the rotating direction of the device for generating additional negative pressure.

“In the rotating direction” is an arrangement in which an acceleration of the rotating speed of the device for generating additional negative pressure is made possible as a result of the flow of the medium in the respective media supply line toward the device for generating additional negative pressure; “counter to the rotating direction” is an arrangement in which deceleration of the rotating speed of the device for generating additional negative pressure is made possible as a result of the flow of the medium in the respective media supply line toward the device for generating additional negative pressure. The rotating speed and the torque of the device for generating additional negative pressure are influenced by the extent of the open position (“open”) and closed position (“closed”) of the regulating flaps, besides the material characteristics of the medium flowing through the media supply lines.

Regulating flaps “open” in the media supply lines “internal” counter to the rotating direction means that the converter wheel is decelerated, which in turn means less torque at a lower rotating speed and thus less output; regulating flaps “closed” in the media supply lines “internal” counter to the rotating direction means normal repulsion on the converter wheel, which in turn means normal torque at corresponding rotating speed and thus normal output.

The variation of the rotating speed and/or of the torque of the device for generating additional negative pressure in the media supply lines “internal” counter to the rotating direction furthermore directly influences the rotating speed and the torque of the turbine wheel. The regulating flaps in the “closed” position leads to an increase in the pressure at the turbine wheel, i.e. more torque at a higher rotating speed is prevalent on the turbine wheel, which is associated with more output; the regulating flaps in the “open” position causes a reduction in pressure on the turbine wheel, which means less torque at a lower rotating speed and thus less output.

Regulating flaps “open” in the media supply lines “external” in the rotating direction means greater repulsion on the converter wheel, which in turn means more torque at a higher rotating speed and thus more output; regulating flaps “closed” in the media supply lines “external” in the rotating direction means less repulsion on the converter wheel, which in turn means less torque at a lower rotating speed and thus less output.

The variation of the rotating speed and/or of the torque of the device for generating additional negative pressure in the media supply lines “external” in the rotating direction furthermore directly influences the rotating speed and the torque of the turbine wheel. The regulating flaps in the “open” position leads to an increase in pressure on the turbine wheel, i.e. more torque at a higher rotating speed is prevalent on the turbine wheel, which is associated with more output; the regulating flaps in the “closed” position causes a reduction in pressure on the turbine wheel, which means less torque at a lower rotating speed and thus less output.

Furthermore, for example in an outer or inner annular arrangement, media lines can be provided which (in conjunction with regulating flaps) lead to an inflow of the medium in or counter to the rotating direction, or alternatingly in and counter to the rotating direction, of the device for generating additional negative pressure, and thus lead to an externally decelerating or internally accelerating, or internally decelerating or externally accelerating, effect of the inflow of the medium and thus of the rotating speed of the device for generating additional negative pressure. The mode of action herein is derived from the above explanations.

The device according to the invention in all above-described variants and embodiments can be operated in an entirely autonomous manner in terms of energy supply, which can be considered a preferred embodiment of the invention. For this purpose, the device is connected to an apparatus for capturing and transmitting energy, preferably by way of a line which within the mast is routed into the overall profile, where this line is connected to the drive motor of the device for generating additional negative pressure. This apparatus for capturing and transmitting energy is preferably one for capturing and transmitting solar energy, and may be a photovoltaic installation, a solar panel system, or a similar system. If water or wave energy is used as the medium, this may be an apparatus for capturing and transmitting energy that can be used in this technical field. The same applies to all medium-specific apparatuses for capturing and transmitting energy.

Furthermore, the device according to all above-described variants is preferably connected to at least one or a plurality of apparatuses for storing and supplying electrical energy. This herein can be at least one so-called power station, at least one accumulator, at least one accumulator pack, or similar. If a plurality of apparatuses of this type are functionally connected to one another, this can be performed by means of a line. The at least one apparatus for storing and supplying electrical energy is connected to the generator disposed in the overall profile by way of a line which partially runs in the mast, for example; as a result of this connection, the (electrical) energy generated by the generator can be stored in the apparatus for storing and supplying electrical energy; any consumer can be supplied with (electrical) energy in this way. Furthermore, the apparatus for storing and supplying electrical energy can also be connected in the above-described manner to the generator assigned to the device for generating additional negative pressure; it is made possible as a result that the apparatus for storing and supplying electrical energy is fed solely by way of the rotation of the device for generating additional negative pressure when an input of energy takes place only by way of the device for generating additional negative pressure, for example the converter wheel, and the generator of said device—for instance because the energy input by way of the turbine wheel and its generator is switched off. Moreover, the apparatus for capturing and transmitting energy can be connected directly to the apparatus for storing and supplying electrical energy by way of a line in such a way that the latter can also be supplied with energy by way of the apparatus additionally or alternatively to the energy generated by way of the turbine wheel and the generator. It is likewise possible by conventional regulating to ensure an input of energy into the apparatus for storing and supplying electrical energy by way of the device for generating additional negative pressure, for example the converter wheel, and the generator assigned thereto. The design embodiment thus permits a multifunctional operation of the device according to the invention that can take into account existing or anticipated environmental conditions or climatic conditions. For example, if the medium is wind, and there is a lull or a weak wind prevalent, for instance, the device for generating additional negative pressure, for example the converter wheel, can be set in rotation, for example, by way of the at least one apparatus for capturing and transmitting energy and the energy delivered by or by way of the latter to the drive motor of the device for generating additional negative pressure in such a way that the turbine wheel can be set in rotation by way of the negative pressure generated by the device for generating additional negative pressure, and the energy generated by the latter by way of the generator can in any case again be partially supplied to the apparatus for storing and supplying electrical energy; it is furthermore possible that enough wind flow is generated in this way by means of generating the negative pressure so as to utilize said wind flow for generating energy even in such a case of a lull or weak wind; or it is possible to completely or partially pivot the device out of the flow of the medium in the case of an excessive flow of the medium, as explained, and nevertheless maintain the function of energy capturing, the utilization of already stored energy. The same also applies to weak wind, the latter being able to be optimally utilized in this way, which is made possible in that the device for generating additional negative pressure can be utilized so as to be intermittently adapted to the weak wind, for example.

The device according to the invention in all variants and embodiments described is particularly advantageously designed if said device is provided with a preferably interchangeable louvre, mesh, net, or a mat with openings, or the like, in the region of the end-side opening or, when viewed in the flow direction, in front of the turbine wheel or in front of the device for generating additional negative pressure. Dirt particles, insects or other undesirable substances located in the medium can be filtered in this way. This not only ensures a purer medium but also generally avoids that particles of this type can block or damage the components of the device, or that birds can make their way into the inlet corpus, for instance.

The invention will henceforth be explained in more detail by means of exemplary embodiments to which said invention is not limited. In the figures:

FIG. 1, FIG. 1a and FIG. 1b: show the device according to the invention in a basic form, in a perspective illustration;

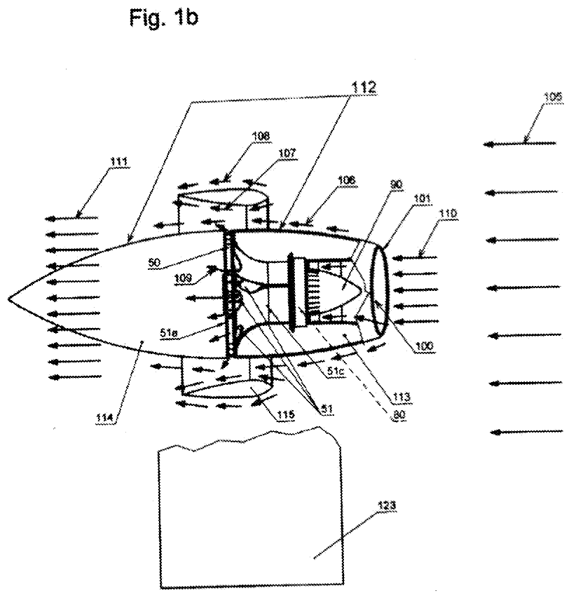

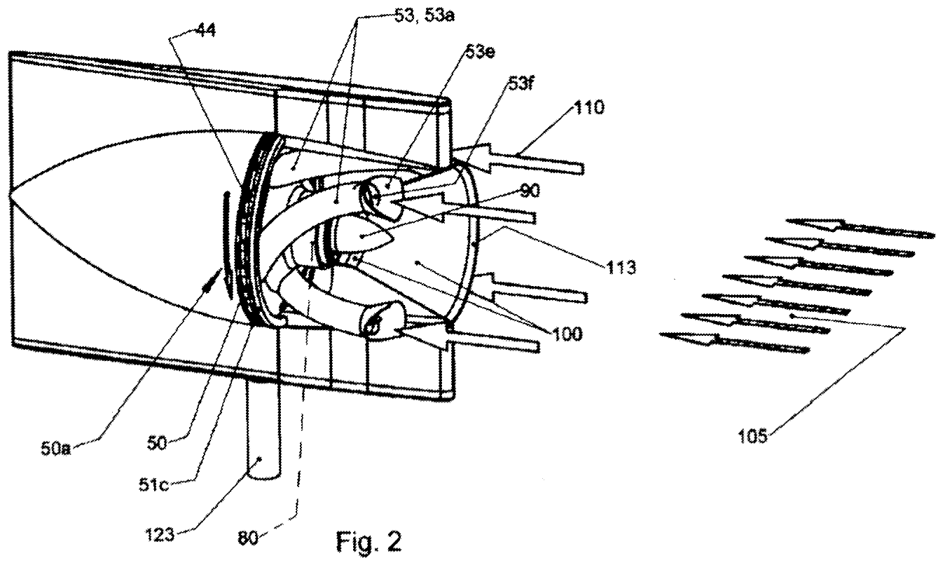

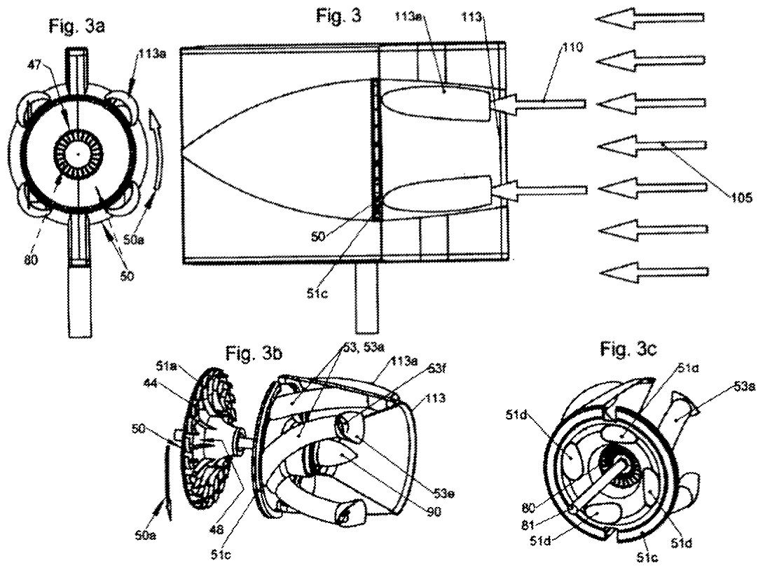

FIG. 2, FIG. 3, FIGS. 3a-c: show an embodiment of the device according to the invention having “externally accelerating” regulating flaps, i.e. regulating flaps and media supply lines external on the inflow duct of the inlet corpus, i.e. the media supply lines point in the rotating direction of the device for generating additional negative pressure, in perspective illustrations;

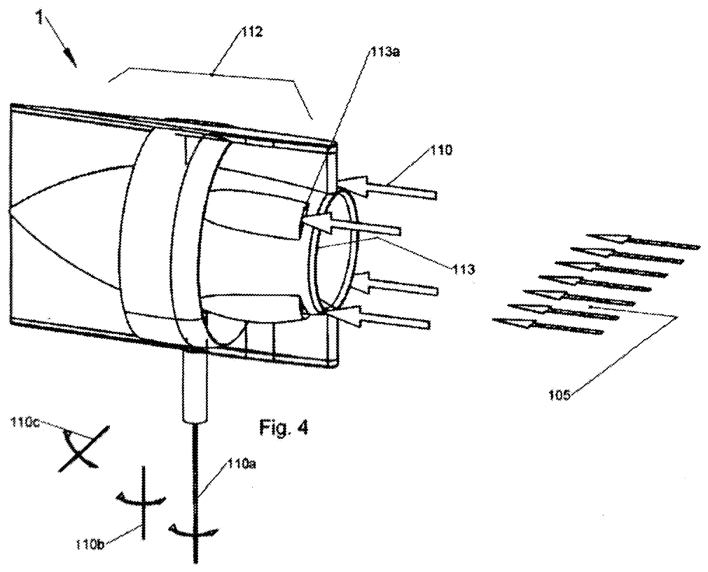

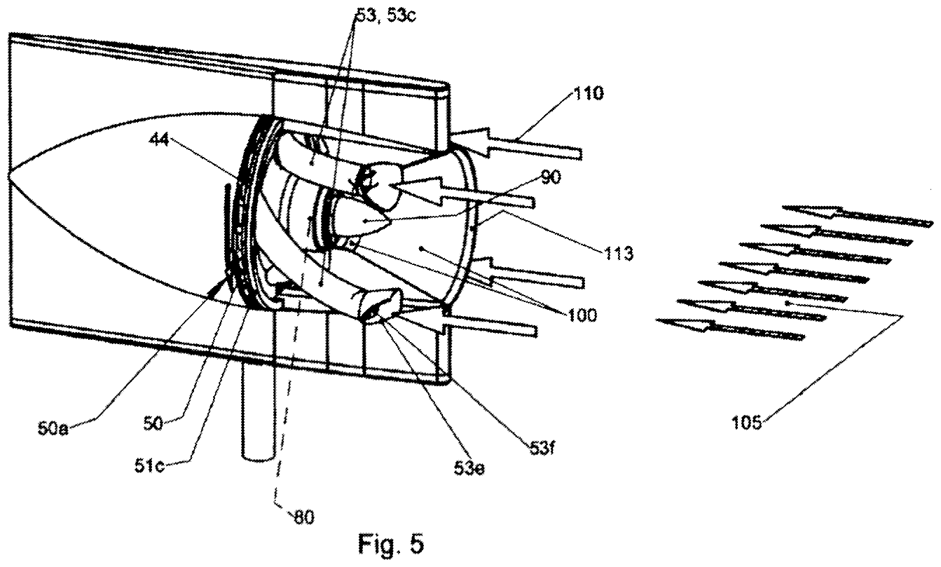

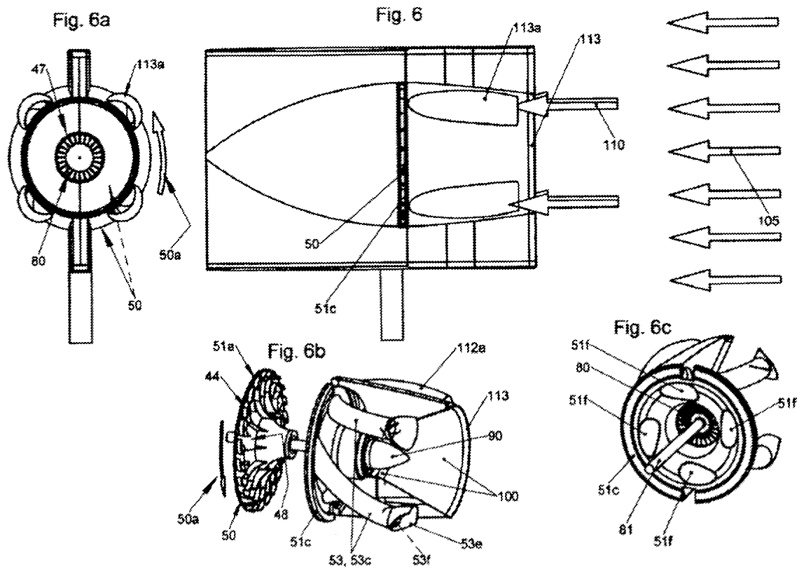

FIG. 4, FIG. 5, FIG. 6, FIGS. 6a-c: show an embodiment of the device according to the invention having “externally decelerating” regulating flaps, i.e. regulating flaps and media supply lines external on the inflow duct of the inlet corpus, i.e. the media supply lines point counter to the rotating direction of the device for generating additional negative pressure, in perspective illustrations;

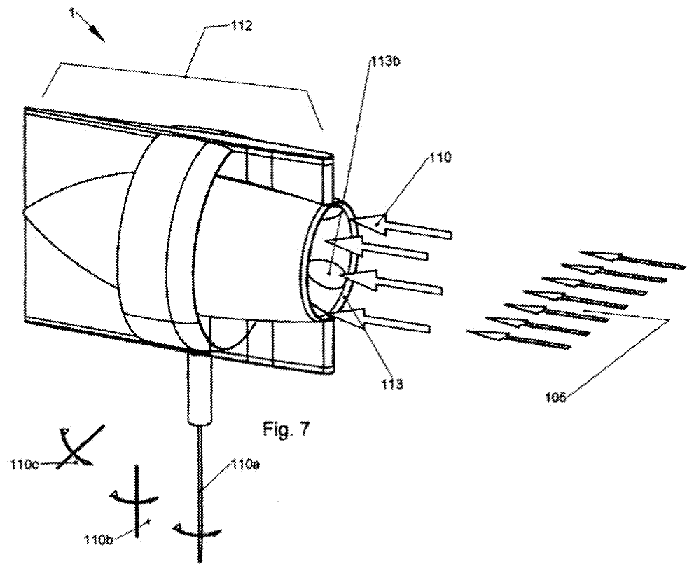

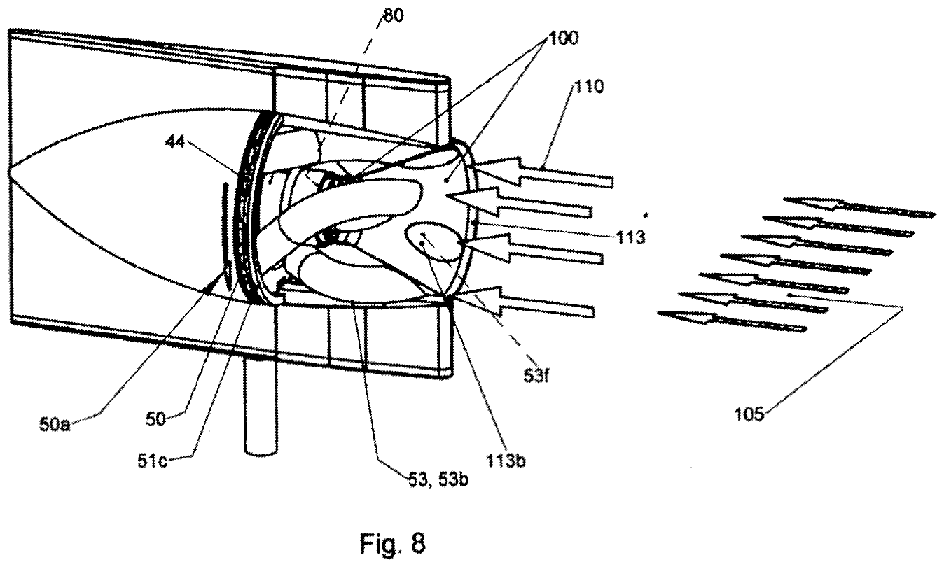

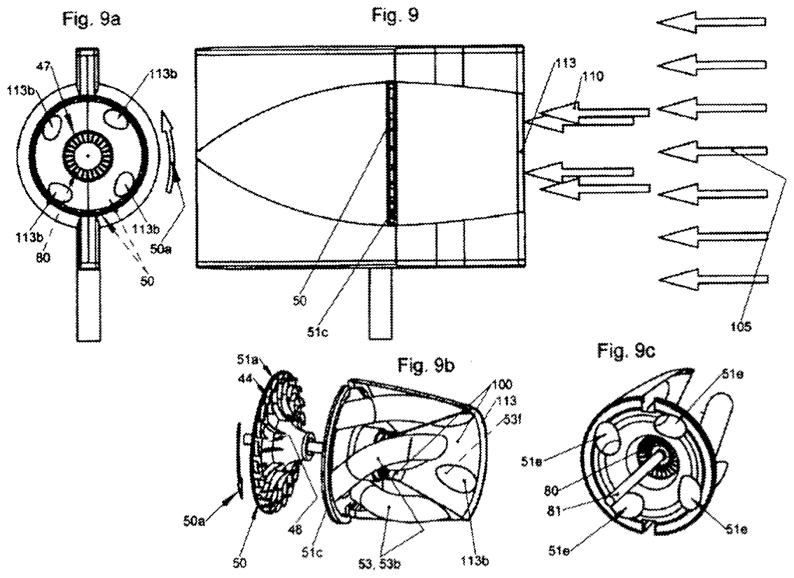

FIG. 7, FIG. 8, FIG. 9, FIGS. 9a-c: show an embodiment of the device according to the invention having “internally accelerating” regulating flaps, i.e. regulating flaps and media supply lines externally on the inflow duct of the inlet corpus, i.e. the media supply lines point in the rotating direction of the device for generating additional negative pressure, in perspective illustrations;

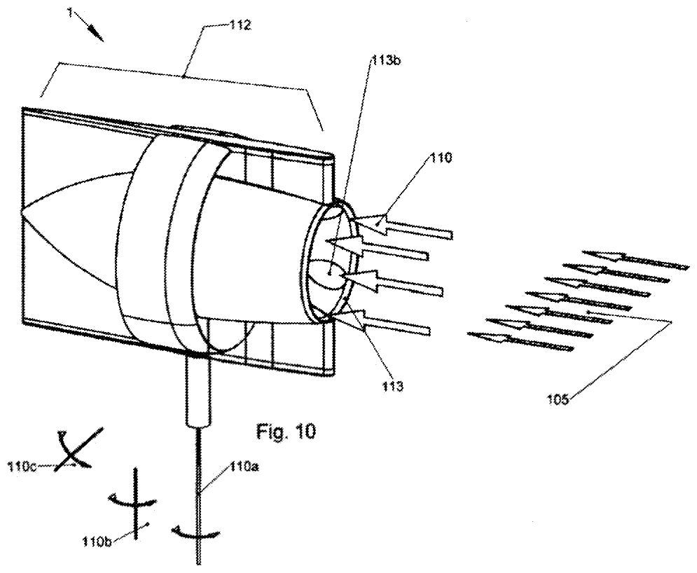

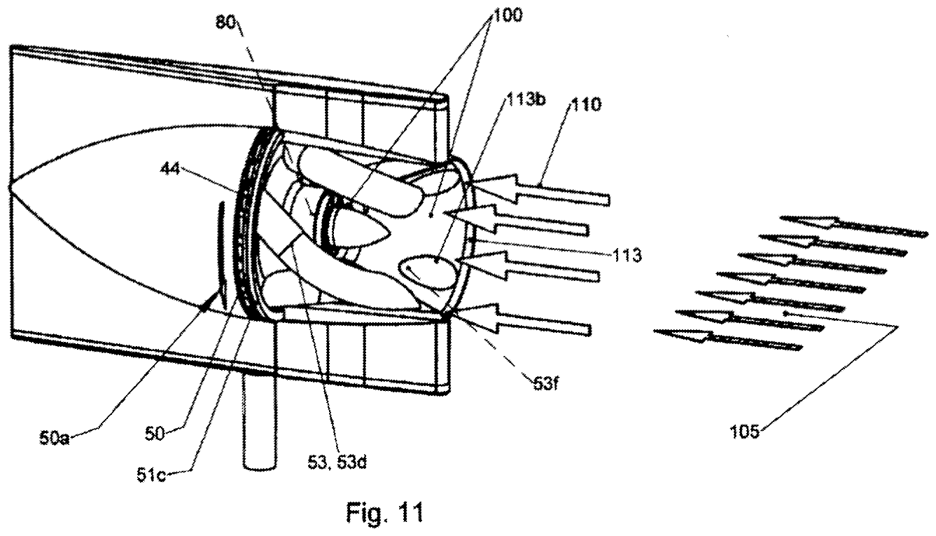

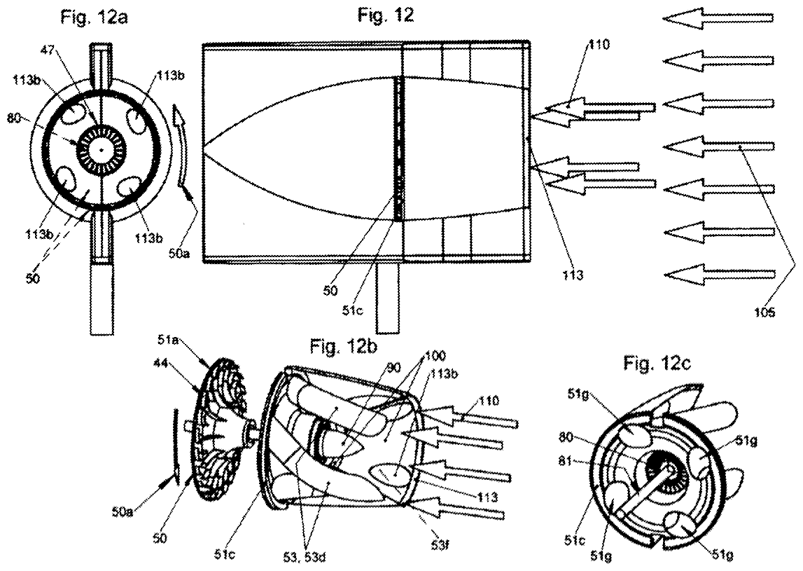

FIG. 10, FIG. 11, FIG. 12, FIGS. 12a-c: show an embodiment of the device according to the invention having “internally decelerating” regulating flaps, i.e. regulating flaps and media supply lines internally on the inflow duct of the inlet corpus, i.e. the media supply lines point counter to the rotating direction of the device for generating additional negative pressure, in perspective illustrations;

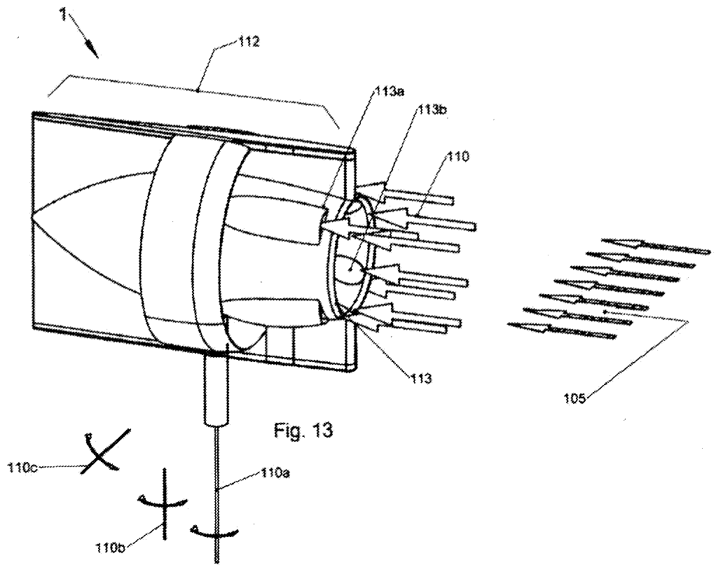

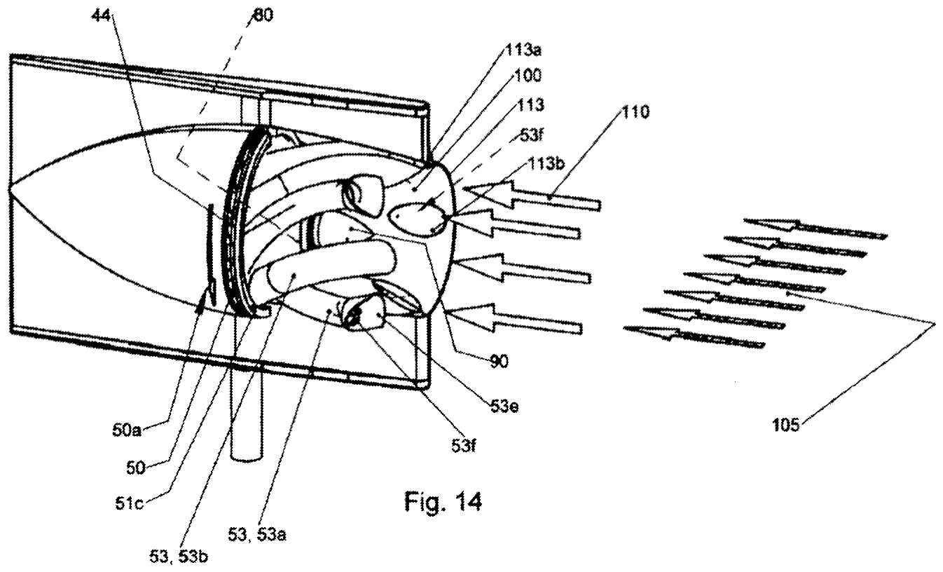

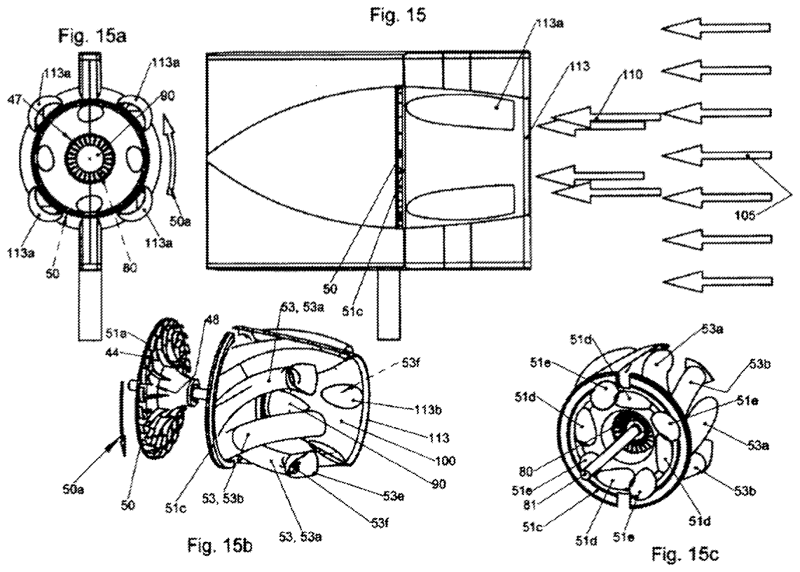

FIG. 13, FIG. 14, FIG. 15, FIGS. 15a-c: show an embodiment of the device according to the invention having “internally and externally accelerating” regulating flaps, i.e. regulating flaps and media supply lines internally and externally on the inflow duct of the inlet corpus, i.e. the media supply lines point in each case in the rotating direction of the device for generating additional negative pressure, in perspective illustrations;

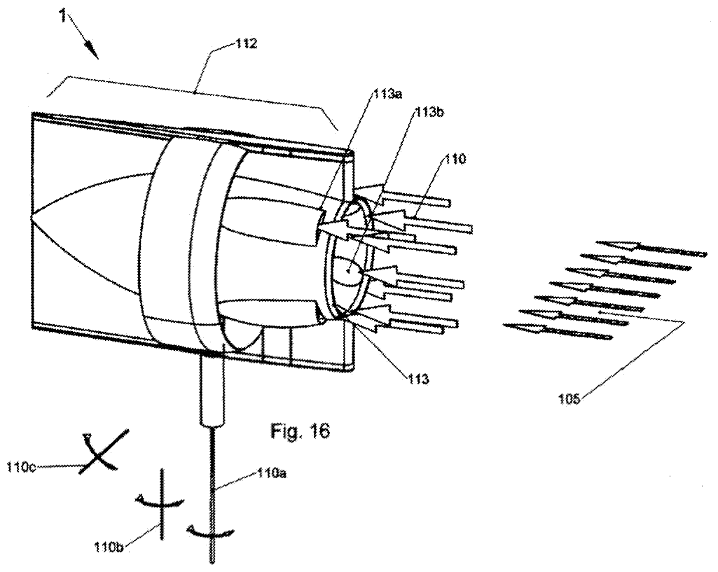

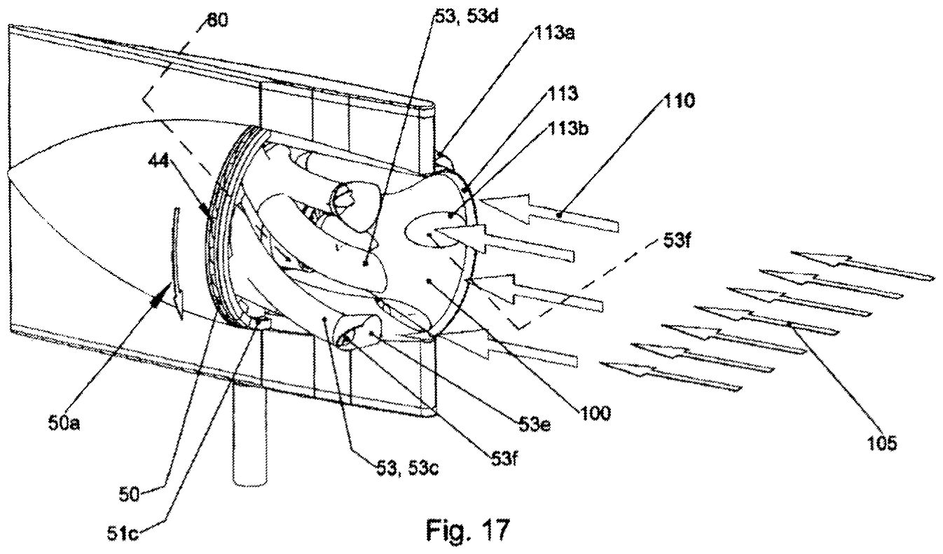

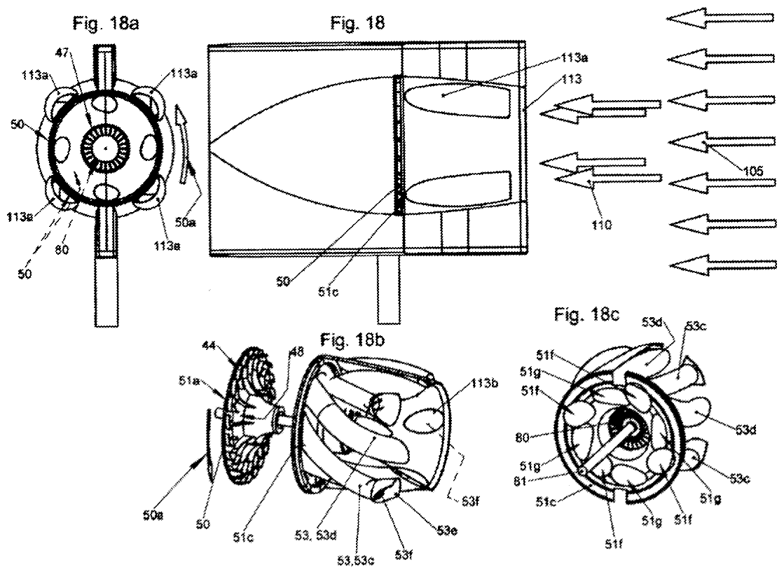

FIG. 16, FIG. 17, FIG. 18, FIGS. 18a-c: show an embodiment of the device according to the invention having “internally and externally decelerating” regulating flaps, i.e. regulating flaps and media supply lines internally and externally on the inflow duct of the inlet corpus, i.e. the media supply lines point in each case counter to the rotating direction of the device for generating additional negative pressure, in perspective illustrations;

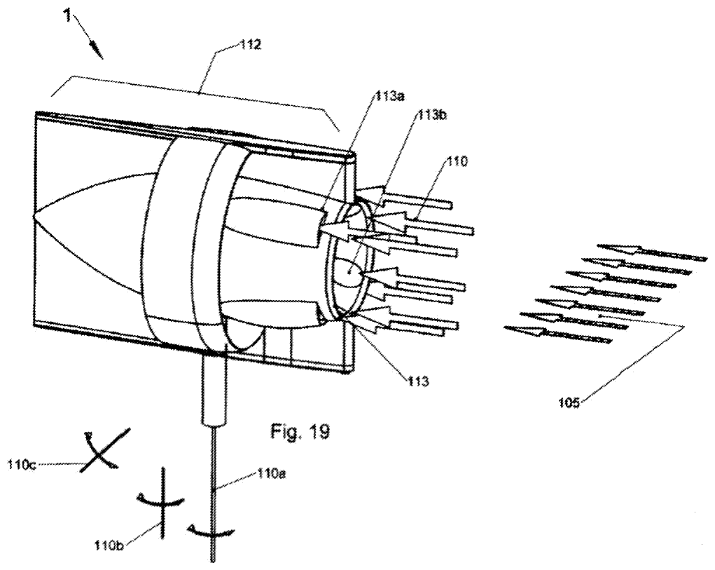

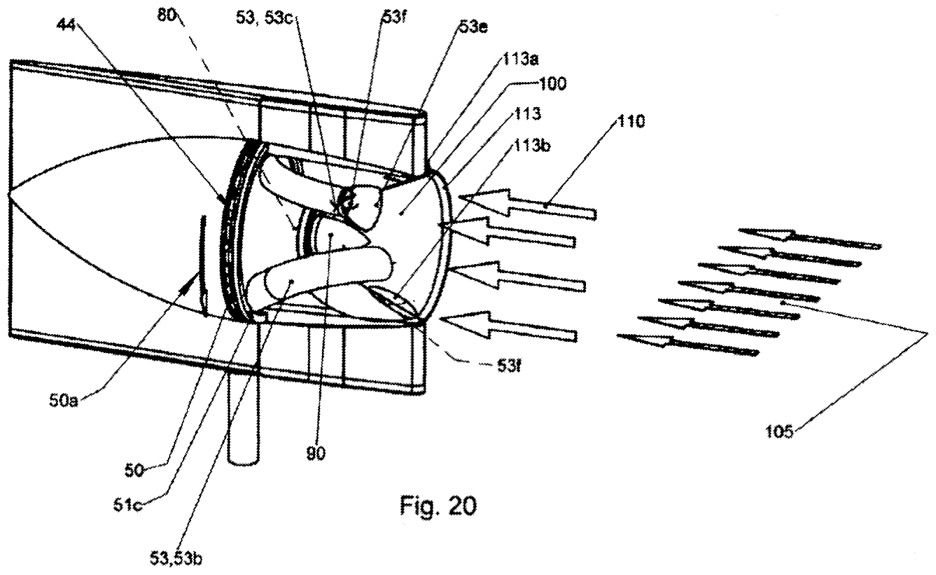

FIG. 19, FIG. 20, FIG. 21, FIGS. 21a-c: show an embodiment of the device according to the invention having “internally accelerating and externally decelerating” regulating flaps, i.e. regulating flaps and media supply lines internally on the inflow duct of the inlet corpus whereby the media supply lines point in the rotating direction of the device for generating additional negative pressure, and having regulating flaps and media supply lines externally on the inflow duct of the inlet corpus, whereby these media supply lines point counter to the rotating direction of the device for generating additional negative pressure, in perspective illustrations;

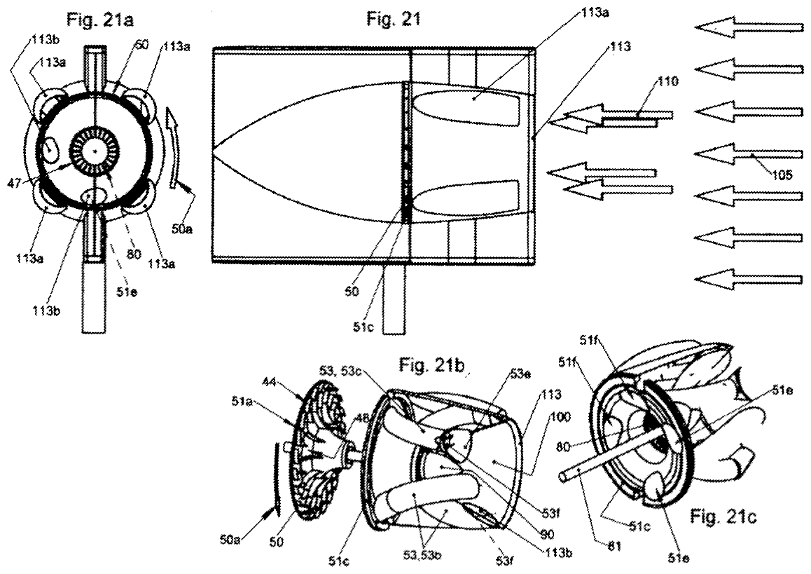

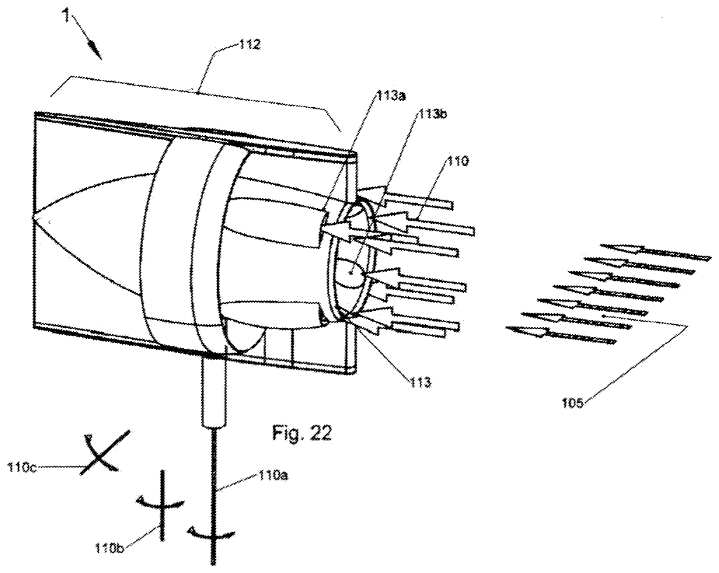

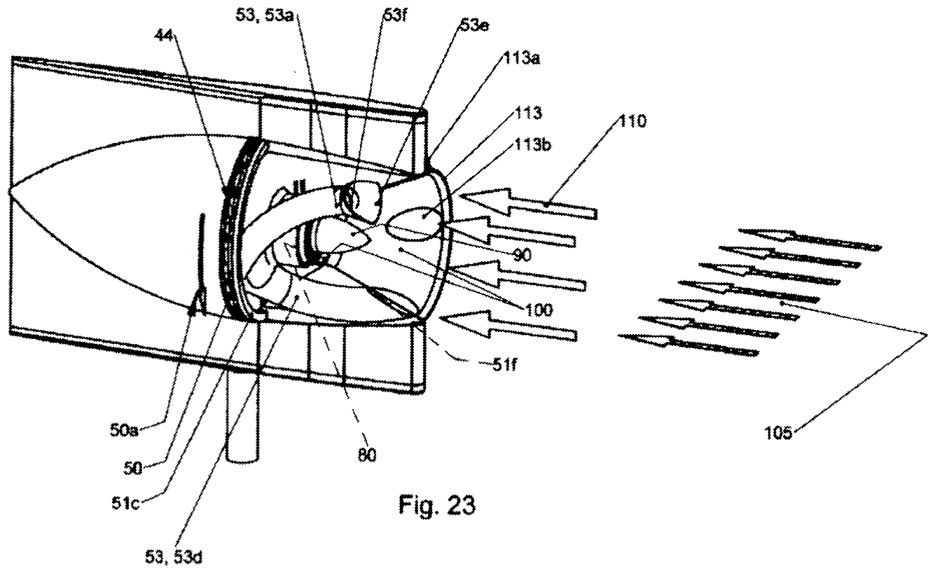

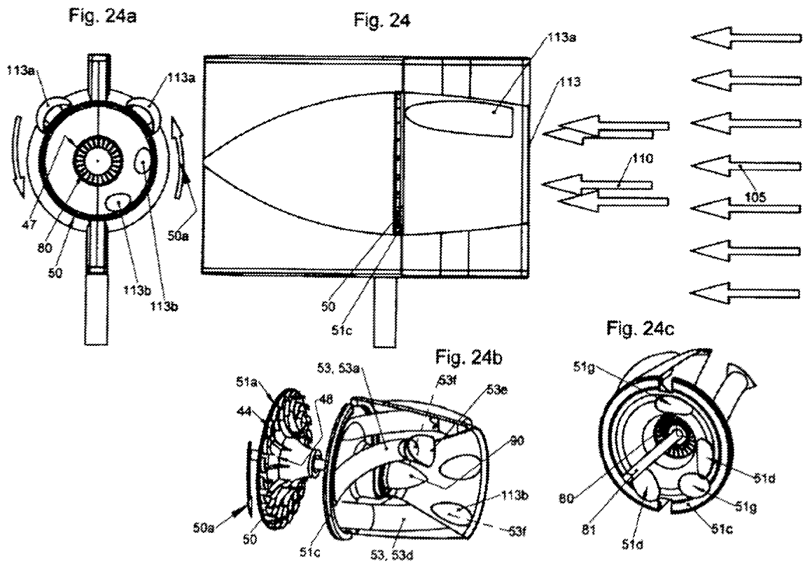

FIG. 22, FIG. 23, FIG. 24, FIGS. 24a-c: show an embodiment of the device according to the invention having “internally decelerating and externally accelerating” regulating flaps, i.e. regulating flaps and media supply lines internally on the inflow duct of the inlet corpus whereby the media supply lines point counter to the rotating direction of the device for generating additional negative pressure, and having regulating flaps and media supply lines externally on the inflow duct of the inlet corpus, whereby these media supply lines point in the rotating direction of the device for generating additional negative pressure, in perspective illustrations;

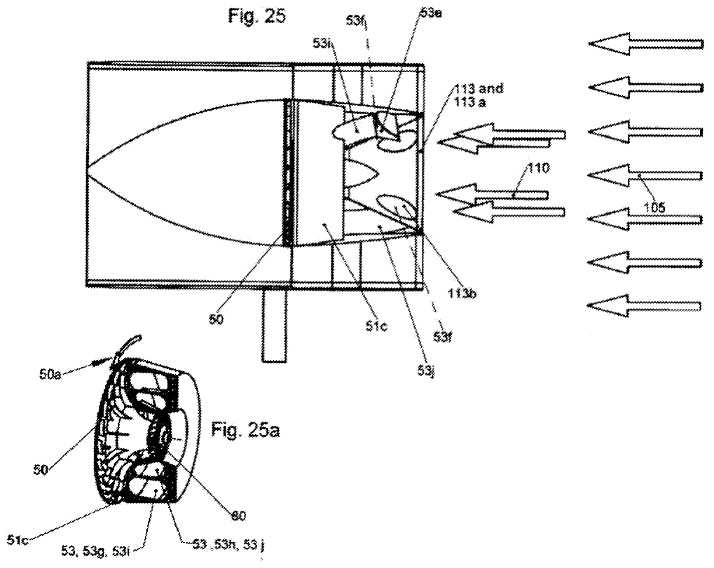

FIG. 25: shows an embodiment of the device according to the invention having a version with ring ducts and externally accelerating and internally decelerating regulating, or externally decelerating and internally accelerating regulating, in perspective illustrations;

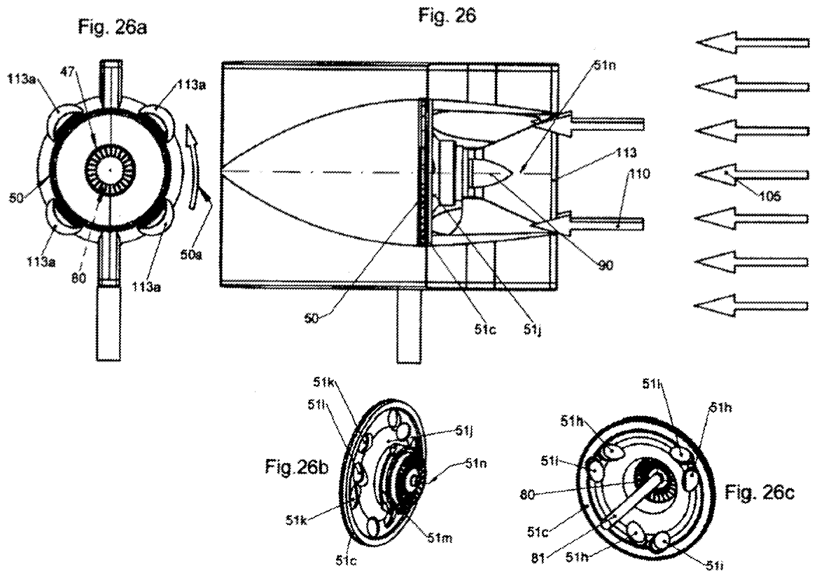

FIG. 26: shows an embodiment of the device according to the invention having a version with a regulating disk with oblique openings, in perspective illustrations; and

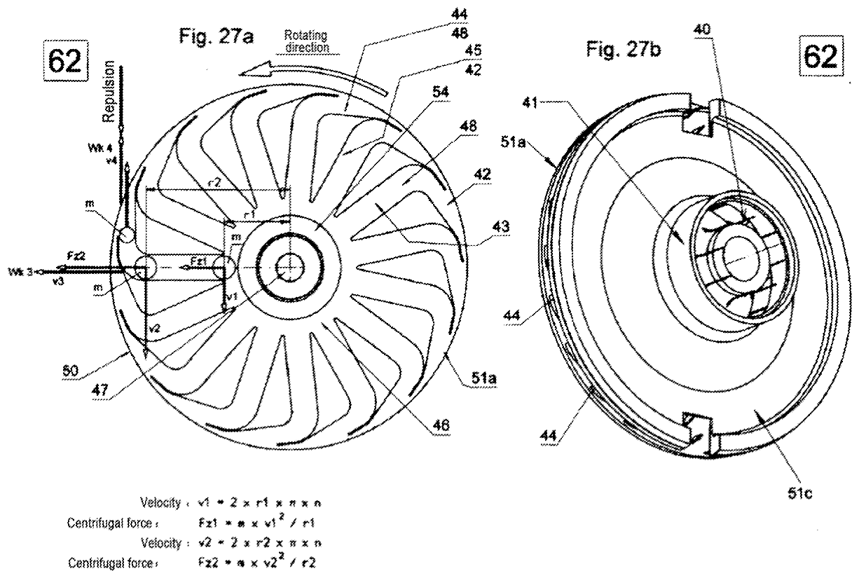

FIGS. 27a, 27b: show the construction and the function of the device for generating additional negative pressure, in perspective illustrations.

The explanations hereunder up to exemplary embodiment 1 apply to all exemplary embodiments and thus represent a summary of the latter:

It is pointed out that the present device 1 can be assembled in different positions, depending on the requirements. The longitudinal axis of the energy converter 1 can preferably be aligned vertically or horizontally.

FIG. 1, FIG. 1a, FIG. 1b show the fundamental construction of an energy converter on which the present invention is based. FIG. 1, FIG. 1 a, FIG. 1b apply in principle to all following exemplary embodiments of FIGS. 2 to 26, so that this fundamental construction is no longer discussed in detail for the avoidance of repetitions when explaining details of said exemplary embodiments. If components in FIG. 1, FIG. 1a and FIG. 1b are known from the generic prior art, this is pointed out.

The device 1 consequently comprises an overall profile 112 having a profile section 113 and a profile section 114, which are designed as conical or coniform casings, cf. only FIG. 1b, FIG. 2, FIG. 3, FIG. 6, FIG. 8, FIG. 9, FIG. 11, FIG. 12, FIG. 14, FIG. 15, FIG. 17, FIG. 18, FIG. 20, FIG. 21, FIG. 23, FIG. 24.

The profile section 113 extends in the direction toward the device for generating additional negative pressure 50, i.e. the converter wheel 50. The overall profile 112 furthermore comprises a further profile section 114 which, proceeding from the converter wheel 50, leads to that side that faces away from the profile section 113 and simultaneously serves for covering the generator and the drive space. The overall profile 112 is disposed coaxially with the preferably horizontally running longitudinal axis, or coaxially with the center 47 of the device for generating additional negative pressure 50. The embodiment of the energy converter shown in FIG. 1a, FIG. 1b rests on a mast 123. This is known.

FIG. 1, FIG. 4, FIG. 7, FIG. 10, FIG. 13, FIG. 16, FIG. 19, FIG. 22 show the pivoting function of the device 1. The output of the energy converter is likewise regulated by the pivoting function, because the projected opening 101 of the profile section 113 for the inflow 110 of the medium is either increased or decreased in size. If the overall profile 112 is completely pivoted out of the inflow 110, the installation is stationary, unless the drive motor 57 (known per se) which is described further below ensures a rotation of the device for generating additional negative pressure 50, and thus for a flow of the medium which is caused by negative pressure and is independent of the defined inflow 110 and the turbine wheel 80. The pivotability of the overall profile 112 consequently influences the incident flow angle of the medium flowing into the interior of the profile section 113. The pivoting directions in the figures mentioned herein are denoted by the reference signs 110a, 110b and 110c. 110a means: pivoting of the device centrically about a vertical axis, 110b means: pivoting the device eccentrically about a vertical axis; 110c means: pivoting the device about a spatial axis.

The primary function of pivotability enables rapid pivoting of the device 1 into or out of the flow direction 110. Various secondary functions are linked to said pivotability, specifically: pivoting the energy converter at an angle ensures optimal utilization of the prevailing flow energy; correcting of the pivoting angle is performed permanently, as a result of which better utilization of the prevailing flow energy is made possible; the associated smoothing of the flow energy causes smaller current peaks at the generators, which therefore does not have to be “capped”; this in turn means a higher current yield and thus also better efficiency; because a plurality of generators can be used, it is possible as a result of pivoting the energy converter that individual generators are switched on or off depending on the current requirement; this likewise means an optimal utilization of the prevailing flow energy; furthermore, the pivotability serves as protection against the destruction of parts of the device 1.

The incident flow angle and regulating the latter per se already directly influence the rotating speed of the device for generating additional negative pressure 50 and of the turbine wheel 80, and also on the torque of the latter two. As a result of the pivotable design embodiment of the device, an instrument for regulating the rotating speed and the torque of the converter wheel and the turbine wheel is consequently achieved by the invention. The pivotability can be implemented in any manner known per se, in particular electromotively. The circulating flow 106 of the overall profile 112 by the respective medium, for example by wind from the wind direction 105, as is shown in FIG. 1a and FIG. 1b, leads to negative pressure at (in) the converter wheel 50 and thus influences the rotating speed of the device for generating additional negative pressure 50 as a result of the repulsion which will yet be described in more detail hereunder. When viewed from the flow direction, this has the consequence that the pressure in front of the turbine wheel 80 is increased, the inflow rate to the turbine wheel thus increasing, i.e. regulating the output is possible by way of the pivotability.

The overall profile 112 is a flow-optimized formed component which is profiled in such a way that the flow 106 is accelerated on the profile contour, wherein a negative pressure is created on the upper side of the overall profile 112 as is known, similar to the airfoil profile of an aircraft. The profile section 112 is designed in such a way that a negative pressure is created in the region of the converter wheel 50 as a result of the axial flow (similar to an airfoil). This negative pressure has the effect that the medium, for example air, located in the converter wheel 50 flows from the center of the converter wheel toward the outside and flows out through guide vanes of the converter wheel 50 counter to the rotating direction, thus causing a repulsion which sets the converter wheel in rotation (principle of linear momentum). The negative pressure is thus propagated in the interior of the converter wheel and likewise in the region after the turbine wheel. The region 113 in front of the turbine wheel is immediately “equalized” by the external pressure 62.

An outer and optional profile ring 115, which is centrically fastened to the overall profile 112, is imparted on its external side with a circulating flow 108, and on its internal side with a circulating flow 107, which is known. The circulating flow 107 boosts the flow 106 and thus increases the flow rate of the latter. The circulating flows 106, 107, 108 all lead in the direction of the “outgoing” wind flow 111. The wind direction of the inflowing wind flow is denoted by the reference sign 105. The flow 106 at the increased flow rate entrains the air flowing out of the device for generating additional negative pressure 50, and thus accelerates the outflow 109 at the converter wheel 50. Said outflow 109 in turn causes a negative pressure in the converter wheel 50, and thus a further increase in the pressure difference after the turbine wheel 80. The inflow rate 110 at the tubular section 100 is increased as a result.

The outflow 109 at the converter wheel 50 causes a repulsion at the converter wheel 50, as has already been explained above, and sets the converter wheel 50 rotation. This energy can be supplied to an additional generator 116, for example by way of a gearbox 117, and be converted into electrical energy. In the process, the medium enters the device for generating additional negative pressure 50, for example the converter wheel 50, through the at least one further passage 51 of the non-rotating formed disk 51c; a plurality of further passages 51 in an approximately rim-shaped arrangement are illustrated in FIG. 1a, FIG. 1b.

The following applies to all of the exemplary embodiments shown in FIGS. 1 to 26 in terms of the rotating direction: The rotating direction 50a of the device for generating additional negative pressure 50, for example of the converter wheel 50, denoted in the figures is illustrated so as to rotate toward the left, when viewed from the front. In a converter wheel embodied to be laterally inversed, the rotating direction is toward the right, when viewed from the front. In this case, all necessary components are also embodied to be laterally inversed. The functional mode as described is maintained in this case. This means that accelerating remains accelerating, and decelerating remains decelerating. The functional mode changes when these parts are not embodied to be laterally inversed, i.e. accelerating becomes decelerating, and decelerating becomes accelerating.

As is known, the embodiment of the device shown in FIG. 1, FIG. 1a, FIG. 1b contains the overall profile 112 with its sections 113, 114 which receive, inter alia, the functional parts of the device for generating additional negative pressure 50, consequently of the so-called converter wheel 50, and for generating the energy, consequently of the turbine wheel 80. The profile section 114 receives further functional components such as, for example, at least one generator 85 which by way of a turbine shaft 81 is connected to the turbine wheel 80, which is disposed in the casing of the profile section 113, for example, FIG. 0-3, FIG. 1. The kinetic energy of the turbine wheel 80 is transmitted with great efficiency to the turbine shaft 81. For example, the high rotating speed of the turbine shaft 81 is reduced by way of a gearbox 82, wherein the corresponding torque is increased. The gearbox 82 is connected to the input of the generator 85. The profile section 114 furthermore contains the drive motor 57 for the converter wheel 50, and a further generator 116 which is connected thereto by way of a gearbox 117. The rotation of the drive motor 57 is transmitted to the converter wheel 50 by arbitrary means available to the person skilled in the art. When viewed in the inflow direction 110 of the respective medium, the device for generating additional negative pressure 50 is disposed after the turbine wheel 80. This embodiment shown can additionally be used as a so-called pump storage station. The required additional output herein does not have to be generated exclusively by the operators of the power station. The converter wheel 50, and the turbine wheel denoted by the reference sign 80, are rotatably mounted, wherein the turbine wheel 80 is co-rotationally connected to a turbine shaft 81. A generator 85, which generates electrical energy during a rotation of the turbine shaft 81, is co-rotationally assembled on that side of the turbine shaft 81 that lies opposite the turbine wheel 80.

All these functional parts can also be located within the mast 123, or at another location.

The profile section 113 can receive a tubular section 100 serving as a supply duct; the respective medium can flow into the interior of the supply duct through the end-side opening 101 of the profile section 113 (cf. FIG. 1, FIG. 1b), which is simultaneously the opening of the supply duct 100, up to the turbine wheel 80, the latter adjoining the supply duct at that side that faces away from the end-side opening 101, as is known; the inflow direction is denoted by the reference sign 110, FIG. 1, FIG. 1a, FIG. 1b.

However, such a tubular section 100 serving as a supply duct is only one option, as shown in FIG. 1, FIG. 1b. By virtue of the media supply line described further below, the present invention can dispense with such a supply duct. All of the exemplary embodiments shown in FIG. 1, FIG. 2 etc. only suggest such a supply duct 100, for example by dashed lines in FIG. 1, this being substantially associated with the avoidance of overloading the drawing. It is however to be emphasized that said embodiments could in each case have such a supply duct. The difference between the presence and absence of a supply duct inter alia lies in that the volumetric flow 40 (cf. FIG. 27b) of the respective medium, the latter also being symbolized by the inflow direction of said medium denoted by the reference sign 110, in the case of the supply duct 100 being present, flows through the latter toward the turbine wheel 80, and moreover by way of the ring duct 41 (cf. FIG. 27b) to the converter wheel 50, while the volumetric flow 40 of the respective medium in the absence of the supply duct 100 flows through the end-side opening 101 of the profile section 113 into the cavity of the latter, and toward the turbine wheel 80, and moreover to the device for generating additional negative pressure 50, cf. FIG. 1, FIG. 1a, FIG. 1b.

A-known-formed component 90, which possesses a conically enlarging shape, FIG. 1a, FIG. 1b, is located in the end region of the interior of the profile section 113 or of the tubular section 100 that faces the device for generating additional negative pressure 50. Guide vane parts 91, which extend from the formed component 90 radially to the outside, FIG. 0-2, 0-4, and in the exemplary embodiment shown are uniformly spaced apart from one another in the circumferential direction are fastened to the end region of the conical formed component 90 that faces the device for generating additional negative pressure 50; this is already known. The guide vane parts 91 form a guide vane assembly. The regions 94 of the guide vane parts 91 that face away from the formed component 90 are preferably angled in the circumferential direction of the formed component 90 relative to the axially running regions 95 of the guide vane parts 91, as can be particularly clearly derived from FIG. 0-4; the guide vane parts 91 in the exemplary embodiment shown are bent in such a way that they point in the rotating direction of the turbine wheel 80. The turbine wheel 80, which is co-rotationally connected to the turbine shaft 81, adjoins the guide vane assembly. The blade parts 87 of the turbine wheel 80 run away from the formed component 90 toward the side of the generator 85 and are inclined in the circumferential direction of the turbine wheel 80, counter to the regions 94 of the guide vane parts 91. A particularly effective rotation of the turbine wheel 80 is achieved in this way. FIG. 0-4 shows the assembly rotated by 90° in the counterclockwise direction.

While the converter wheel 50 according to the generic prior art (FIG. 0-4b) has two circular disks 51a and 51b, which are disposed so as to be mutually parallel and are in each case rotatable, the present invention follows another path in that the converter wheel 50 indeed still has a rotatable circular disk 51a, but the circular disk 51a is replaced by the henceforth non-rotating formed disk 51c, FIG. 1a, FIG. 1b, FIGS. 27a, 27b, FIG. 1b, FIG. 2, FIGS. 3, 3b, FIGS. 6, 6b, FIG. 8, FIGS. 9, 9b, FIG. 11, FIGS. 12, 12b, FIG. 14, FIGS. 15, 15b, FIG. 17, FIG. 18b, FIG. 20, FIG. 21b, FIG. 23, FIG. 24b.

FIGS. 27a, 27b show constructive details of the device for generating additional negative pressure 50 according to the invention, for example of the converter wheel 50. As has already been mentioned, the device for generating additional negative pressure 50, i.e. the converter wheel 50, is accordingly disposed in the above-mentioned inlet corpus 113 of the overall profile 112 of the device. The converter wheel 50 no longer has two circular disks 51a, 51b, which are mutually spaced apart in parallel, cf. FIG. 0-4, but a rotating circular disk 51a and, when viewed in the inflow direction 110 of the respective medium, a non-rotating front formed disk 51c which is spaced apart from said rotating circular disk 51a and of which an exemplary embodiment is shown in FIG. 27b. This represents an effective novelty in comparison to the generic prior art, because the non-rotating characteristic permits, inter alia, the particular further passages for accelerating or decelerating the device for generating additional negative pressure already described, and in addition the media supply lines including regulating flaps, as described further below. The medium herein enters the device for generating additional negative pressure 50, for example of the converter wheel 50, through the at least one further passage 51 of the non-rotating formed disk 51c; a plurality of further passages 51 in an approximately rim-shaped arrangement are illustrated in FIG. 1a, FIG. 1b. The non-rotating front formed disk 51c can either be a fixed constituent part of the inlet corpus 113 of the overall profile 112, or be fastened in the latter, as is shown in FIG. 1b, for example. This formed disk 51c runs in an arcuate manner from the longitudinal axis of the device for generating additional negative pressure 50 toward the outside, wherein the arcuate profile increasingly flattens in the outward direction. When viewed in the inflow direction 110 of the respective medium, and so as to be spaced apart from this front formed component 51c, the device for generating additional negative pressure 50, i.e. the converter wheel 50, has a rotatable rear formed disk 51a, this being derived from FIG. 1b, FIG. 3b, FIGS. 6b, c, FIGS. 9b, c, FIGS. 12b, c, FIGS. 15b, c, FIGS. 18b, c, FIGS. 21b, c, FIGS. 24b, c.

Disposed between this front non-rotating formed disk 51c and the rear circular disk 51a are the ducts 48 and baffles 44, the blade assembly, the inner inlet duct 41 with a mounting (not shown) for the turbine wheel 80 and the receptacle bearing for the bearing flange (not shown) for the converter wheel 50, as derived from FIGS. 27a and 27b, reference being made thereto herewith. The non-rotating front formed disk 51c possesses the inner inlet duct 41 which can be flange-fitted to the formed disk, or be a fixed constituent part of the inlet corpus 113 of the overall profile 112, or be fastened in this inlet corpus 113. In addition to this inlet duct 41, the formed disk 51c possesses at least one further passage 51, advantageously a plurality of passages 51d . . . 51n (not shown in FIG. 27b) which allow the respective medium to flow into the ducts 48 disposed between the non-rotating front formed disk 51c and the rotatable rear circular disk, cf. FIG. 1b, FIG. 3b, FIGS. 6a, b, c, FIGS. 9a, b, c, FIGS. 12a, b, c, FIGS. 15a, b, c, FIGS. 18a, b, c, FIGS. 21a, b, c, FIGS. 24a, b, c, FIG. 25, FIGS. 26b, c. The passages 51d . . . 51n in the exemplary embodiments shown are disposed in an approximately rim-shaped manner on the external periphery of the formed disk 51c, FIGS. 3a, c, FIG. 6c, FIGS. 9a, c, FIGS. 12a, c, FIGS. 15a, c, FIGS. 18a, c, FIGS. 24a, c, FIG. 25, FIGS. 26b, c, and will be described in more detail in the context of the explanations pertaining to these figures.

FIG. 27a shows that ducts 48 which are uniformly spaced apart from one another in the circumferential direction run in each case radially toward the outside from the center 47 of the converter wheel 50. Said ducts, shortly before the external diameter of the converter wheel 50, have an angle of preferably approximately 90° counter to the rotating direction of the converter wheel 50. The ducts 48 here open out radially toward the inside into a common annular antechamber 46 that surrounds the annular hub part 54 of the converter wheel 50, FIG. 27a. The hub part 54, by way of its region that faces the non-rotating formed disk 51c, likewise runs in an arcuate manner from the longitudinal axis of the converter wheel 50 toward the outside. A particularly positive and turbulence-free flow of the medium from the antechamber 46 into the ducts 48 is ensured as a result.

The individual ducts 48 are in each case formed by baffles 44 and 45 which in the manner illustrated in FIG. 27a, proceeding from the annular antechamber 46, run in each case rectilinearly toward the outside and for forming the ducts 48 are angled in such a way that the region 43 of the duct 48, which runs approximately radially toward the outside, is formed in the rectilinear region between two adjacent baffles 44 and 45, and the region 42, which preferably runs at a right angle in relation to the region 43 running radially toward the outside, is formed between the angled end regions of the baffles 44 and 45.

During rotation of the converter wheel 50 by the drive motor 57 (cf. FIG. 0-3), or as a result of the inflow 110 of the medium, for example of the wind in the wind direction 105, through the end-side opening 101 (cf. FIG. 1b) into the inlet corpus 113 (cf. FIG. 1b, FIG. 2, FIG. 3, FIG. 6, FIG. 7, FIG. 8, FIG. 9, FIG. 10, FIG. 11, FIG. 12, etc.) in the rotating direction 50a illustrated in FIGS. 3a, b, FIG. 6b, FIGS. 9a, b, FIGS. 12a, b, FIGS. 15a, b, FIGS. 18a, b, FIGS. 24a, b, FIG. 0-4a, a medium located in the ducts 48 is subjected to a centrifugal force Fz1, FIG. 27a, as a result of the rotating movement at a rotating speed n.

This centrifugal force Fz1 is determined by the circumferential velocity v1 at the radius r1 and the mass m of the medium also in the context of the invention. The formula for the centrifugal force is:

$$Fz 1 = \frac{m \cdot v {1}^{2}}{r 1}$$

The formula for the circumferential velocity in the context of the invention is also: v1=2·r1·π·n.

The centrifugal force Fz1 forces the medium in the ducts 48 toward the outside. At the radius r2, shortly before the orthogonal curvature of the ducts 48, the following applies to the centrifugal force also in the context of the invention:

$$Fz 2 = \frac{m \cdot v {2}^{2}}{r 2}$$

The centrifugal force Fz2 accelerates the mass m of the medium to a velocity v3, wherein the friction loss has to be taken into account. At this point, i.e, thus shortly before the curvature of the ducts 48, the kinetic energy for the mass m of the medium also in the context of the invention is:

$$WK 3 = \frac{m \cdot v {3}^{2}}{2}$$

The medium is deflected counter to the rotating direction by the curvature of the ducts 48, and after the curvature is imparted a velocity v4 which, due to friction losses, is lower than the velocity v3. The kinetic energy resulting therefrom also in the context of the invention is:

$$WK 4 = \frac{m \cdot v {4}^{2}}{2}$$

The medium exits the converter wheel 50 with a kinetic energy W4 also in the context of the invention. A repulsion with the same energy is created in the process. This energy helps to drive the converter wheel 50.

In the process explained, a negative pressure, which has the effect that the atmospheric external pressure 62 causes the medium to be accelerated in front of the device for generating additional negative pressure 50 and to be supplied to the device for generating additional negative pressure 50 through the inner inlet duct denoted by the reference sign 41 (FIGS. 27a, b), is created in the antechamber 46 also in the context of the invention. The pressure difference can be increased by increasing the rotating speed of the converter wheel 50 driven by the drive motor 57 and/or of the converter wheel 50 driven by the inflow 110.

When the converter wheel 50 is set in rotation by the drive motor 57 and/or by the inflow 110 of the medium into the converter wheel, the medium in the ducts 43 of the converter wheel 50 is forced toward the outside in the manner described in the context of FIG. 27a also in the context of the invention, which is why a negative pressure is created in the region below the turbine wheel 80, the latter being rotatably disposed in the inner inlet duct 41. This has the consequence also in the context of the invention that the medium flows out of the interior of the inlet corpus 113 (cf. FIG. 1b) or out of the tubular section 100 (cf. FIG. 1a), through the ducts formed between the guide vane parts 91, in the direction toward the blade parts 87, because of said negative pressure and because of the atmospheric pressure 62 prevalent in the interior of the inlet corpus 113 or in the tubular section 100. The turbine wheel 80 is set in rotation in the process also in the context of the invention, and transmits its rotation to the generator 85 by way of the turbine shaft 81, said generator 85 generating electric energy corresponding to the rotation.

The volumetric flow 40 is deflected by the formed component 90 in such a way also in the context of the invention that an optimal pressure is exerted on the blade parts 87 of the turbine wheel 80.

The shape, dimension and the number of ducts 48 of the converter wheel 50, of the converter wheel 50 and of the turbine, the sizing of the overall profile 112, of the inlet corpus 113, of the profile section 114, of the tubular section 100 and of all other components of the energy converter can be determined and optimized in terms of effectivity, site, and other parameters of the energy converter 1 also in the context of the invention.

The invention is particularly suitable for assembly on roofs of high-rise buildings or the like. The device is preferably assembled on a mast 123 or the like in the manner which can be seen.

A specific rotating speed at the converter wheel 50 can be generated in a differentiated manner by the drive motor 57 also in the context of the invention. Any known control systems can be used for this purpose. This differentiated rotating speed influences the inflow 110 in front of the turbine wheel 80 and serves the purpose of operating in the optimal range of the turbine wheel 80 at different medium speeds, for example wind speeds. This means that an adjustment of guide vanes and an adjustment of the turbine blades is not required. The energy of the turbine wheel 80 is supplied to the generator 85 by way of the gearbox 82, as has already been explained above.

It can furthermore be derived from FIG. 1 that the exemplary embodiment shown therein can be operated in a completely autonomous manner in terms of energy, which can be considered a preferred embodiment of the invention. For this purpose, the device 1 is connected to an apparatus for capturing and transmitting energy 125 by way of a line 126 which is guided into the profile section 114 within the mast 123, where a connection of this line 126 (not shown) to the drive motor 57 of the device for generating additional negative pressure 50 is established. This apparatus for capturing and transmitting energy 125 in this exemplary embodiment is one for capturing and transmitting solar energy, this potentially being a photovoltaic installation, a solar panel system, or a similar system. If water or wave energy is used as the medium, this may be an apparatus for capturing and transmitting energy that can be used in this technical field. The same applies in an analogous manner to all medium-specific apparatuses for capturing and transmitting energy.

The device 1 is furthermore connected to at least one apparatus for storing and supplying electrical energy 127.1, 127.2, 127 . . . n. This can be at least one so-called power station, at least one accumulator, at least one accumulator pack, or similar. If a plurality of apparatuses of this type are functionally connected to one another, this can be performed by means of a line 130. The at least one apparatus for storing and supplying electrical energy 127.1, 127.2, 127 . . . n is connected to the generator 85 (not illustrated) disposed in the profile section 114 by way of a line 128 which partially runs in the mast 123; as a result of this connection, the (electrical) energy generated by the generator 85 can be stored in the apparatus for storing and supplying electrical energy 127.1, 127.2, 127 . . . n; any consumer can be supplied with (electrical) energy in this way. Furthermore, the apparatus for storing and supplying electrical energy 127.1, 127.2, 127 . . . n can also be connected in the above-described manner to the generator 116 assigned to the device for generating additional negative pressure 50; it is made possible as a result that the apparatus for storing and supplying electrical energy 127.1, 127.2, 127 . . . n is fed solely by way of the rotation of the device for generating additional negative pressure when an input of energy takes place only by way of the converter wheel 50, and the generator 116 of the latter—for instance because the energy input by way of the turbine wheel 80 and its generator 85 is switched off. Moreover, the apparatus for capturing and transmitting energy 125 can be connected directly to the apparatus for storing and supplying electrical energy 127.1, 127.2, 127 . . . n by way of a line 129 in such a way that the latter can also be supplied with energy by way of the apparatus 125 additionally or alternatively to the energy generated by way of the turbine wheel 80 and the generator 85. It is likewise possible by conventional regulating to ensure an input of energy into the apparatus for storing and supplying electrical energy 127.1, 127.2, 127 . . . n by way of the converter wheel 50 and the generator 116 assigned thereto. The design embodiment thus permits a multifunctional operation of the device 1 that can take into account existing or anticipated environmental conditions or climatic conditions. For example, if the medium is wind, and there is for example a lull prevalent, the converter wheel 50 can be set in rotation, for example, by way of the apparatuses 125, 127, etc., and the energy delivered by or by way of the latter to the drive motor 57 in such a way that the turbine wheel 80 can be set in rotation by way of the negative pressure generated by the device for generating additional negative pressure 50, and the energy generated by said turbine wheel 80 by way of the generator 85 can in any case again be partially supplied to the apparatus for storing and supplying electrical energy 127.1, 127.2, 127 . . . n; it is furthermore possible that enough wind flow is generated in this way by means of generating the negative pressure so as to utilize said wind flow for generating energy even in such a case of a lull; or it is possible to completely or partially pivot 110a, 110b, 110c the device out of the flow of the medium in the case of an excessive flow, as explained, and nevertheless maintain the function of energy capturing, the utilization of already stored energy. The same applies to weak wind, the latter being able to be optimally utilized in this way, which is made possible in that the device for generating additional negative pressure 50 can be utilized so as to be intermittently adapted to the weak wind, for example.

The above-described possibility of using an apparatus for capturing and transmitting solar energy 125, and an apparatus for storing and supplying electrical energy 127, is indeed mentioned only in the context of the exemplary embodiment of FIG. 1. This possibility however applies to all of the exemplary embodiments mentioned according to FIGS. 2 to 27b; a graphic repetition has been omitted in this respect only for the avoidance of overloading the illustrations in the drawings.

The more detailed explanation of the design embodiment of the device according to the invention, according to which an interaction between the device for generating additional negative pressure 50, for example of the converter wheel 50, (in the embodiment with a non-rotating formed disk 51c) and at least one media supply line and one regulating flap is provided, will henceforth be provided hereunder by means of the associated exemplary embodiments in FIGS. 2 to 27b.

### Exemplary Embodiment 1

The exemplary embodiment in FIGS. 2, 3, 3a, 3b and 3c, in conjunction with FIG. 1, shows a device 1 having regulating flaps “externally accelerating”, i.e. regulating flaps and media supply lines outside on the inflow duct of the inlet corpus, i.e. the media supply lines point in the rotating direction of the device for generating additional negative pressure, in perspective illustrations. The preferred use of the arrangement “externally accelerating” is with low flow rates and with intense fluctuations of the flow rates.

The device 1 has an overall profile 112 with its profile sections 113 and 114.

The optional supply duct 100 is disposed in the interior of the profile section 113, and its spatially geometric position is illustrated by dashed lines in FIG. 1, view “Z”. The design embodiment and mode of action of said supply duct 100 has been explained above in the introductory part of the description of the figures, so that reference is made thereto.

In this exemplary embodiment, four outer inflow hoods 113a are disposed at identical mutual spacings on the outer casing of the profile section 113, FIGS. 1, 3, 3a. Said inflow hoods 113a cover a material clearance in the outer casing 113, FIG. 3b, which when viewed in the flow direction 110 receive the in each case front end piece of likewise four media supply lines 53 having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53 in this exemplary embodiment without inflow hoods 113a receive the medium directly through the end-side opening 101, FIG. 1b, in the inflow duct of the inlet corpus 113.

When viewed in the flow direction 110, the four media supply lines 53 at their rear end lead in each case to the non-rotating formed disk 51c of the device for generating additional negative pressure 50. The media supply lines 53 to the non-rotating formed disk 51c are disposed outside in the rotating direction 50a of the device for generating additional negative pressure, and have an accelerating effect on the rotating speed of the device for generating additional negative pressure 50; for the purpose of differentiation in relation to further media supply lines, they are therefore specifically denoted by the reference sign 53a, FIG. 2, FIG. 3b.

The medium, by way of the openings of the inflow hoods 113a, which are co-aligned with the flow direction 110 of the respective medium, for example wind 105, and passing the inlet 53e and the regulating flaps 53f, flows into the four media supply lines 53 toward the non-rotating formed disk 51c of the device for generating additional negative pressure 50, FIG. 3b.

The media supply lines 53 are disposed in an outer region within the inflow duct of the inlet corpus 113 and, like the latter, run in the longitudinal direction toward the device for generating additional negative pressure 50. “Outer” region, or synonymously “outside”, means that the media supply lines 53 run between the internal wall of the inlet corpus 113 and the external wall of the supply duct 100 toward the device for generating additional negative pressure 50, if such a supply duct is present; if such a supply duct is not provided, these terms mean that the media supply lines 53 are disposed so far toward the internal wall of the inlet corpus 113 that the inlet corpus 113 in its more central, consequently “inner” region, or synonymously “inside”, when viewed in the longitudinal direction, can in any case receive at least one (further) media supply line 53b, 53d in such a manner that the media supply lines 53 point in the rotating direction of the device for generating additional negative pressure.

The arrangement of the outer media supply lines 53 “in the rotating direction” can be seen from FIG. 3b. That end of the media supply line 53a that reaches the non-rotating formed disk 51c is aligned in such a way that said end points in the rotating direction of the device for generating additional negative pressure, this being identified by means of the arrow 50a. The medium flowing through the media supply line 53a thus impacts the converter wheel in such a way that the rotation of the latter is facilitated as a result, the rotating speed thus being increased. In this way, an acceleration of the rotating speed of the device for generating additional negative pressure 50 is made possible as a result of the flow of the medium in the respective media supply line 53a toward the device for generating additional negative pressure.

FIG. 3b thus shows that end of the at least one media supply line 53a that faces away from the end-side opening of the inlet corpus 113 in the rotating direction of the device for generating additional negative pressure 50; this is the position of the media supply line that contributes toward accelerating the rotating speed of the device for generating additional negative pressure when the respective medium is supplied through the media supply line to the device for generating additional negative pressure in the rotating direction of the latter.

In the process, the medium passes through the four passages 51d in the non-rotating formed disk 51c of the device for generating additional negative pressure 50, shown in FIG. 3c. Said medium thus reaches the ducts 48, which are shown in FIG. 3b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 2 and FIG. 3b, besides the material characteristics of the medium flowing through the media supply lines 53.

Regulating flaps “open” means greater repulsion on the converter wheel, which in turn means more torque at a higher rotating speed and thus more output; regulating flaps “closed” means less repulsion on the converter wheel, which in turn means less torque at a low rotating speed and thus less output.

The variation of the rotating speed and/or of the torque of the device for generating additional negative pressure furthermore directly influences the rotating speed and the torque of the turbine wheel 80. The regulating flaps 53f in the “open” position lead to an increase in the pressure at the turbine wheel, i.e. there is more torque at a higher rotating speed prevalent on the turbine wheel, which is associated with more output; the regulating flaps 53f in the “closed” position cause a reduction in pressure on the turbine wheel, which means less torque at a lower rotating speed and thus less output.

As can be seen from FIG. 3a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 3a.

### Exemplary Embodiment 2

The exemplary embodiment in FIG. 4 (in conjunction with FIG. 1) and FIG. 5, FIG. 6, FIGS. 6a-c shows an embodiment of the device 1 having regulating flaps “externally decelerating”, i.e. the regulating flaps and the media supply lines are disposed outside on the inflow duct of the inlet corpus, i.e. the media supply lines point counter to the rotating direction of the device for generating additional negative pressure, in perspective illustrations. The preferred use of the arrangement “externally decelerating” is with high flow rates and with intense fluctuations of the flow rates.

The device 1 has an overall profile 112 with its profile sections 113 (inlet corpus) and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, four outer inflow hoods 113a are disposed at identical mutual spacings on the outer casing of the inlet corpus 113, FIGS. 1, 4, 6a. Said inflow hoods 113a cover a material clearance in the outer casing 113, FIG. 6b, which when viewed in the flow direction 110 receive the in each case front end piece of likewise four media supply lines 53 having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53 in this exemplary embodiment without inflow hoods 113a receive the medium directly through the end-side opening 101, FIG. 1b, in the inflow duct of the inlet corpus 113.

When viewed in the flow direction 110, the four media supply lines 53 at their rear end lead in each case to the non-rotating formed disk 51c of the device for generating additional negative pressure 50. The media supply lines 53 to the non-rotating formed disk 51c are disposed outside counter to the rotating direction 50a of the device for generating additional negative pressure, and have a decelerating effect on the rotating speed of the device for generating additional negative pressure 50; for the purpose of differentiation in relation to further media supply lines, they are therefore specifically denoted by the reference sign 53c, FIG. 5, FIG. 6b.

The medium, by way of the openings of the inflow hoods 113a, which are co-aligned with the flow direction 110 of the respective medium, for example wind 105, and passing the inlet 53e and the regulating flaps 53f, flows into the four media supply lines 53 toward the non-rotating formed disk 51c of the device for generating additional negative pressure 50, FIG. 5, FIG. 6b.

The media supply lines 53 are disposed in an outer region within the inflow duct of the inlet corpus 113 and, like the latter, run in the longitudinal direction toward the device for generating additional negative pressure 50. “Outer” region, or synonymously “outside”, means that the media supply lines 53 run between the internal wall of the inlet corpus 113 and the external wall of the supply duct 100 toward the device for generating additional negative pressure 50, if such a supply duct is present; if such a supply duct is not provided, these terms mean that the media supply lines 53 are disposed so far toward the internal wall of the inlet corpus 113 that the inlet corpus 113 in its more central, consequently “inner” region, or synonymously “inside”, when viewed in the longitudinal direction, can in any case receive at least one (further) media supply line 53b, 53d in such a manner that the media supply lines 53 point counter to the rotating direction of the device for generating additional negative pressure.

The arrangement of the outer media supply lines 53 “counter to the rotating direction” can be seen from FIG. 5 and FIG. 6b. That end of the media supply line 53c that reaches the non-rotating formed disk 51c is aligned in such a way that said end points counter to the rotating direction of the device for generating additional negative pressure, this being identified by means of the arrow 50a. The medium flowing through the media supply line 53c thus impacts the converter wheel in such a way that the rotation of the latter is reduced as a result, the rotating speed thus being decelerated. “Counter to the rotating direction” is an arrangement in which a deceleration of the rotating speed of the device for generating additional negative pressure is made possible as a result of the flow of the medium in the respective media supply line toward the device for generating additional negative pressure. In this way, a deceleration of the rotating speed of the device for generating additional negative pressure 50 is made possible as a result of the flow of the medium in the respective media supply line 53c toward the device for generating additional negative pressure.

FIG. 5 and FIG. 6b thus show that end of the at least one media supply line 53c that faces away from the end-side opening of the inlet corpus 113 counter to the rotating direction of the device for generating additional negative pressure 50; this is the position of the media supply line that contributes toward decelerating the rotating speed of the device for generating additional negative pressure when the respective medium is supplied through the media supply line to the device for generating additional negative pressure counter to the rotating direction of the latter.

In the process, the medium passes through the four passages 51f in the non-rotating formed disk 51c of the device for generating additional negative pressure 50, shown in FIG. 6c. Said medium thus reaches the ducts 48, which are shown in FIG. 6b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 5 and FIG. 6b, besides the material characteristics of the medium flowing through the media supply lines 53.

Regulating flaps “open” means that the converter wheel is decelerated, which in turn means less torque at a lower rotating speed and thus less output; regulating flaps “closed” means normal repulsion at the converter wheel, which in turn means normal torque at a corresponding rotating speed and thus normal output.

The variation of the rotating speed and/or of the torque of the device for generating additional negative pressure furthermore directly influences the rotating speed and the torque of the turbine wheel 80. The regulating flaps 53f in the “open” position lead to an increase in the pressure at the turbine wheel, i.e. there is more torque at a higher rotating speed prevalent on the turbine wheel, which is associated with more output; the regulating flaps 53f in the “closed” position cause a reduction in pressure on the turbine wheel, which means less torque at a lower rotating speed and thus less output.

As can be seen from FIG. 6a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 6a.

### Exemplary Embodiment 3

The exemplary embodiment in FIG. 7 (in conjunction with FIG. 1) and FIGS. 8, 9, 9a, 9b and 9c shows a device 1 having regulating flaps “internally accelerating”, i.e. regulating flaps and media supply lines are disposed inside on the inflow duct of the inlet corpus, i.e. the media supply lines point in the rotating direction of the device for generating additional negative pressure, in perspective illustrations. The preferred use of the arrangement “internally accelerating” is with low flow rates and with intense fluctuations of the flow rates.

The device 1 has an overall profile 112 with its profile sections 113 and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, the inlet corpus 113 receives four media supply lines 53 which are in each case provided with an aperture 113b and are attached in front of the inlet 53e (not shown) and the media supply line. One regulating flap 53f is in each case located after the aperture, said regulating flaps 53f being received at the beginning of the media lines 53. In the case of a closed media supply line, the aperture serves for improving the inflow to the turbine. The media supply lines are disposed so as to continue within the inflow duct of the inlet corpus 113; it is to be pointed out here that the media supply lines 53 in this exemplary embodiment receive the medium directly, without inflow hoods 113a, through the end-side opening 101, FIG. 1b, in the inflow duct of the inlet corpus 113.

When viewed in the flow direction 110, the four media supply lines 53, of which one is shown, at their rear end lead in each case to the non-rotating formed disk 51c of the device for generating additional negative pressure 50. The media supply lines 53 to the non-rotating formed disk 51c are disposed on the inside in the rotating direction 50a of the device for generating additional negative pressure, without said media supply lines 53 being guided into the interior of the inlet corpus 113 by way of outer inflow hoods, as in the exemplary embodiment according to FIG. 2 and FIG. 3, and have an accelerating effect on the rotating speed of the device for generating additional negative pressure 50; for the purpose of differentiation in relation to further media supply lines, they are therefore specifically denoted by the reference sign 53b, FIG. 8, FIG. 9b.

In the case of an open aperture 113b, the medium, by way of the opening 101 (cf. FIG. 1b) of the inlet corpus 113, which is co-aligned with the flow direction 110 of the respective medium, for example wind 105, and passing the inlet 53e and the regulating flaps 53f, flows into the four media supply lines 53 toward the non-rotating formed disk 51c of the device for generating additional negative pressure 50, FIG. 8 and FIG. 9b.

The media supply lines 53 are disposed in an inner region within the inflow duct of the inlet corpus 113 and, like the latter, run in the longitudinal direction toward the device for generating additional negative pressure 50. “Inner” region, or synonymously “inside”, means that the media supply lines 53 run within the supply duct 100 toward the device for generating additional negative pressure 50, if such a supply duct is present; if such a supply duct is not provided, these terms either mean that the media supply lines 53 are disposed so far from the internal wall of the inlet corpus 113 that the inlet corpus 113 in its eccentric, consequently “outer” region, or synonymously “outside”, when viewed in the longitudinal direction, can in any case receive at least one (further) media supply line 53a, 53c in such a manner that the media supply lines 53 point in or counter to the rotating direction of the device for generating additional negative pressure; or else they mean that the inlet corpus 113 does not possess inflow hoods 113a, the medium thus not flowing by way of the latter into the media supply lines; the latter is shown in this exemplary embodiment.

The arrangement of the inner media supply lines 53 “in the rotating direction” can be seen from FIG. 9b. That end of the media supply line 53b that reaches the non-rotating formed disk 51c is aligned in such a way that said end points in the rotating direction of the device for generating additional negative pressure, this being identified by means of the arrow 50a. The medium flowing through the media supply line 53b thus impacts the converter wheel in such a way that the rotation of the latter is facilitated as a result, the rotating speed thus being increased. In this way, an acceleration of the rotating speed of the device for generating additional negative pressure 50 is made possible as a result of the flow of the medium in the respective media supply line 53b toward the device for generating additional negative pressure.

FIG. 9b thus shows that end of the media supply lines 53b that faces away from the end-side opening of the inlet corpus 113 in the rotating direction of the device for generating additional negative pressure 50; this is the position of the media supply line that contributes toward accelerating the rotating speed of the device for generating additional negative pressure when the respective medium is supplied through the media supply line to the device for generating additional negative pressure in the rotating direction of the latter.

In the process, the medium passes through the four passages 51e in the non-rotating formed disk 51c of the device for generating additional negative pressure 50, shown in FIGS. 9a, 9c. Said medium thus reaches the ducts 48, which are shown in FIG. 9b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 8 and FIG. 9b, besides the material characteristics of the medium flowing through the media supply lines 53.

Regulating flaps “open” means greater repulsion at the converter wheel, which in turn means more torque at a higher rotating speed and thus more output; regulating flaps “closed” means less repulsion at the converter wheel, which in turn means less torque at a low rotating speed and thus less output.

The variation of the rotating speed and/or of the torque of the device for generating additional negative pressure furthermore directly influences the rotating speed and the torque of the turbine wheel 80. The regulating flaps 53f in the “open” position lead to an increase in the pressure at the turbine wheel, i.e. there is more torque at a higher rotating speed prevalent on the turbine wheel, which is associated with more output; the regulating flaps 53f in the “closed” position cause a reduction in pressure on the turbine wheel, which means less torque at a lower rotating speed and thus less output.

As can be seen from FIG. 9a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 9a.

### Exemplary Embodiment 4

The exemplary embodiment in FIG. 10 (in conjunction with FIG. 1) and FIG. 11, FIGS. 12, 12a, 12b and 12c shows a device 1 having regulating flaps “internally decelerating”, i.e. regulating flaps and media supply lines are disposed inside on the inflow duct of the inlet corpus, i.e. the media supply lines point counter to the rotating direction of the device for generating additional negative pressure, in perspective illustrations. The preferred use of the arrangement “internally decelerating” is with high flow rates and with intense fluctuations of the flow rates.

The device 1 has an overall profile 112 with its profile sections 113 and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, the inlet corpus 113 receives four media supply lines 53 which are in each case provided with an aperture 113b and are attached in front of the inlet 53e (not shown) and the media supply line. One regulating flap 53f is in each case located after the aperture, said regulating flaps 53f being received at the beginning of the media lines 53. The media supply lines are disposed so as to continue within the inflow duct of the inlet corpus 113; it is to be pointed out here that the media supply lines 53 in this exemplary embodiment receive the medium directly, without inflow hoods 113a, through the end-side opening 101, FIG. 1b, in the inflow duct of the inlet corpus 113.

When viewed in the flow direction 110, the four media supply lines 53, of which one is shown, at their rear end lead in each case to the non-rotating formed disk 51c of the device for generating additional negative pressure 50. The media supply lines 53 to the non-rotating formed disk 51c are disposed on the inside counter to the rotating direction 50a of the device for generating additional negative pressure; said media supply lines 53 have a decelerating effect on the rotating speed of the device for generating additional negative pressure 50; for the purpose of differentiation in relation to further media supply lines, they are therefore specifically denoted by the reference sign 53d, FIG. 11, FIG. 12b.

In the case of an open aperture 113b, the medium, by way of the opening 101 (cf. FIG. 1b) of the inlet corpus 113, which is co-aligned with the flow direction 110 of the respective medium, for example wind 105, and passing the inlet 53e and the regulating flaps 53f, flows into the four media supply lines 53 toward the non-rotating formed disk 51c of the device for generating additional negative pressure 50, FIG. 11 and FIG. 12b.

The media supply lines 53 are disposed in an inner region within the inflow duct of the inlet corpus 113 and, like the latter, run in the longitudinal direction toward the device for generating additional negative pressure 50. “Inner” region, or synonymously “inside”, means that the media supply lines 53 run within the supply duct 100 toward the device for generating additional negative pressure 50, if such a supply duct is present; if such a supply duct is not provided, these terms either mean that the media supply lines 53 are disposed so far from the internal wall of the inlet corpus 113 that the inlet corpus 113 in its eccentric, consequently “outer” region, or synonymously “outside”, when viewed in the longitudinal direction, can in any case receive at least one (further) media supply line 53a, 53c in such a manner that the media supply lines 53 point in or counter to the rotating direction of the device for generating additional negative pressure; or else they mean that the inlet corpus 113 does not possess inflow hoods 113a, the medium thus not flowing by way of the latter into the media supply lines; the latter is shown in this exemplary embodiment.

The arrangement of the inner media supply lines 53 “counter to the rotating direction” can be seen from FIG. 11, FIG. 12b. That end of the media supply line 53d that reaches the non-rotating formed disk 51c is aligned in such a way that said end points counter to the rotating direction of the device for generating additional negative pressure, this being identified by means of the arrow 50a. The medium flowing through the media supply line 53d thus impacts the converter wheel in such a way that the rotation of the latter is decelerated as a result, the rotating speed thus being reduced. In this way, a deceleration of the rotating speed of the device for generating additional negative pressure 50 is made possible as a result of the flow of the medium in the respective media supply line 53d toward the device for generating additional negative pressure.

FIG. 11, FIG. 12b thus show that end of the media supply lines 53d that faces away from the end-side opening of the inlet corpus 113 counter to the rotating direction of the device for generating additional negative pressure 50; this is the position of the media supply line that contributes toward decelerating the rotating speed of the device for generating additional negative pressure when the respective medium is supplied through the media supply line to the device for generating additional negative pressure counter to the rotating direction of the latter.

In the process, the medium passes through the four passages 51g in the non-rotating formed disk 51c of the device for generating additional negative pressure 50, shown in FIGS. 12a, 12c. Said medium thus reaches the ducts 48, which are shown in FIG. 12b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 11 and FIG. 12b, besides the material characteristics of the medium flowing through the media supply lines 53.

Regulating flaps “open” means less repulsion at the converter wheel, which in turn means less torque at a lower rotating speed and thus less output; regulating flaps “closed” means normal repulsion at the converter wheel, which in turn means normal torque at a normal rotating speed and thus normal output.

The variation of the rotating speed and/or of the torque of the device for generating additional negative pressure furthermore directly influences the rotating speed and the torque of the turbine wheel 80. The regulating flaps 53f in the “open” position lead to a reduction in pressure on the turbine wheel, i.e. there is less torque at a lower rotating speed prevalent on the turbine wheel, which is associated with less output; the regulating flaps 53f in the “closed” position cause an increase in pressure on the turbine wheel, which means increased torque at a higher rotating speed and thus more output.

As can be seen from FIG. 12a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIGS. 12a, 12b.

### Exemplary Embodiment 5

The exemplary embodiment in FIG. 13 (in conjunction with FIG. 1) and FIG. 14, FIGS. 15, 15a, 15b and 15c shows a device 1 having regulating flaps “externally and internally accelerating”, i.e. the regulating flaps and media supply lines are disposed outside and inside on the inflow duct of the inlet corpus, i.e. the media supply lines point in the rotating direction of the device for generating additional negative pressure, in perspective illustrations. The preferred use of the arrangement “externally and internally accelerating” is with low flow rates and with intense fluctuations of the flow rates.

The device 1 has an overall profile 112 with its profile sections 113 and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, four outer inflow hoods 113a are disposed at identical mutual spacings on the outer casing of the profile section 113, FIG. 1, FIG. 13, FIG. 15a. Said inflow hoods 113a cover a material clearance in the outer casing 113, FIG. 15b, which when viewed in the flow direction 110 receive the in each case front end piece of likewise four outer media supply lines 53a having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53a in this exemplary embodiment without inflow hoods 113a could also receive the medium directly through the end-side opening 101, FIG. 1b, in the inflow duct of the inlet corpus 113. In this exemplary embodiment, there are moreover four further inner media supply lines 53b which are in each case provided with an aperture 113b, having in each case one inlet 53e into the media supply line, and in each case one regulating flap 53f. The media supply lines 53b receive the medium directly through the end-side opening 101, FIG. 1b, in the inflow duct of the inlet corpus 113.

When viewed in the flow direction 110, the eight media supply lines 53, 53a, 53b at their rear end lead in each case to the non-rotating formed disk 51c of the device for generating additional negative pressure 50. The media supply lines 53, 53a, 53b to the non-rotating formed disk 51c are disposed outside and inside in the rotating direction 50a of the device for generating additional negative pressure, and have an accelerating effect on the rotating speed of the device for generating additional negative pressure 50; for the purpose of differentiation in relation to further media supply lines, they are therefore specifically denoted by the reference sign 53a for the so-called outer media supply line, and by the reference sign 53b for the so-called inner media supply line, FIG. 14, FIG. 15b.

The medium, by way of the openings of the inflow hoods 113a, which are co-aligned with the flow direction 110 of the respective medium, for example wind 105, and passing the inlet 53e and the regulating flaps 53f, flows into the four outer media supply lines 53a toward the non-rotating formed disk 51c of the device for generating additional negative pressure 50, FIG. 15b.

The four media supply lines 53a are disposed in an outer region within the inflow duct of the inlet corpus 113 and, like the latter, run in the longitudinal direction toward the device for generating additional negative pressure 50. “Outer” region, or synonymously “outside”, means that the media supply lines 53a run between the internal wall of the inlet corpus 113 and the external wall of the supply duct 100 toward the device for generating additional negative pressure 50, if such a supply duct is present; if such a supply duct is not provided, these terms either mean that the media supply lines 53a are disposed so far toward the internal wall of the inlet corpus 113 that the inlet corpus 113 in its more central, consequently “inner” region, or synonymously “inside”, when viewed in the longitudinal direction, can in any case receive at least one (further) media supply line 53b in such a manner that the media supply lines 53 point in the rotating direction of the device for generating additional negative pressure; or else the terms mean that the inlet corpus 113 possesses inflow hoods 113a, the medium thus flowing by way of the latter into the media supply lines; the latter is shown in this exemplary embodiment, FIGS. 15a, 15b.

The further four media supply lines 53b are disposed in an inner region within the inflow duct of the inlet corpus 113 and, like the latter, run in the longitudinal direction toward the device for generating additional negative pressure 50. “Inner” region, or synonymously “inside”, means that the media supply lines 53b run within the supply duct 100 toward the device for generating additional negative pressure 50 if such a supply duct is present; if such a supply duct is not provided, these terms either mean that the media supply lines 53 are disposed so far from the internal wall of the inlet corpus 113 in such a manner that the inlet corpus 113 in its eccentric, consequently “outer” region, or synonymously “outside”, when viewed in the longitudinal direction, can in any case receive at least one (further) media supply line 53a in such a manner that the media supply lines 53 point in the rotating direction of the device for generating additional negative pressure; or else said terms mean that the media supply lines 53b do not receive the flow of the medium by way of inflow hoods 113a of the inlet corpus 113, the medium thus not flowing by way of these inflow hoods 113a into the media supply lines; the latter is shown in this exemplary embodiment, FIGS. 15a, 15b.

The arrangement of the outer and inner media supply lines 53a, 53b “in the rotating direction” can be seen from FIG. 14, FIG. 15b. That end of the media supply line 53a, 53b that reaches the non-rotating formed disk 51c is aligned in such a way that said end points in the rotating direction of the device for generating additional negative pressure, this being identified by means of the arrow 50a. The medium flowing through the media supply line 53a, 53b thus impacts the converter wheel in such a way that the rotation of the latter is facilitated as a result, the rotating speed thus being increased. In this way, an acceleration of the rotating speed of the device for generating additional negative pressure 50 is made possible as a result of the flow of the medium in the respective media supply line 53a, 53b toward the device for generating additional negative pressure.

FIG. 14, FIG. 15b thus show that end of the at least one media supply line 53a, 53b that faces away from the end-side opening of the inlet corpus 113 and the aperture 113b in the rotating direction of the device for generating additional negative pressure 50; this is the position of the media supply line that contributes toward accelerating the rotating speed of the device for generating additional negative pressure when the respective medium is supplied through the media supply line to the device for generating additional negative pressure in the rotating direction of the latter.

In the process, the medium passes through the four passages 51d (for the so-called outer media supply lines 53a), shown in FIG. 15c, and four further passages 51e (for the so-called inner media supply lines 53b) in the non-rotating formed disk 51c of the device for generating additional negative pressure 50. Said medium thus reaches the ducts 48, which are shown in FIG. 15b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 14, FIG. 15b and FIG. 15b, besides the material characteristics of the medium flowing through the media supply lines 53. It goes without saying that each media supply line can be separately regulated.

Regulating flaps “open” means greater repulsion at the converter wheel, which in turn means more torque at a higher rotating speed and thus more output; regulating flaps “closed” means less repulsion at the converter wheel, which in turn means less torque at a low rotating speed and thus less output.

The variation of the rotating speed and/or of the torque of the device for generating additional negative pressure furthermore directly influences the rotating speed and the torque of the turbine wheel 80. The regulating flaps 53f in the “open” position lead to an increase in pressure on the turbine wheel, i.e. there is more torque at a higher rotating speed prevalent on the turbine wheel, which is associated with more output; the regulating flaps 53f in the “closed” position cause a reduction in pressure on the turbine wheel, which means less torque at a lower rotating speed and thus less output.

As can be seen from FIG. 3a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 15a.

### Exemplary Embodiment 6

The exemplary embodiment in FIG. 16 (in conjunction with FIG. 1) and FIG. 17, FIGS. 18, 18a, 18b and 18c shows a device 1 having regulating flaps “externally and internally decelerating”, i.e. the regulating flaps and media supply lines are disposed outside and inside on the inflow duct of the inlet corpus, i.e. the media supply lines point counter to the rotating direction of the device for generating additional negative pressure, in perspective illustrations. The preferred use of the arrangement “externally and internally decelerating” is with high flow rates and with intense fluctuations of the flow rates.

The device 1 has an overall profile 112 with its profile sections 113 (inlet corpus) and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, four outer inflow hoods 113a are disposed at identical mutual spacings on the outer casing of the inlet corpus 113, FIG. 1, FIG. 16, FIG. 18a. Said inflow hoods 113a cover a material clearance in the outer casing 113, FIG. 18b, which when viewed in the flow direction 110 receive the in each case front end piece of likewise four outer media supply lines 53c having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53c in this exemplary embodiment without inflow hoods 113a receive the medium directly through the end-side opening 101, FIG. 1b, in the inflow duct of the inlet corpus 113. In this exemplary embodiment, there are moreover four further inner media supply lines 53d which are in each case provided with an aperture 113b, having in each case one inlet 53e into the media supply line, and in each case one regulating flap 53f. The media supply lines 53d receive the medium directly through the end-side opening 101, FIG. 1b, in the inflow duct of the inlet corpus 113.

When viewed in the flow direction 110, the eight media supply lines 53, 53c, 53d at their rear end lead in each case to the non-rotating formed disk 51c of the device for generating additional negative pressure 50. The media supply lines 53, 53c, 53d to the non-rotating formed disk 51c are disposed outside and inside counter to the rotating direction 50a of the device for generating additional negative pressure, and have a decelerating effect on the rotating speed of the device for generating additional negative pressure 50; for the purpose of differentiation in relation to further media supply lines, they are therefore specifically denoted by the reference sign 53c for the so-called outer media supply line, and by the reference sign 53d for the so-called inner media supply line, FIG. 17, FIG. 18b.

The medium, by way of the openings of the inflow hoods 113a, which are co-aligned with the flow direction 110 of the respective medium, for example wind 105, and passing the inlet 53e and the regulating flaps 53f, flows into the four outer media supply lines 53c toward the non-rotating formed disk 51c of the device for generating additional negative pressure 50, FIGS. 18b, 18c.

The four media supply lines 53c are disposed in an outer region within the inflow duct of the inlet corpus 113 and, like the latter, run in the longitudinal direction toward the device for generating additional negative pressure 50. “Outer” region, or synonymously “outside”, means that the media supply lines 53c run between the internal wall of the inlet corpus 113 and the external wall of the supply duct 100 toward the device for generating additional negative pressure 50, if such a supply duct is present; if such a supply duct is not provided, these terms either mean that the media supply lines 53c are disposed so far toward the internal wall of the inlet corpus 113 that the inlet corpus 113 in its more central, consequently “inner” region, or synonymously “inside”, when viewed in the longitudinal direction, can in any case receive at least one (further) media supply line 53d in such a manner that the media supply lines 53 point counter to the rotating direction of the device for generating additional negative pressure; or else the terms mean that the inlet corpus 113 possesses inflow hoods 113a, the medium thus flowing by way of the latter into the media supply lines; the latter is shown in this exemplary embodiment, FIGS. 18a, 18b.

The further four media supply lines 53d are disposed in an inner region within the inflow duct of the inlet corpus 113 and, like the latter, run in the longitudinal direction toward the device for generating additional negative pressure 50. “Inner” region, or synonymously “inside”, means that the media supply lines 53d run within the supply duct 100 toward the device for generating additional negative pressure 50 if such a supply duct is present; if such a supply duct is not provided, these terms either mean that the media supply lines 53d are disposed so far from the internal wall of the inlet corpus 113 in such a manner that the inlet corpus 113 in its eccentric, consequently “outer” region, or synonymously “outside”, when viewed in the longitudinal direction, can in any case receive at least one (further) media supply line 53c in such a manner that the media supply lines 53 point in the rotating direction of the device for generating additional negative pressure; or else said terms mean that the media supply lines 53d do not receive the flow of the medium by way of inflow hoods 113a of the inlet corpus 113, the medium thus not flowing by way of these inflow hoods 113a into the media supply lines; the latter is shown in this exemplary embodiment, FIGS. 18a, 18b.

The arrangement of the outer and inner media supply lines 53c, 53d “counter to the rotating direction” can be seen from FIG. 17, FIGS. 18b, 18c. That end of the media supply line 53c, 53d that reaches the non-rotating formed disk 51c is aligned in such a way that said end points counter to the rotating direction of the device for generating additional negative pressure, this being identified by means of the arrow 50a. The medium flowing through the media supply line 53c, 53d thus impacts the converter wheel in such a way that the rotation of the latter is reduced as a result, the rotating speed thus being decreased. In this way, a deceleration of the rotating speed of the device for generating additional negative pressure 50 is made possible as a result of the flow of the medium in the respective media supply line 53c, 53d toward the device for generating additional negative pressure.

FIG. 17, FIG. 18b thus show that end of the at least one media supply line 53c, 53d that faces away from the end-side opening of the inlet corpus 113 and the aperture 113b counter to the rotating direction of the device for generating additional negative pressure 50; this is the position of the media supply line that contributes toward reducing the rotating speed of the device for generating additional negative pressure when the respective medium is supplied through the media supply line to the device for generating additional negative pressure counter to the rotating direction of the latter.

In the process, the medium passes through the four passages 51f (for the so-called outer media supply lines 53c), shown in FIG. 18c, and four further passages 51g (for the so-called inner media supply lines 53d) in the non-rotating formed disk 51c of the device for generating additional negative pressure 50. Said medium thus reaches the ducts 48, which are shown in FIG. 18b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 16 and FIG. 17, besides the material characteristics of the medium flowing through the media supply lines 53. It goes without saying that each media supply line can be separately regulated.

Regulating flaps “open” means lower repulsion at the converter wheel, which in turn means less torque at a lower rotating speed and thus less output; regulating flaps “closed” means normal repulsion at the converter wheel, which in turn means normal torque at a normal rotating speed and thus normal output.

The variation of the rotating speed and/or of the torque of the device for generating additional negative pressure furthermore directly influences the rotating speed and the torque of the turbine wheel 80. The regulating flaps 53f in the “closed” position lead to an increase in pressure on the turbine wheel, i.e. there is more torque at a higher rotating speed prevalent on the turbine wheel, which is associated with more output; the regulating flaps 53f in the “open” position cause a reduction in pressure on the turbine wheel, which means less torque at a lower rotating speed and thus less output.

As can be seen from FIG. 18a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 18a.

### Exemplary Embodiment 7

The exemplary embodiment in FIG. 19 (in conjunction with FIG. 1) and FIG. 20, FIGS. 21, 21a, 21b and 21c shows a device 1 having regulating flaps “internally accelerating and externally decelerating”, i.e. the regulating flaps and media supply lines are disposed outside and inside on the inflow duct of the inlet corpus, i.e. the media supply lines inside point in the rotating direction of the device for generating additional negative pressure, and the media supply lines outside point counter to the rotating direction of the device for generating additional negative pressure, in perspective illustrations. The preferred use of the arrangement “internally accelerating and externally decelerating” is decelerating with high flow rates and accelerating with lower flow rates, and with intense fluctuations of the flow rates.

The device 1 has an overall profile 112 with its profile sections 113 (inlet corpus) and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, four outer inflow hoods 113a are disposed at identical mutual spacings on the outer casing of the inlet corpus 113, FIG. 1, FIG. 19, FIG. 21a. Said inflow hoods 113a cover a material clearance in the outer casing 113, FIG. 21b, which when viewed in the flow direction 110 receive the in each case front end piece of likewise four outer media supply lines 53c having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53c in this exemplary embodiment without inflow hoods 113a receive the medium directly through the end-side opening 101, FIG. 1b, in the inflow duct of the inlet corpus 113. In this exemplary embodiment, there are moreover four further inner media supply lines 53b which are in each case provided with an aperture 113b, having in each case one inlet 53e into the media supply line, and in each case one regulating flap 53f. The media supply lines 53b receive the medium directly through the end-side opening 101, FIG. 1b, in the inflow duct of the inlet corpus 113.

When viewed in the flow direction 110, the eight media supply lines 53, 53c, 53b at their rear end lead in each case to the non-rotating formed disk 51c of the device for generating additional negative pressure 50. The media supply lines 53, 53c to the non-rotating formed disk 51c are disposed on the outside counter to the rotating direction 50a of the device for generating additional negative pressure, and have a decelerating effect on the rotating speed of the device for generating additional negative pressure 50; the media supply lines 53, 53b to the non-rotating formed disk 51c are disposed inside in the rotating direction 50a of the device for generating additional negative pressure, and have an accelerating effect on the rotating speed of the device for generating additional negative pressure 50; for the purpose of differentiation in relation to further media supply lines, they are therefore specifically denoted by the reference sign 53c for the so-called outer and decelerating media supply line, and by the reference sign 53b for the so-called inner accelerating media supply line, and the aperture 113b FIG. 20, FIG. 21b.

The medium, by way of the openings of the inflow hoods 113a, which are co-aligned with the flow direction 110 of the respective medium, for example wind 105, and passing the inlet 53e and the regulating flaps 53f, flows into the four outer media supply lines 53c toward the non-rotating formed disk 51c of the device for generating additional negative pressure 50, FIG. 20, FIG. 21b.

The four media supply lines 53c are disposed in an outer region within the inflow duct of the inlet corpus 113 and, like the latter, run in the longitudinal direction toward the device for generating additional negative pressure 50. “Outer” region, or synonymously “outside”, means that the media supply lines 53c run between the internal wall of the inlet corpus 113 and the external wall of the supply duct 100 toward the device for generating additional negative pressure 50, if such a supply duct is present; if such a supply duct is not provided, these terms either mean that the media supply lines 53c are disposed so far toward the internal wall of the inlet corpus 113 that the inlet corpus 113 in its more central, consequently “inner” region, or synonymously “inside”, when viewed in the longitudinal direction, can in any case receive at least one (further) media supply line 53b in such a manner that the media supply lines 53 point in the rotating direction of the device for generating additional negative pressure; or else the terms mean that the inlet corpus 113 possesses inflow hoods 113a, the medium thus flowing by way of the latter into the media supply lines; the latter is shown in this exemplary embodiment, FIG. 20, FIGS. 21a, 21b.

The further four media supply lines 53b are disposed in an inner region within the inflow duct of the inlet corpus 113 and, like the latter, run in the longitudinal direction toward the device for generating additional negative pressure 50. “Inner” region, or synonymously “inside”, means that the media supply lines 53b run within the supply duct 100 toward the device for generating additional negative pressure 50 if such a supply duct is present; if such a supply duct is not provided, these terms either mean that the media supply lines 53b are disposed so far from the internal wall of the inlet corpus 113 in such a manner that the inlet corpus 113 in its eccentric, consequently “outer” region, or synonymously “outside”, when viewed in the longitudinal direction, can in any case receive at least one (further) media supply line 53c in such a manner that the media supply line 53c points in the rotating direction of the device for generating additional negative pressure; or else said terms mean that the at least one media supply line 53b does not receive the flow of the medium by way of inflow hoods 113a of the inlet corpus 113, the medium thus not flowing by way of these inflow hoods 113a into the media supply lines; the latter is shown in this exemplary embodiment, FIG. 20, FIGS. 21a, 21b.

The arrangement of the outer media supply lines 53c “counter to the rotating direction” and the inner media supply lines 53b “in the rotating direction” can be seen from FIG. 20, FIG. 21b. That end of the media supply line 53c that reaches the non-rotating formed disk 51c is aligned in such a way that said end points counter to the rotating direction of the device for generating additional negative pressure, this being identified by means of the arrow 50a. The medium flowing through the media supply line 53c thus impacts the converter wheel in such a way that the rotation of the latter is reduced as a result, the rotating speed thus being decreased. In this way, a deceleration of the rotating speed of the device for generating additional negative pressure 50 is made possible as a result of the flow of the medium in the respective media supply line 53c toward the device for generating additional negative pressure. That end of the media supply line 53b that reaches the non-rotating formed disk 51c is aligned in such a way that said end points in the rotating direction of the device for generating additional negative pressure, this being identified by means of the arrow 50a. The medium flowing through the media supply line 53b thus impacts the converter wheel in such a way that the rotation of the latter is accelerated as a result, the rotating speed thus being increased. In this way, an acceleration of the rotating speed of the device for generating additional negative pressure 50 is made possible as a result of the flow of the medium in the respective media supply line 53b toward the device for generating additional negative pressure. The device 1 can be controlled by suitable closed-loop and open-loop control measures in such a way that either the accelerating or the decelerating function dominates, depending on the respective acute environmental conditions, for example wind conditions.

FIG. 20, FIG. 21b thus show that end of the media supply lines 53c that faces away from the end-side opening of the inlet corpus 113 counter to the rotating direction of the device for generating additional negative pressure 50; this is the position of the media supply line that contributes toward reducing the rotating speed of the device for generating additional negative pressure when the respective medium is supplied through the media supply line to the device for generating additional negative pressure counter to the rotating direction of the latter. FIG. 20, FIG. 21b furthermore show that end of the media supply lines 53b that faces away from the end-side opening of the inlet corpus 113 in the rotating direction of the device for generating additional negative pressure 50; this is the position of the media supply line that contributes toward increasing the rotating speed of the device for generating additional negative pressure 50 when the respective medium is supplied through the media supply line 53b to the device for generating additional negative pressure 50 in the rotating direction.

In the process, the medium passes through the four passages 51f (for the so-called outer media supply lines 53c), shown in FIG. 21c, and four further passages 51e (for the so-called inner media supply lines 53b) in the non-rotating formed disk 51c of the device for generating additional negative pressure 50. Said medium thus reaches the ducts 48, which are shown in FIG. 21b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 20 and FIG. 21b, besides the material characteristics of the medium flowing through the media supply lines 53. It goes without saying that each media supply line can be separately regulated.

Regulating flaps “open” in the media supply lines “inside” 53b in the rotating direction means greater repulsion at the converter wheel, which in turn means more torque at a higher rotating speed and thus more output; regulating flaps “closed” in the media supply lines “inside” in the rotating direction means less repulsion at the converter wheel, which in turn means less torque at a low rotating speed and thus less output.

The variation of the rotating speed and/or of the torque of the device for generating additional negative pressure in the media supply lines “inside” 53b in the rotating direction furthermore directly influences the rotating speed and the torque of the turbine wheel 80. The regulating flaps in the “open” position lead to an increase in pressure on the turbine wheel, i.e. there is more torque at a higher rotating speed prevalent on the turbine wheel, which is associated with more output; the regulating flaps in the “closed” position cause a reduction in pressure on the turbine wheel, which means less torque at a lower rotating speed and thus less output.

Regulating flaps “open” in the media supply lines “outside” 53c counter to the rotating direction means that the converter wheel is decelerated, which in turn means less torque at a lower rotating speed and thus less output; regulating flaps “closed” in the media supply lines “outside” counter to the rotating direction means normal repulsion at the converter wheel, which in turn means normal torque at a corresponding rotating speed and thus normal output.

The variation of the rotating speed and/or of the torque of the device for generating additional negative pressure in the media supply lines “outside” 53c counter to the rotating direction furthermore directly influences the rotating speed and the torque of the turbine wheel 80. The regulating flaps in the “closed” position lead to an increase in pressure on the turbine wheel, i.e. there is more torque at a higher rotating speed prevalent on the turbine wheel, which is associated with more output; the regulating flaps in the “open” position cause a reduction in pressure on the turbine wheel, which means less torque at a lower rotating speed and thus less output.

As can be seen from FIG. 21a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 21a.

### Exemplary Embodiment 8

The exemplary embodiment in FIG. 22 (in conjunction with FIG. 1) and FIG. 23, FIGS. 24, 24a, 24b and 24c shows a device 1 having regulating flaps “internally decelerating and externally accelerating”, i.e. the regulating flaps and media supply lines are disposed outside and inside on the inflow duct of the inlet corpus, i.e. the media supply lines inside point counter to the rotating direction of the device for generating additional negative pressure, and the media supply lines outside point in the rotating direction of the device for generating additional negative pressure, in perspective illustrations. The preferred use of the arrangement “internally decelerating and externally accelerating” is decelerating with high flow rates and accelerating with lower flow rates, and with intense fluctuations of the flow rates.

The device 1 has an overall profile 112 with its profile sections 113 (inlet corpus) and 114.

The optional supply duct 100 is disposed in the interior of the profile section 113, and its spatially geometric position is illustrated by dashed lines in FIG. 1. The design embodiment and mode of action of said supply duct 100 has been explained above in the introductory part of the description of the figures, so that reference is made thereto.

In this exemplary embodiment, two outer inflow hoods 113a are disposed at identical mutual spacings on the outer casing of the inlet corpus 113, FIG. 1, FIG. 22, FIG. 24a. Said inflow hoods 113a cover a material clearance in the outer casing 113, FIG. 24b, which when viewed in the flow direction 110 receive the in each case front end piece of likewise two outer media supply lines 53a having in each case one inlet 53e into the media supply line and in each case one regulating flap 53f. The media supply lines are disposed so as to continue within the inflow duct of the inlet corpus 113; it is to be pointed out that the inflow hoods 113a are optional, i.e. that the media supply lines 53a in this exemplary embodiment without inflow hoods 113a receive the medium directly through the end-side opening 101, FIG. 1b, in the inflow duct of the inlet corpus 113. In this exemplary embodiment, there are moreover two further inner media supply lines 53d which are in each case provided with an aperture 113b, having in each case one inlet 53e into the media supply line, and in each case one regulating flap 53f. The media supply lines 53d receive the medium directly through the end-side opening 101, FIG. 1b, in the inflow duct of the inlet corpus 113.

When viewed in the flow direction 110, the four media supply lines 53, 53a, 53d at their rear end lead in each case to the non-rotating formed disk 51c of the device for generating additional negative pressure 50. The media supply lines 53, 53d to the non-rotating formed disk 51c are disposed inside counter to the rotating direction 50a of the device for generating additional negative pressure, and have a decelerating effect on the rotating speed of the device for generating additional negative pressure 50; the media supply lines 53, 53a to the non-rotating formed disk 51c are disposed outside in the rotating direction 50a of the device for generating additional negative pressure, and have an accelerating effect on the rotating speed of the device for generating additional negative pressure 50; for the purpose of differentiation in relation to further media supply lines, they are therefore specifically denoted by the reference sign 53a for the so-called outer and accelerating media supply line, and by the reference sign 53d for the so-called inner, decelerating media supply line, FIG. 23, FIG. 24b.

The medium, by way of the openings of the inflow hoods 113a, which are co-aligned with the flow direction 110 of the respective medium, for example wind 105, and passing the inlet 53e and the regulating flaps 53f, flows into the two outer media supply lines 53a toward the non-rotating formed disk 51c of the device for generating additional negative pressure 50, FIG. 23, FIG. 24b.

The two media supply lines 53a are disposed in an outer region within the inflow duct of the inlet corpus 113 and, like the latter, run in the longitudinal direction toward the device for generating additional negative pressure 50. “Outer” region, or synonymously “outside”, means that the media supply lines 53a run between the internal wall of the inlet corpus 113 and the external wall of the supply duct 100 toward the device for generating additional negative pressure 50, if such a supply duct is present; if such a supply duct is not provided, these terms either mean that the media supply lines 53a are disposed so far toward the internal wall of the inlet corpus 113 that the inlet corpus 113 in its more central, consequently “inner” region, or synonymously “inside”, when viewed in the longitudinal direction, can in any case receive (further) media supply lines 53d in such a manner that the media supply lines 53d point counter to the rotating direction of the device for generating additional negative pressure; or else the terms mean that the inlet corpus 113 possesses inflow hoods 113a, the medium thus flowing by way of the latter into the media supply lines; the latter is shown in this exemplary embodiment, FIG. 23, FIGS. 24a, 24b.

The further two media supply lines 53d are disposed in an inner region within the inflow duct of the inlet corpus 113 and, like the latter, run in the longitudinal direction toward the device for generating additional negative pressure 50. “Inner” region, or synonymously “inside”, means that the media supply lines 53d run within the supply duct 100 toward the device for generating additional negative pressure 50 if such a supply duct is present; if such a supply duct is not provided, these terms either mean that the media supply lines 53d are disposed so far from the internal wall of the inlet corpus 113 in such a manner that the inlet corpus 113 in its eccentric, consequently “outer” region, or synonymously “outside”, when viewed in the longitudinal direction, can in any case receive at least one (further) media supply line 53a in such a manner that the media supply line 53a points in the rotating direction of the device for generating additional negative pressure; or else said terms mean that the at least one media supply line 53d does not receive the flow of the medium by way of inflow hoods 113a of the inlet corpus 113, the medium thus not flowing by way of these inflow hoods 113a into the media supply lines; the latter is shown in this exemplary embodiment, FIG. 23, FIGS. 24a, 24b.

The arrangement of the inner media supply lines 53d “counter to the rotating direction” and the outer media supply lines 53a “in the rotating direction” can be seen from FIG. 23, FIG. 24b. That end of the media supply line 53d that reaches the non-rotating formed disk 51c is aligned in such a way that said end points counter to the rotating direction of the device for generating additional negative pressure, this being identified by means of the arrow 50a. The medium flowing through the media supply line 53d thus impacts the converter wheel in such a way that the rotation of the latter is reduced as a result, the rotating speed thus being decreased. In this way, a deceleration of the rotating speed of the device for generating additional negative pressure 50 is made possible as a result of the flow of the medium in the respective media supply line 53d toward the device for generating additional negative pressure. That end of the media supply line 53a that reaches the non-rotating formed disk 51c is aligned in such a way that said end points in the rotating direction of the device for generating additional negative pressure, this being identified by means of the arrow 50a. The medium flowing through the media supply line 53a thus impacts the converter wheel in such a way that the rotation of the latter is accelerated as a result, the rotating speed thus being increased. In this way, an acceleration of the rotating speed of the device for generating additional negative pressure 50 is made possible as a result of the flow of the medium in the respective media supply line 53a toward the device for generating additional negative pressure. The device 1 can be controlled by suitable closed-loop or open-loop control measures in such a way that either the accelerating or the decelerating function dominates, depending on the respective acute environmental conditions, for example wind conditions.

FIG. 23, FIG. 24b thus show that end of the media supply lines 53d that faces away from the end-side opening of the inlet corpus 113 and the aperture 113b counter to the rotating direction of the device for generating additional negative pressure 50; this is the position of the media supply line that contributes toward reducing the rotating speed of the device for generating additional negative pressure when the respective medium is supplied through the media supply line to the device for generating additional negative pressure counter to the rotating direction of the latter. FIG. 23, FIG. 24b furthermore show that end of the media supply lines 53a that faces away from the end-side opening of the inlet corpus 113 in the rotating direction of the device for generating additional negative pressure 50; this is the position of the media supply line that contributes toward increasing the rotating speed of the device for generating additional negative pressure 50 when the respective medium is supplied through the media supply line 53a to the device for generating additional negative pressure 50 in the rotating direction.

In the process, the medium passes through the two passages 51d (for the so-called outer media supply lines 53c), shown in FIG. 24c, and four further passages 51g (for the so-called inner media supply lines 53b) in the non-rotating formed disk 51c of the device for generating additional negative pressure 50. Said medium thus reaches the ducts 48, which are shown in FIG. 24b and are disposed between the rotatable circular disk 51a and the non-rotating formed disk 51c, and is directed toward the outside by way of the baffles 44 in the manner explained in detail above.

The rotating speed and the torque of the device for generating additional negative pressure are furthermore influenced by the extent of the open position (“open”) and closed position (“closed”) of the regulating flaps 53f, which are shown in FIG. 23 and FIG. 24b, besides the material characteristics of the medium flowing through the media supply lines 53. It goes without saying that each media supply line can be separately regulated.

Regulating flaps “open” in the media supply lines “inside” 53d counter to the rotating direction means that the converter wheel is decelerated, which in turn means less torque at a lower rotating speed and thus less output; regulating flaps “closed” in the media supply lines “inside” counter to the rotating direction means normal repulsion at the converter wheel, which in turn means normal torque at a corresponding rotating speed and thus normal output.

The variation of the rotating speed and/or of the torque of the device for generating additional negative pressure in the media supply lines “inside” 53d counter to the rotating direction furthermore directly influences the rotating speed and the torque of the turbine wheel 80. The regulating flaps in the “closed” position lead to an increase in pressure on the turbine wheel, i.e. there is more torque at a higher rotating speed prevalent on the turbine wheel, which is associated with more output; the regulating flaps in the “open” position cause a reduction in pressure on the turbine wheel, which means less torque at a lower rotating speed and thus less output.

Regulating flaps “open” in the media supply lines “outside” 53a in the rotating direction means greater repulsion at the converter wheel, which in turn means more torque at a higher rotating speed and thus more output; regulating flaps “closed” in the media supply lines “outside” in the rotating direction means less repulsion at the converter wheel, which in turn means less torque at a low rotating speed and thus less output.

The variation of the rotating speed and/or of the torque of the device for generating additional negative pressure in the media supply lines “outside” 53a in the rotating direction furthermore directly influences the rotating speed and the torque of the turbine wheel 80. The regulating flaps in the “open” position lead to an increase in pressure on the turbine wheel, i.e. there is more torque at a higher rotating speed prevalent on the turbine wheel, which is associated with more output; the regulating flaps in the “closed” position cause a reduction in pressure on the turbine wheel, which means less torque at a lower rotating speed and thus less output.

As can be seen from FIG. 24a, the converter wheel has a larger diameter than the turbine wheel 80. When viewed in the flow direction 110, said turbine wheel 80 is disposed in a manner known so as to adjoin a formed component 90 by which the volumetric flow 40 of the medium is deflected in such a way also in the context of the invention that an optimal pressure (not shown) is exerted on the blade parts 87 of the turbine wheel 80. When viewed in the flow direction 110, the turbine wheel 80 and the formed component 90 are framed by the supply duct 100 at the rear end of the latter, if such a supply duct 100 is provided. Otherwise, said turbine wheel 80 and the formed component 90 are fixed in the interior of the profile section 113, in the annular center 47 of the device for generating additional negative pressure, when viewed in the flow direction 110, FIG. 24a.

### Exemplary Embodiment 9

The exemplary embodiment in FIGS. 25, 25a shows a different type of media supply line, specifically a device 1 according to the invention having a version with ring ducts and externally accelerating and internally decelerating regulating, or externally decelerating and internally accelerating regulating, in perspective illustrations.

Where FIGS. 25 and 25a contain the same reference signs as in the preceding exemplary embodiments of FIGS. 1 to 24, the referenced components have identical functions. To this extent, reference is made thereto.

The present exemplary embodiment is distinguished in that the media supply lines are designed as ring ducts, thus designed for example to be annular. In this way, two annular ducts 53i, 53j can be disposed from the end-side opening 101 of the inlet corpus 113 in the direction of the non-rotating formed disk 51c of the device for generating additional negative pressure 50, wherein the ring ducts form one circular ring that is tighter at the end side, and one that is wider at the end side.

FIG. 25 shows that the front formed disk 51c is designed in such a way that the latter has two ring ducts “integrally molded” thereon in the front region, wherein the inner ring duct 53h/53j is responsible for deceleration, and the inflow and outflow opening runs counter to the rotating direction, and the outer ring duct 53g/53i is responsible for acceleration, and the inflow and outflow opening runs in the rotating direction 50a; the arrangement may also be inverse.

Individual ring ducts are not illustrated in FIG. 25. Individual ring ducts are possible and in this instance have single or a plurality of access points to the front formed disk. The ring ducts can in each case be individually embodied, without the formed disk being embodied. In this way, by way of example the outer ring duct 53i can receive the medium flowing into the inlet corpus 113 by way of the inflow hoods 113a which have been explained multiple times in the preceding exemplary embodiments.

### Exemplary Embodiment 10

The exemplary embodiment shown in FIGS. 26, 26a, 26b, 26c contains an embodiment of the energy converter having a version of a regulating disk with oblique openings, in perspective illustrations.

This exemplary embodiment is a manifestation of the invention in which the latter achieves the object by a converter wheel 50 with the above-described non-rotating formed disk 51c, without at least one media supply line, in which the increase in the rotating speeds of the device for generating additional negative pressure, or the reduction in the rotating speeds of the device for generating additional negative pressure, is established by the design embodiment of the at least one additional opening (in addition to the ring duct 41) contained in the formed disk.

Where the same reference signs are contained in FIGS. 26, 26a, 26b, 26c as in the preceding exemplary embodiments of FIGS. 1 to 25, the components referenced have the same functions. To this extent, reference is made thereto.

In this design embodiment, the medium flows through the end-side opening 101 of the inlet corpus 113 toward the device for generating additional negative pressure 50, which possesses a rotatable circular disk 51a, a ring duct 41, regions 43, baffles 44, 45, antechamber 46, center 47, ducts 48, and a non-rotating front formed disk 51c, as has already been described in more detail. The rotating direction of the device for generating additional negative pressure 50 is denoted by the reference sign 50a.

A rotating disk 51j is provided as an aperture. The latter is pivoted in one of the two pivoting directions 51m about a centric axis 51n, and thus releases the oblique opening 51h for accelerating the device for generating additional negative pressure 50, or in the other rotating direction 51i for decelerating the device for generating additional negative pressure. The rotating disk having the passages 51k is accelerating and 51l is decelerating. The positioning is arranged in such a manner that either an acceleration or deceleration takes place, or the passages in the front formed disk are covered.

It is also possible for this design embodiment of the specific design embodiment of the passages to be combined with at least one ring duct according to the exemplary embodiment of FIG. 25. In this way, a ring duct having the oblique passages 51h in the formed disk can be connected in the rotating direction 50a of the device for generating additional negative pressure 50, while the other ring duct having the oblique passages 51i in the formed disk can be connected counter to the rotating direction 50a of the device for generating additional negative pressure 50. The supply flow of the medium can be controlled by corresponding design embodiment of regulating flaps, for example in the form of slides or similar, in the ring ducts. The above-mentioned regulating disk could be dispensed with in this way.

### LIST OF REFERENCE SIGNS

1 Device for converting energy
2-39 Reserved
40 Volumetric flow
41 Ring duct=inlet duct
42 Region
43 Region
44 Baffle
45 Baffle
46 Antechamber
47 Center
48 Duct
49 Reserved
50 Device for generating additional negative pressure=converter wheel
50a Rotating direction
51 Further passage
51a Circular disk
51b Circular disk
51c Non-rotating front formed disk
51d Passage (for media supply line 53a)
51e Passage (for media supply line 53b)
51f Passage (for media supply line 53c)
51g Passage (for media supply line 53d)
51h Passage in formed disk in rotating direction
51i Passage in formed disk counter to rotating direction
51j Regulating disk as aperture
51k Passage in the regulating disk for acceleration
51l Passage in the regulating disk for deceleration
51m Pivoting direction for regulating disk about axis 51n
51n Rotation axis for regulating disk
52 Bearing part
53 Media supply line
53a Media supply line (to 51c in rotating direction 50a externally accelerating)
53b Media supply line (to 51c in rotating direction 50a internally accelerating)
53c Media supply line (to 51c counter to rotating direction 50a externally decelerating)
53d Media supply line (to 51c counter to rotating direction 50a internally decelerating)
53e Inlet media supply line
53f Regulating flap
53g Non-rotating front formed disk with ring duct for accelerating externally and decelerating internally
53h Non-rotating front formed disk with ring duct for decelerating externally and accelerating internally
53i Outer ring duct for acceleration or deceleration
53j Inner ring duct for deceleration or acceleration
54 Hub part
54a Region
55-56 Reserved
57 Drive motor
58-61 Reserved
62 External pressure
63-79 Reserved
80 Turbine wheel
81 Turbine shaft
82 Gearbox
83, 84 Reserved
85 Generator
86 Reserved
87 Blade part
88, 89 Reserved
90 Formed component
91 Guide vane part
92, 93 Reserved
94 Region
95 Region
97-99 Reserved
100 Tubular section
101 End-side opening inlet corpus 113
102-104 Reserved
105 Wind direction
106 Circulating flow
107 Circulating flow
108 Circulating flow
109 Outflow
110 Inflow
110a Pivoting centrically about a vertical axis
110b Pivoting eccentrically about a vertical axis
110c Pivoting of the energy converter about a spatial axis
111 Wind flow
112 Overall profile=casing
113 Profile section-inlet corpus
113a Outer inflow hood
113b Aperture
114 Profile section
115 Profile ring
116 Generator
117 Gearbox
118-122 Reserved
123 Mast
124 Roof of building
125 Apparatus for capturing and transmitting energy
126 Electrical line
127 . . . n Apparatus for storing and supplying electrical energy=power station
128 Electrical line
129 Electrical line
130 Electrical line

1. A device (1) for converting flow energy transported via a medium into mechanical and/or electrical energy, comprising
a casing (112) which has a turbine wheel (80) and a device for generating additional negative pressure (50), which is disposed downstream of said turbine wheel (80) in the flow direction and contains an inner inlet duct (41) and ducts (48) which receive the medium, wherein the latter is forced outward during rotation of the rotatable parts of the device for generating additional negative pressure (50), characterized in that the device for generating additional negative pressure (50) has a non-rotatable formed disk (51c) which has at least one further passage (51, 51h, 51i, 51d-51g) which is suitable for either accelerating or decelerating the rotatable parts of the device for generating additional negative pressure (50).

2. The device (1) as claimed in claim 1, characterized in that the at least one further passage (51, 51h, 51i, 51d-51g) in the non-rotating formed disk (51c) has a design embodiment which deflects the medium in or counter to the rotating direction (50a) of the device for generating additional negative pressure (50).

3. The device (1) as claimed in claim 2, characterized in that the non-rotating formed disk (51c) has a rotatable disk (51j) as an aperture which is pivotable in one of the two pivoting directions (51m) about a centric axis (51n), and releases the at least one further passage (51, 51h, 51i, 51d-51g) for the accelerating or for the decelerating rotation of the rotatable parts of the device for generating additional negative pressure (50).

4. The device (1) as claimed in claim 1, characterized in that the at least one further passage (51, 51h, 51i, 51d-51g) is designed as at least one ring duct (53i, 53j), wherein the ring duct (53i, 53j) either ensures the deceleration of the rotating speed of the device for generating additional negative pressure (50) and the inflow and outflow opening runs (53j) counter to the rotating direction (50a) of said device, or ensures the acceleration of the rotating speed of the device for generating additional negative pressure (50) and the inflow and outflow opening runs (53i) in the rotating direction (50a).

5. A device (1) for converting flow energy transported via a medium into mechanical and/or electrical energy, comprising
a casing (112) which has a turbine wheel (80) and a device for generating additional negative pressure (50), which is disposed downstream of said turbine wheel (80) in the flow direction and contains an inner inlet duct (41) and ducts (48) which receive the medium, wherein the latter is forced outward during rotation of the rotatable parts of the device for generating additional negative pressure (50), characterized in that the device for generating additional negative pressure (50) has a non-rotatable formed disk (51c), and in that the casing (112) comprises an inlet corpus (113) in which is disposed at least one media supply line (53) which is designed to direct the medium to the device for generating additional negative pressure (50) in the rotating direction (50a) of the latter and/or counter to the rotating direction (50a) of the latter.

6. The device (1) as claimed in claim 5, characterized in that the at least one media supply line (53) is disposed in an inner or outer region of the inlet corpus (113) in such a manner that the end of said media supply line (53) facing away from the end-side opening (101) of the inlet corpus (113) points in or counter to the rotating direction (50a) of the device for generating additional negative pressure (50).

7. The device (1) as claimed in claim 5 or 6, characterized in that the at least one media supply line (53) has a regulating flap (53f) which is designed to regulate the mass of the inflowing medium.

8. The device (1) as claimed in claim 7, characterized in that the regulating flap (53f) can be opened completely or partially, and be closed completely or partially, in such a manner that the rotating speed and/or the torque of the device for generating additional negative pressure (50) are/is able to be influenced as a result.

9. The device (1) as claimed in claim 5, characterized in that the inlet corpus (113) has at least one outer inflow hood (113a) by way of which medium flows into the at least one media supply line (53).

10. The device (1) as claimed in claim 5, characterized in that disposed in the inlet corpus (113) is in each case at least one media supply line (53) which is designed to supply the respective medium to the device for generating additional negative pressure (50) in (53a, 53b) the rotating direction (50a) of the latter and counter (53c, 53d) to the rotating direction (50a) of the latter in such a manner that the rotating speed of the device for generating additional negative pressure (50) can be accelerated or decelerated depending on the flow conditions of the medium, in that the respective medium is supplied through the media supply line (53) to the device for generating additional negative pressure (50) in or counter to the rotating direction (50a) of the latter.

11. The device (1) as claimed in claim 10, characterized in that the at least one media supply line (53) is designed as at least one ring duct (53i, 53j) which runs from the end-side opening (101) of the inlet corpus (113) in the direction of the non-rotating formed disk (51c) of the device for generating additional negative pressure (50).

12. The device (1) as claimed in claim 5, characterized in that the device for generating additional negative pressure (50) has a non-rotatable formed disk (51c) which has at least one further passage (51, 51h, 51i, 51d-51g), and the at least one media supply line (53) is designed to direct the medium to the at least one further passage (51, 51h, 51i, 51d-51g) in the non-rotating formed disk (51c) of the device for generating additional negative pressure (50) in the rotating direction (50a) of the latter and/or counter to the rotating direction (50a) of the latter.

13. The device (1) as claimed in claim 12, characterized in that the at least one further passage (51, 51h, 51i, 51d-51g) is designed as claimed in one of claims 1 to 4.

14. A device (1) for converting flow energy transported via a medium into mechanical and/or electrical energy, comprising a casing (112) which has a turbine wheel (80) and a device for generating additional negative pressure (50), which is disposed downstream of said turbine wheel (80) in the flow direction and contains an inner inlet duct (41) and ducts (48) which receive the medium, wherein the latter is forced outward during rotation of the rotatable parts of the device for generating additional negative pressure (50), characterized in that the device for generating additional negative pressure (50) has a non-rotatable formed disk (51c), and the device (1) is pivotable into or out of the flow direction of the medium in such a manner that the projected inflow area of the medium is able to be regulated.

15. The device (1) as claimed in claim 14, characterized in that the device is designed to enable pivoting of the device centrically (110a) about a vertical axis, eccentrically (110b) about a vertical axis, and/or about a spatial axis (110c).

16. The device (1) as claimed in claim 14, characterized in that the casing (112) comprises an inlet corpus (113) in which is disposed at least one media supply line (53) which is disposed to direct the medium to the device for generating additional negative pressure (50) in the rotating direction (50a) of the latter and/or counter to the rotating direction (50a) of the latter.

17. The device (1) as claimed in claim 16, characterized in that the media supply line (53) is designed as claimed in one of claims 6 to 12.

18. The device (1) as claimed in claim 14, characterized in that the non-rotatable formed disk (51c) has at least one further passage (51, 51h, 51i, 51d-51g) which is suitable for either accelerating or decelerating the rotatable parts of the device for generating additional negative pressure (50).

19. The device (1) as claimed in claim 18, characterized in that the further passage (51, 51h, 51i, 51d-51g) is designed as claimed in one of claims 2 to 4.

20. The device (1) as claimed in one of claim 1 or 5 or 14, characterized in that the device for generating additional negative pressure (50) and the turbine wheel (80) are able to be decoupled from one another, and the medium can flow against them in a mutually independent manner.

21. The device (1) as claimed in one of claim 1 or 5 or 14, characterized in that the device has an apparatus for capturing and transmitting energy (125), and at least one apparatus for storing and providing electrical energy (127.1, 127.2, 127 . . . n).

22. The device (1) as claimed in one of claim 1 or 5 or 14, characterized in that the device, when viewed in the flow direction, is provided with a louvre, net, mesh, or with a mat with openings, in the region of the end-side opening (101) of the inlet corpus (113) or in front of the turbine wheel (80) or the device for generating additional negative pressure (50).

23. A method for actuating and regulating the device (1) designed as claimed in one of preceding claim 1 or 5 or 14 for utilizing flow energy from water power and wind power or other flowing media, characterized in that the device (1) is pivoted into or out of the flow direction (110) of the medium in such a manner that the projected inflow area of the medium is increased or decreased.

24. The method as claimed in claim 23, characterized in that pivoting of the device (1) centrically (110a) is performed about a vertical axis, eccentrically (110b) about a vertical axis, and/or about a spatial axis (110c).

25. The method as claimed in claim 24, characterized in that correcting of the pivoting angle is performed permanently.

26. The method as claimed in one of claims 23 to 25, characterized in that pivoting of the device (1) is associated with switching on or off individual generators depending on the demand for energy.

27. The method as claimed in one of claims 23 to 26, characterized in that the choice of the incident flow angle of the medium flowing into the device (1) takes place as a function of the respective rotating speed of the device for generating additional negative pressure (50) and/or of the turbine wheel (80).

28. The method as claimed in one of claims 23 to 27, characterized in that the at least one media supply line (53) that in the inflow duct of the inlet corpus (113) points in the rotating direction (50a) of the device for generating additional negative pressure (50) is fed with medium by way of the “open” position of the regulating flap (53f) when the rotating speed and/or the torque of said device for generating additional negative pressure (50) is to be increased.

29. The method as claimed in one of claims 23 to 27, characterized in that the at least one media supply line (53) that in the inflow duct of the inlet corpus (113) points counter to the rotating direction (50a) of the device for generating additional negative pressure (50) is correspondingly closed to the flow of medium by way of the “closed” position of the regulating flap (53f) when the rotating speed and/or the torque of said device for generating additional negative pressure (50) is to be reduced.
